(19) United States
(12) Patent Application Publication
(10) Pub. No.: US 2025/0203091 A1
(43) Pub. Date: Jun. 19, 2025

(54) POINT CLOUD DATA TRANSMISSION DEVICE, POINT CLOUD DATA TRANSMISSION METHOD, POINT CLOUD DATA RECEPTION DEVICE, AND POINT CLOUD DATA RECEPTION METHOD

(71) Applicant: LG ELECTRONICS INC., Seoul (KR)

(72) Inventors: Yousun PARK, Seoul (KR); Hyejung HUR, Seoul (KR)

(21) Appl. No.: 18/838,931

(22) PCT Filed: Feb. 16, 2023
(86) PCT No.: PCT/KR2023/002302

§ 371 Date: Aug. 15, 2024

(30) Foreign Application Priority Data
Feb. 16, 2022 (KR) 10-2022-0020427

(51) Int. Cl. H04N 19/136; H04N 19/105; H04N 19/172; H04N 19/463; H04N 19/503

(52) U.S. Cl. CPC H04N 19/136; H04N 19/105; H04N 19/172; H04N 19/463; H04N 19/503

(57) ABSTRACT

A point cloud data transmission method according to embodiments comprises the steps of: encoding geometry information of point cloud data; encoding attribute information of the point cloud data on the basis of the geometry information; and transmitting the encoded geometry information, the encoded attribute information, and signaling information, wherein the step of encoding the attribute information may comprise the steps of: selectively applying a scaling factor to the attribute information; and compressing the attribute information by performing inter prediction on the basis of a reference frame and the current frame including attribute information to which the scaling factor is or is not applied.

### TECHNICAL FIELD

Embodiments relate to a method and apparatus for processing point cloud content.

### BACKGROUND ART

Point cloud content is content represented by a point cloud, which is a set of points belonging to a coordinate system representing a three-dimensional space (or volume). The point cloud content may express media configured in three dimensions, and is used to provide various services such as virtual reality (VR), augmented reality (AR), mixed reality (MR), XR (Extended Reality), and self-driving services. However, tens of thousands to hundreds of thousands of point data are required to represent point cloud content. Therefore, there is a need for a method for efficiently processing a large amount of point data.

### DISCLOSURE

### Technical Problem

An object of the present disclosure devised to solve the above-described problems is to provide a point cloud data transmission device, a point cloud data transmission method, a point cloud data reception device, and a point cloud data reception method for efficiently transmitting and receiving a point cloud.

Another object of the present disclosure is to provide a point cloud data transmission device, a point cloud data transmission method, a point cloud data reception device, and a point cloud data reception method for addressing latency and encoding/decoding complexity.

Another object of the present disclosure is to provide a point cloud data transmission device, a point cloud data transmission method, a point cloud data reception device, and a point cloud data reception method for improving the compression performance of the point cloud by improving the technique of encoding attribute information in geometry-based point cloud compression (G-PCC).

Another object of the present disclosure is to provide a point cloud data transmission device, a point cloud data transmission method, a point cloud data reception device, and a point cloud data reception method for increasing the compression efficiency of attribute information by applying a global/local scale based on the intensity of the attribute information in encoding the attribute information.

Another object of the present disclosure is to provide a point cloud data transmission device, a point cloud data transmission method, a point cloud data reception device, and a point cloud data reception method for increasing the compression efficiency of attribute information by obtaining a scaling factor based on the intensity of the attribute information and applying the same to compression of the attribute information. Objects of the present disclosure are not limited to the aforementioned objects, and other objects of the present disclosure which are not mentioned above will become apparent to those having ordinary skill in the art upon examination of the following description.

### Technical Solution

To achieve these objects and other advantages and in accordance with the purpose of the disclosure, as embodied and broadly described herein, a method of transmitting point cloud data may include encoding geometry information in the point cloud data, encoding attribute information in the point cloud data based on the geometry information, and transmitting the encoded geometry information, the encoded attribute information, and signaling information.

According to embodiments, the encoding of the attribute information may include selectively applying a scaling factor to the attribute information, and compressing the attribute information by performing inter-prediction based on a reference frame and a current frame containing the attribute information with and without the scaling factor applied.

According to embodiments, the signaling information may include scaling-related information.

According to embodiments, the scaling factor may be acquired based on an average distribution of the attribute information contained in the current frame and an average distribution of the attribute information contained in the reference frame.

According to embodiments, the average distribution may be an average distribution of intensities acquired based on reflectance included in the attribute information.

According to embodiments, the applying of the scaling factor may include applying the scaling factor to the attribute information based on an amount of change between the attribute information contained in the current frame and the attribute information contained in the reference frame being greater than a threshold.

According to embodiments, the scaling-related information may be included in at least one of a sequence parameter set, a geometry parameter set, an attribute parameter set, a tile parameter set, a geometry slice header, or an attribute slice header.

According to embodiments, the scaling-related information may include at least one of information indicating whether scaling is applied to the attribute information, threshold information provided to determine whether the scaling is applied, a value of the scaling factor, or information indicating a unit of application of the scaling factor.

A device for transmitting point cloud data according to embodiments may include a geometry encoder configured to encode geometry information in the point cloud data, an attribute encoder configured to encode attribute information in the point cloud data based on the geometry information, and a transmitter configured to transmit the encoded geometry information, the encoded attribute information, and signaling information.

According to embodiments, the attribute encoder may be configured to selectively apply a scaling factor to the attribute information, and compress the attribute information by performing inter-prediction based on a reference frame and a current frame containing the attribute information with and without the scaling factor applied.

According to embodiments, the signaling information may include scaling-related information.

According to embodiments, the scaling factor may be acquired based on an average distribution of the attribute information contained in the current frame and an average distribution of the attribute information contained in the reference frame.

According to embodiments, the average distribution may be an average distribution of intensities acquired based on reflectance included in the attribute information.

According to embodiments, the attribute encoder may apply the scaling factor to the attribute information based on an amount of change between the attribute information contained in the current frame and the attribute information contained in the reference frame being greater than a threshold.

According to embodiments, the scaling-related information may be included in at least one of a sequence parameter set, a geometry parameter set, an attribute parameter set, a tile parameter set, a geometry slice header, or an attribute slice header.

According to embodiments, the scaling-related information may include at least one of information indicating whether scaling is applied to the attribute information, threshold information provided to determine whether the scaling is applied, a value of the scaling factor, or information indicating a unit of application of the scaling factor.

A method of receiving point cloud data according to embodiments may include receiving encoded geometry information, encoded attribute information, and signaling information, decoding the encoded geometry information based on the signaling information, decoding the encoded attribute information based on the signaling information and the decoded geometry information, and rendering reconstructed point cloud data based on the decoded geometry information and the decoded attribute information.

According to embodiments, the signaling information may include scaling-related information.

According to embodiments, the decoding of the attribute information may include selectively applying scaling to the encoded attribute information based on the scaling-related information, and restoring the encoded attribute information by performing inter-prediction based on a reference frame and a current frame containing the encoded attribute information with or without the scaling applied.

According to embodiments, the scaling-related information may be included in at least one of a sequence parameter set, a geometry parameter set, an attribute parameter set, a tile parameter set, a geometry slice header, or an attribute slice header.

According to embodiments, the scaling-related information may include at least one of information indicating whether scaling is applied to the attribute information, threshold information provided to determine whether the scaling is applied, a value of the scaling factor, or information indicating a unit of application of the scaling factor.

### Advantageous Effects

A point cloud data transmission method, a point cloud data transmission device, a point cloud data reception method, and a point cloud data reception device according to embodiments may provide a good-quality point cloud service.

A point cloud data transmission method, a point cloud data transmission device, a point cloud data reception method, and a point cloud data reception device according to embodiments may achieve various video codec methods.

A point cloud data transmission method, a point cloud data transmission device, a point cloud data reception method, and a point cloud data reception device according to embodiments may provide universal point cloud content such as a self-driving service (or an autonomous driving service).

A point cloud data transmission method, a point cloud data transmission device, a point cloud data reception method, and a point cloud data reception device according to embodiments may perform space-adaptive partition of point cloud data for independent encoding and decoding of the point cloud data, thereby improving parallel processing and providing scalability.

A point cloud data transmission method, a point cloud data transmission device, a point cloud data reception method, and a point cloud data reception device according to embodiments may perform encoding and decoding by spatial partitioning the point cloud data in units of tiles and/or slices, and signal necessary data therefore, thereby improving encoding and decoding performance of the point cloud.

A point cloud data transmission method, a point cloud data transmission device, a point cloud data reception method, and a point cloud data reception device according to embodiments may encode and decode attribute information by applying a scaling factor to the attribute information and signal necessary data for the encoding and decoding, thereby improving the encoding and decoding performance of the point cloud.

A point cloud data transmission method, a point cloud data transmission device, a point cloud data reception method, and a point cloud data reception device according to embodiments may obtain a scaling factor based on an intensity of the attribute information and apply the same to encoding and decoding of the attribute information, thereby improving the encoding and decoding performance of the attribute information.

A point cloud data transmission method, a point cloud data transmission device, a point cloud data reception method, and a point cloud data reception device according to embodiments may obtain a scaling factor based on a color of the attribute information and apply the same to encoding and decoding of the attribute information, thereby improving the encoding and decoding performance of the attribute information.

### DESCRIPTION OF DRAWINGS

The accompanying drawings, which are included to provide a further understanding of the disclosure and are incorporated in and constitute a part of this application, illustrate embodiment(s) of the disclosure and together with the description serve to explain the principle of the disclosure.

FIG. 1 illustrates an exemplary point cloud content providing system according to embodiments.

FIG. 2 is a block diagram illustrating a point cloud content providing operation according to embodiments.

FIG. 3 illustrates an exemplary process of capturing a point cloud video according to embodiments.

FIG. 4 illustrates an exemplary block diagram of point cloud video encoder according to embodiments.

FIG. 5 illustrates an example of voxels in a 3D space according to embodiments.

FIG. 6 illustrates an example of octree and occupancy code according to embodiments.

FIG. 7 illustrates an example of a neighbor node pattern according to embodiments.

FIG. 8 illustrates an example of point configuration of a point cloud content for each LOD according to embodiments.

FIG. 9 illustrates an example of point configuration of a point cloud content for each LOD according to embodiments.

FIG. 10 illustrates an example of a block diagram of a point cloud video decoder according to embodiments.

FIG. 11 illustrates an example of a point cloud video decoder according to embodiments.

FIG. 12 illustrates a configuration for point cloud video encoding of a transmission device according to embodiments.

FIG. 13 illustrates a configuration for point cloud video decoding of a reception device according to embodiments.

FIG. 14 illustrates an exemplary structure operatively connectable with a method/device for transmitting and receiving point cloud data according to embodiments.

FIG. 15 illustrates an example in which a group of frames (GOF) is composed of a plurality of frames according to embodiments.

FIGS. 16-(a) and 16-(b) illustrate example global motion matrices according to embodiments.

FIG. 17 is a graph depicting an example of the number according to the intensity of an entire frame.

FIG. 18 illustrates an example of searching for nearest neighbor points according to embodiments.

FIG. 19 illustrates another example of a point cloud transmission device according to embodiments.

FIG. 20 illustrates an example of applying scaling in neighbor node search of an attribute encoder according to embodiments.

FIG. 21 is an example detailed block diagram illustrating a point cloud video encoder including a geometry encoder and an attribute encoder according to embodiments.

FIG. 22 illustrates another example of a point cloud reception device according to embodiments.

FIG. 23 is a detailed block diagram illustrating another example of a point cloud video decoder including a geometry decoder and an attribute decoder according to embodiments.

FIG. 24 illustrates an exemplary syntax structure of a sequence parameter set according to embodiments.

FIG. 25 illustrates another exemplary syntax structure of a sequence parameter set according to embodiments.

FIG. 26 illustrates an exemplary syntax structure of a tile parameter set according to embodiments.

FIG. 27 illustrates another exemplary syntax structure of a geometry parameter set according to embodiments.

FIG. 28 illustrates an exemplary syntax structure of an attribute parameter set according to embodiments.

FIG. 29 illustrates an exemplary syntax structure of a geometry slice bitstream according to embodiments.

FIG. 30 illustrates an exemplary syntax structure of a geometry slice header according to embodiments.

FIG. 31 illustrates an exemplary syntax structure of an attribute slice bitstream( ) according to embodiments.

FIG. 32 illustrates a syntax structure of an attribute slice header according to one embodiment of the present disclosure.

FIG. 33 is a flowchart of a method of transmitting point cloud data according to embodiments.

FIG. 34 is a flowchart of a method of receiving point cloud data according to embodiments.

### BEST MODE

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. It should be noted that the following examples are only for embodying the present disclosure and do not limit the scope of the present disclosure. What can be easily inferred by an expert in the technical field to which the present disclosure belongs from the detailed description and examples of the present disclosure is to be interpreted as being within the scope of the present disclosure.

The detailed description in this present specification should be construed in all aspects as illustrative and not restrictive. The scope of the disclosure should be determined by the appended claims and their legal equivalents, and all changes coming within the meaning and equivalency range of the appended claims are intended to be embraced therein.

Reference will now be made in detail to the preferred embodiments of the present disclosure, examples of which are illustrated in the accompanying drawings. The detailed description, which will be given below with reference to the accompanying drawings, is intended to explain exemplary embodiments of the present disclosure, rather than to show the only embodiments that can be implemented according to the present disclosure. The following detailed description includes specific details in order to provide a thorough understanding of the present disclosure. However, it will be apparent to those skilled in the art that the present disclosure may be practiced without such specific details. Although most terms used in this specification have been selected from general ones widely used in the art, some terms have been arbitrarily selected by the applicant and their meanings are explained in detail in the following description as needed. Thus, the present disclosure should be understood based upon the intended meanings of the terms rather than their simple names or meanings. In addition, the following drawings and detailed description should not be construed as being limited to the specifically described embodiments, but should be construed as including equivalents or substitutes of the embodiments described in the drawings and detailed description.

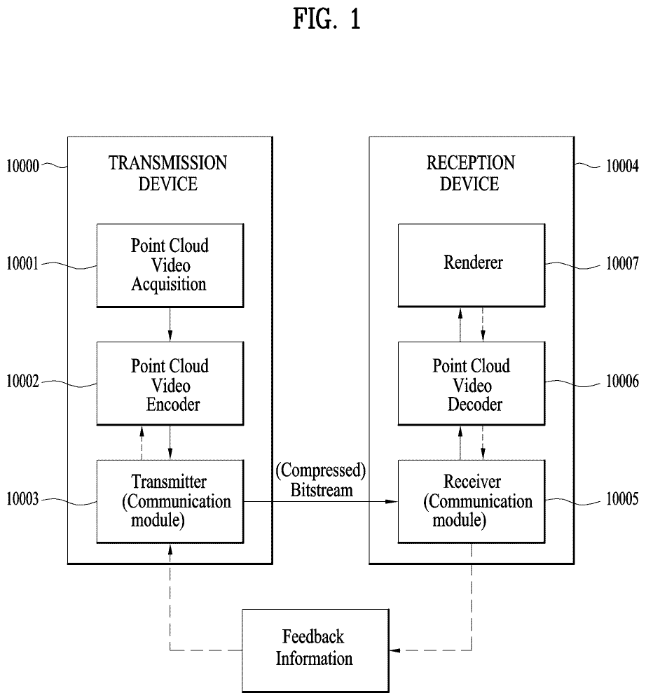

FIG. 1 shows an exemplary point cloud content providing system according to embodiments.

The point cloud content providing system illustrated in FIG. 1 may include a transmission device 10000 and a reception device 10004. The transmission device 10000 and the reception device 10004 are capable of wired or wireless communication to transmit and receive point cloud data.

The point cloud data transmission device 10000 according to the embodiments may secure and process point cloud video (or point cloud content) and transmit the same. According to embodiments, the transmission device 10000 may include a fixed station, a base transceiver system (BTS), a network, an artificial intelligence (AI) device and/or system, a robot, an AR/VR/XR device and/or server. According to embodiments, the transmission device 10000 may include a device, a robot, a vehicle, an AR/VR/XR device, a portable device, a home appliance, an Internet of Thing (IoT) device, and an AI device/server which are configured to perform communication with a base station and/or other wireless devices using a radio access technology (e.g., 5G New RAT (NR), Long Term Evolution (LTE)).

The transmission device 10000 according to the embodiments includes a point cloud video acquisition unit 10001, a point cloud video encoder 10002, and/or a transmitter (or communication module) 10003.

The point cloud video acquisition unit 10001 according to the embodiments acquires a point cloud video through a processing process such as capture, synthesis, or generation. The point cloud video is point cloud content represented by a point cloud, which is a set of points positioned in a 3D space, and may be referred to as point cloud video data. The point cloud video according to the embodiments may include one or more frames. One frame represents a still image/picture. Therefore, the point cloud video may include a point cloud image/frame/picture, and may be referred to as a point cloud image, frame, or picture.

The point cloud video encoder 10002 according to the embodiments encodes the acquired point cloud video data. The point cloud video encoder 10002 may encode the point cloud video data based on point cloud compression coding. The point cloud compression coding according to the embodiments may include geometry-based point cloud compression (G-PCC) coding and/or video-based point cloud compression (V-PCC) coding or next-generation coding. The point cloud compression coding according to the embodiments is not limited to the above-described embodiment. The point cloud video encoder 10002 may output a bitstream containing the encoded point cloud video data. The bitstream may contain not only the encoded point cloud video data, but also signaling information related to encoding of the point cloud video data.

The transmitter 10003 according to the embodiments transmits the bitstream containing the encoded point cloud video data. The bitstream according to the embodiments is encapsulated in a file or segment (e.g., a streaming segment), and is transmitted over various networks such as a broadcasting network and/or a broadband network. Although not shown in the figure, the transmission device 10000 may include an encapsulator (or an encapsulation module) configured to perform an encapsulation operation. According to embodiments, the encapsulator may be included in the transmitter 10003. According to embodiments, the file or segment may be transmitted to the reception device 10004 over a network, or stored in a digital storage medium (e.g., USB, SD, CD, DVD, Blu-ray, HDD, SSD, etc.). The transmitter 10003 according to the embodiments is capable of wired/wireless communication with the reception device 10004 (or the receiver 10005) over a network of 4G, 5G, 6G, etc. In addition, the transmitter may perform a necessary data processing operation according to the network system (e.g., a 4G, 5G or 6G communication network system). The transmission device 10000 may transmit the encapsulated data in an on-demand manner.

The reception device 10004 according to the embodiments includes a receiver 10005, a point cloud video decoder 10006, and/or a renderer 10007. According to embodiments, the reception device 10004 may include a device, a robot, a vehicle, an AR/VR/XR device, a portable device, a home appliance, an Internet of Things (IoT) device, and an AI device/server which are configured to perform communication with a base station and/or other wireless devices using a radio access technology (e.g., 5G New RAT (NR), Long Term Evolution (LTE)).

The receiver 10005 according to the embodiments receives the bitstream containing the point cloud video data or the file/segment in which the bitstream is encapsulated from the network or storage medium. The receiver 10005 may perform necessary data processing according to the network system (e.g., a communication network system of 4G, 5G, 6G, etc.). The receiver 10005 according to the embodiments may decapsulate the received file/segment and output a bitstream. According to embodiments, the receiver 10005 may include a decapsulator (or a decapsulation module) configured to perform a decapsulation operation. The decapsulator may be implemented as an element (or component or module) separate from the receiver 10005.

The point cloud video decoder 10006 decodes the bitstream containing the point cloud video data. The point cloud video decoder 10006 may decode the point cloud video data according to the method by which the point cloud video data is encoded (e.g., in a reverse process of the operation of the point cloud video encoder 10002). Accordingly, the point cloud video decoder 10006 may decode the point cloud video data by performing point cloud decompression coding, which is the reverse process to the point cloud compression. The point cloud decompression coding includes G-PCC coding.

The renderer 10007 renders the decoded point cloud video data. The renderer 10007 may output point cloud content by rendering not only the point cloud video data but also audio data. According to embodiments, the renderer 10007 may include a display configured to display the point cloud content. According to embodiments, the display may be implemented as a separate device or component rather than being included in the renderer 10007.

The arrows indicated by dotted lines in the drawing represent a transmission path of feedback information acquired by the reception device 10004. The feedback information is information for reflecting interactivity with a user who consumes the point cloud content, and includes information about the user (e.g., head orientation information, viewport information, and the like). In particular, when the point cloud content is content for a service (e.g., self-driving service, etc.) that requires interaction with the user, the feedback information may be provided to the content transmitting side (e.g., the transmission device 10000) and/or the service provider. According to embodiments, the feedback information may be used in the reception device 10004 as well as the transmission device 10000, or may not be provided.

The head orientation information according to embodiments is information about the user's head position, orientation, angle, motion, and the like. The reception device 10004 according to the embodiments may calculate the viewport information based on the head orientation information. The viewport information may be information about a region of a point cloud video that the user is viewing. A viewpoint is a point through which the user is viewing the point cloud video, and may refer to a center point of the viewport region. That is, the viewport is a region centered on the viewpoint, and the size and shape of the region may be determined by a field of view (FOV). Accordingly, the reception device 10004 may extract the viewport information based on a vertical or horizontal FOV supported by the device in addition to the head orientation information. Also, the reception device 10004 performs gaze analysis or the like to check the way the user consumes a point cloud, a region that the user gazes at in the point cloud video, a gaze time, and the like. According to embodiments, the reception device 10004 may transmit feedback information including the result of the gaze analysis to the transmission device 10000. The feedback information according to the embodiments may be acquired in the rendering and/or display process. The feedback information according to the embodiments may be secured by one or more sensors included in the reception device 10004. According to embodiments, the feedback information may be secured by the renderer 10007 or a separate external element (or device, component, or the like).

The dotted lines in FIG. 1 represent a process of transmitting the feedback information secured by the renderer 10007. The point cloud content providing system may process (encode/decode) point cloud data based on the feedback information. Accordingly, the point cloud video decoder 10006 may perform a decoding operation based on the feedback information. The reception device 10004 may transmit the feedback information to the transmission device 10000. The transmission device 10000 (or the point cloud video encoder 10002) may perform an encoding operation based on the feedback information. Accordingly, the point cloud content providing system may efficiently process necessary data (e.g., point cloud data corresponding to the user's head position) based on the feedback information rather than processing (encoding/decoding) the entire point cloud data, and provide point cloud content to the user.

According to embodiments, the transmission device 10000 may be called an encoder, a transmitting device, a transmitter, a transmission system, or the like, and the reception device 10004 may be called a decoder, a receiving device, a receiver, a reception system, or the like.

The point cloud data processed in the point cloud content providing system of FIG. 1 according to embodiments (through a series of processes of acquisition/encoding/transmission/decoding/rendering) may be referred to as point cloud content data or point cloud video data. According to embodiments, the point cloud content data may be used as a concept covering metadata or signaling information related to the point cloud data.

The elements of the point cloud content providing system illustrated in FIG. 1 may be implemented by hardware, software, a processor, and/or a combination thereof.

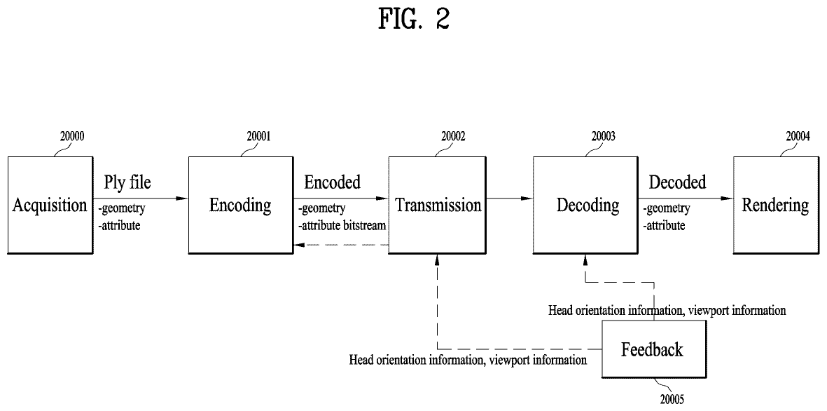

FIG. 2 is a block diagram illustrating a point cloud content providing operation according to embodiments.

The block diagram of FIG. 2 shows the operation of the point cloud content providing system described in FIG. 1. As described above, the point cloud content providing system may process point cloud data based on point cloud compression coding (e.g., G-PCC).

The point cloud content providing system according to the embodiments (e.g., the point cloud transmission device 10000 or the point cloud video acquisition unit 10001) may acquire a point cloud video (20000). The point cloud video is represented by a point cloud belonging to a coordinate system for expressing a 3D space. The point cloud video according to the embodiments may include a Ply (Polygon File format or the Stanford Triangle format) file. When the point cloud video has one or more frames, the acquired point cloud video may include one or more Ply files. The Ply files contain point cloud data, such as point geometry and/or attributes. The geometry includes positions of points. The position of each point may be represented by parameters (e.g., values of the X, Y, and Z axes) representing a three-dimensional coordinate system (e.g., a coordinate system composed of X, Y and Z axes). The attributes include attributes of points (e.g., information about texture, color (in YCbCr or RGB), reflectance r, transparency, etc. of each point). A point has one or more attributes. For example, a point may have an attribute that is a color, or may have two attributes that are color and reflectance.

According to embodiments, the geometry may be called positions, geometry information, geometry data, or the like, and the attribute may be called attributes, attribute information, attribute data, or the like.

The point cloud content providing system (e.g., the point cloud transmission device 10000 or the point cloud video acquisition unit 10001) may secure point cloud data from information (e.g., depth information, color information, etc.) related to the acquisition process of the point cloud video.

The point cloud content providing system (e.g., the transmission device 10000 or the point cloud video encoder 10002) according to the embodiments may encode the point cloud data (20001). The point cloud content providing system may encode the point cloud data based on point cloud compression coding. As described above, the point cloud data may include the geometry and attributes of a point. Accordingly, the point cloud content providing system may perform geometry encoding of encoding the geometry and output a geometry bitstream. The point cloud content providing system may perform attribute encoding of encoding attributes and output an attribute bitstream. According to embodiments, the point cloud content providing system may perform the attribute encoding based on the geometry encoding. The geometry bitstream and the attribute bitstream according to the embodiments may be multiplexed and output as one bitstream. The bitstream according to the embodiments may further contain signaling information related to the geometry encoding and attribute encoding.

The point cloud content providing system (e.g., the transmission device 10000 or the transmitter 10003) according to the embodiments may transmit the encoded point cloud data (20002). As illustrated in FIG. 1, the encoded point cloud data may be represented by a geometry bitstream and an attribute bitstream. In addition, the encoded point cloud data may be transmitted in the form of a bitstream together with signaling information related to encoding of the point cloud data (e.g., signaling information related to the geometry encoding and the attribute encoding). The point cloud content providing system may encapsulate a bitstream that carries the encoded point cloud data and transmit the same in the form of a file or segment.

The point cloud content providing system (e.g., the reception device 10004 or the receiver 10005) according to the embodiments may receive the bitstream containing the encoded point cloud data. In addition, the point cloud content providing system (e.g., the reception device 10004 or the receiver 10005) may demultiplex the bitstream.

The point cloud content providing system (e.g., the reception device 10004 or the point cloud video decoder 10005) may decode the encoded point cloud data (e.g., the geometry bitstream, the attribute bitstream) transmitted in the bitstream. The point cloud content providing system (e.g., the reception device 10004 or the point cloud video decoder 10005) may decode the point cloud video data based on the signaling information related to encoding of the point cloud video data contained in the bitstream. The point cloud content providing system (e.g., the reception device 10004 or the point cloud video decoder 10005) may decode the geometry bitstream to reconstruct the positions (geometry) of points. The point cloud content providing system may reconstruct the attributes of the points by decoding the attribute bitstream based on the reconstructed geometry. The point cloud content providing system (e.g., the reception device 10004 or the point cloud video decoder 10005) may reconstruct the point cloud video based on the positions according to the reconstructed geometry and the decoded attributes.

The point cloud content providing system according to the embodiments (e.g., the reception device 10004 or the renderer 10007) may render the decoded point cloud data (20004). The point cloud content providing system (e.g., the reception device 10004 or the renderer 10007) may render the geometry and attributes decoded through the decoding process, using various rendering methods. Points in the point cloud content may be rendered to a vertex having a certain thickness, a cube having a specific minimum size centered on the corresponding vertex position, or a circle centered on the corresponding vertex position. All or part of the rendered point cloud content is provided to the user through a display (e.g., a VR/AR display, a general display, etc.).

The point cloud content providing system (e.g., the reception device 10004) according to the embodiments may secure feedback information (20005). The point cloud content providing system may encode and/or decode point cloud data based on the feedback information. The feedback information and the operation of the point cloud content providing system according to the embodiments are the same as the feedback information and the operation described with reference to FIG. 1, and thus detailed description thereof is omitted.

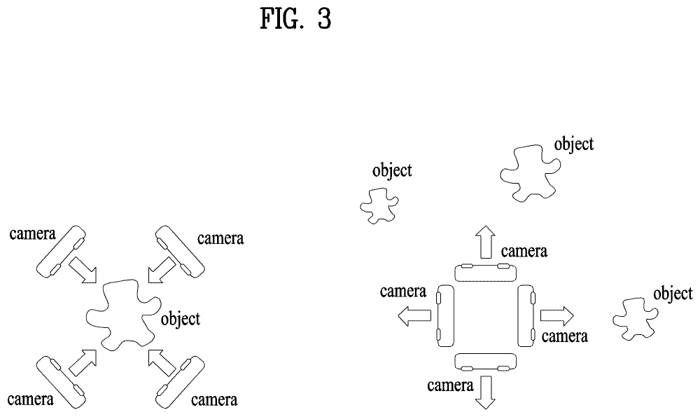

FIG. 3 illustrates an exemplary process of capturing a point cloud video according to embodiments.

FIG. 3 illustrates an exemplary point cloud video capture process of the point cloud content providing system described with reference to FIGS. 1 to 2.

Point cloud content includes a point cloud video (images and/or videos) representing an object and/or environment located in various 3D spaces (e.g., a 3D space representing a real environment, a 3D space representing a virtual environment, etc.). Accordingly, the point cloud content providing system according to the embodiments may capture a point cloud video using one or more cameras (e.g., an infrared camera capable of securing depth information, an RGB camera capable of extracting color information corresponding to the depth information, etc.), a projector (e.g., an infrared pattern projector to secure depth information), a LiDAR, or the like. The point cloud content providing system according to the embodiments may extract the shape of geometry composed of points in a 3D space from the depth information and extract the attributes of each point from the color information to secure point cloud data. An image and/or video according to the embodiments may be captured based on at least one of the inward-facing technique and the outward-facing technique.

The left part of FIG. 3 illustrates the inward-facing technique. The inward-facing technique refers to a technique of capturing images a central object with one or more cameras (or camera sensors) positioned around the central object. The inward-facing technique may be used to generate point cloud content providing a 360-degree image of a key object to the user (e.g., VR/AR content providing a 360-degree image of an object (e.g., a key object such as a character, player, object, or actor) to the user).

The right part of FIG. 3 illustrates the outward-facing technique. The outward-facing technique refers to a technique of capturing images an environment of a central object rather than the central object with one or more cameras (or camera sensors) positioned around the central object. The outward-facing technique may be used to generate point cloud content for providing a surrounding environment that appears from the user's point of view (e.g., content representing an external environment that may be provided to a user of a self-driving vehicle).

As shown in FIG. 3, the point cloud content may be generated based on the capturing operation of one or more cameras. In this case, the coordinate system may differ among the cameras, and accordingly the point cloud content providing system may calibrate one or more cameras to set a global coordinate system before the capturing operation. In addition, the point cloud content providing system may generate point cloud content by synthesizing an arbitrary image and/or video with an image and/or video captured by the above-described capture technique. The point cloud content providing system may not perform the capturing operation described in FIG. 3 when it generates point cloud content representing a virtual space. The point cloud content providing system according to the embodiments may perform post-processing on the captured image and/or video. In other words, the point cloud content providing system may remove an unwanted area (e.g., a background), recognize a space to which the captured images and/or videos are connected, and, when there is a spatial hole, perform an operation of filling the spatial hole.

The point cloud content providing system may generate one piece of point cloud content by performing coordinate transformation on points of the point cloud video secured from each camera. The point cloud content providing system may perform coordinate transformation on the points based on the coordinates of the position of each camera. Accordingly, the point cloud content providing system may generate content representing one wide range, or may generate point cloud content having a high density of points.

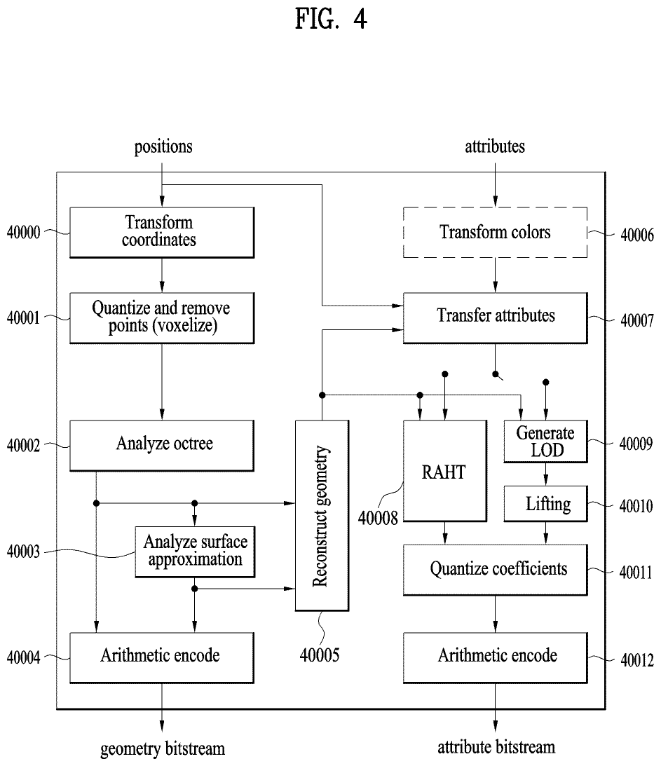

FIG. 4 illustrates an exemplary point cloud video encoder according to embodiments.

FIG. 4 shows an example of the point cloud video encoder 10002 of FIG. 1. The point cloud video encoder reconstructs and encodes point cloud data (e.g., positions and/or attributes of the points) to adjust the quality of the point cloud content (to, for example, lossless, lossy, or near-lossless) according to the network condition or applications. When the overall size of the point cloud content is large (e.g., point cloud content of 60 Gbps is given for 30 fps), the point cloud content providing system may fail to stream the content in real time. Accordingly, the point cloud content providing system may reconstruct the point cloud content based on the maximum target bitrate to provide the same in accordance with the network environment or the like.

As described with reference to FIGS. 1 to 2, the point cloud video encoder may perform geometry encoding and attribute encoding. The geometry encoding is performed before the attribute encoding.

The point cloud video encoder according to the embodiments includes a coordinate transformer (Transform coordinates) 40000, a quantizer (Quantize and remove points (voxelize)) 40001, an octree analyzer (Analyze octree) 40002, and a surface approximation analyzer (Analyze surface approximation) 40003, an arithmetic encoder (Arithmetic encode) 40004, a geometry reconstructor (Reconstruct geometry) 40005, a color transformer (Transform colors) 40006, an attribute transformer (Transform attributes) 40007, a RAHT transformer (RAHT) 40008, an LOD generator (Generate LOD) 40009, a lifting transformer (Lifting) 40010, a coefficient quantizer (Quantize coefficients) 40011, and/or an arithmetic encoder (Arithmetic encode) 40012.

The coordinate transformer 40000, the quantizer 40001, the octree analyzer 40002, the surface approximation analyzer 40003, the arithmetic encoder 40004, and the geometry reconstructor 40005 may perform geometry encoding. The geometry encoding according to the embodiments may include octree geometry coding, direct coding, trisoup geometry encoding, and entropy encoding. The direct coding and trisoup geometry encoding are applied selectively or in combination. The geometry encoding is not limited to the above-described example.

As shown in the figure, the coordinate transformer 40000 according to the embodiments receives positions and transforms the same into coordinates. For example, the positions may be transformed into position information in a three-dimensional space (for example, a three-dimensional space represented by an XYZ coordinate system). The position information in the three-dimensional space according to the embodiments may be referred to as geometry information.

The quantizer 40001 according to the embodiments quantizes the geometry information. For example, the quantizer 40001 may quantize the points based on a minimum position value of all points (e.g., a minimum value on each of the X, Y, and Z axes). The quantizer 40001 performs a quantization operation of multiplying the difference between the minimum position value and the position value of each point by a preset quantization scale value and then searching the nearest integer value by rounding the value obtained through the multiplication. Thus, one or more points may have the same quantized position (or position value). The quantizer 40001 according to the embodiments performs voxelization based on the quantized positions to reconstruct quantized points. The voxelization means a minimum unit representing position information in 3D space. Points of point cloud content (or 3D point cloud video) according to the embodiments may be included in one or more voxels. The term voxel, which is a compound of volume and pixel, refers to a 3D cubic space generated when a 3D space is divided into units (unit=1.0) based on the axes representing the 3D space (e.g., X-axis, Y-axis, and Z-axis). The quantizer 40001 may match groups of points in the 3D space with voxels. According to embodiments, one voxel may include only one point. According to embodiments, one voxel may include one or more points. In order to express one voxel as one point, the position of the center point of a voxel may be set based on the positions of one or more points included in the voxel. In this case, attributes of all positions included in one voxel may be combined and assigned to the voxel.

The octree analyzer 40002 according to the embodiments performs octree geometry coding (or octree coding) to present voxels in an octree structure. The octree structure represents points matched with voxels, based on the octal tree structure.

The surface approximation analyzer 40003 according to the embodiments may analyze and approximate the octree. The octree analysis and approximation according to the embodiments is a process of analyzing a region containing a plurality of points to efficiently provide octree and voxelization.

The arithmetic encoder 40004 according to the embodiments performs entropy encoding on the octree and/or the approximated octree. For example, the encoding scheme includes arithmetic encoding. As a result of the encoding, a geometry bitstream is generated.

The color transformer 40006, the attribute transformer 40007, the RAHT transformer 40008, the LOD generator 40009, the lifting transformer 40010, the coefficient quantizer 40011, and/or the arithmetic encoder 40012 perform attribute encoding. As described above, one point may have one or more attributes. The attribute encoding according to the embodiments is equally applied to the attributes that one point has. However, when an attribute (e.g., color) includes one or more elements, attribute encoding is independently applied to each element. The attribute encoding according to the embodiments includes color transform coding, attribute transform coding, region adaptive hierarchical transform (RAHT) coding, interpolation-based hierarchical nearest-neighbor prediction (prediction transform) coding, and interpolation-based hierarchical nearest-neighbor prediction with an update/lifting step (lifting transform) coding. Depending on the point cloud content, the RAHT coding, the prediction transform coding and the lifting transform coding described above may be selectively used, or a combination of one or more of the coding schemes may be used. The attribute encoding according to the embodiments is not limited to the above-described example.

The color transformer 40006 according to the embodiments performs color transform coding of transforming color values (or textures) included in the attributes. For example, the color transformer 40006 may transform the format of color information (for example, from RGB to YCbCr). The operation of the color transformer 40006 according to embodiments may be optionally applied according to the color values included in the attributes.

The geometry reconstructor 40005 according to the embodiments reconstructs (decompresses) the octree and/or the approximated octree. The geometry reconstructor 40005 reconstructs the octree/voxels based on the result of analyzing the distribution of points. The reconstructed octree/voxels may be referred to as reconstructed geometry (restored geometry).

The attribute transformer 40007 according to the embodiments performs attribute transformation to transform the attributes based on the reconstructed geometry and/or the positions on which geometry encoding is not performed. As described above, since the attributes are dependent on the geometry, the attribute transformer 40007 may transform the attributes based on the reconstructed geometry information. For example, based on the position value of a point included in a voxel, the attribute transformer 40007 may transform the attribute of the point at the position. As described above, when the position of the center of a voxel is set based on the positions of one or more points included in the voxel, the attribute transformer 40007 transforms the attributes of the one or more points. When the trisoup geometry encoding is performed, the attribute transformer 40007 may transform the attributes based on the trisoup geometry encoding.

The attribute transformer 40007 may perform the attribute transformation by calculating the average of attributes or attribute values of neighboring points (e.g., color or reflectance of each point) within a specific position/radius from the position (or position value) of the center of each voxel. The attribute transformer 40007 may apply a weight according to the distance from the center to each point in calculating the average. Accordingly, each voxel has a position and a calculated attribute (or attribute value).

The attribute transformer 40007 may search for neighboring points existing within a specific position/radius from the position of the center of each voxel based on the K-D tree or the Morton code. The K-D tree is a binary search tree and supports a data structure capable of managing points based on the positions such that nearest neighbor search (NNS) can be performed quickly. The Morton code is generated by presenting coordinates (e.g., (x, y, z)) representing 3D positions of all points as bit values and mixing the bits. For example, when the coordinates representing the position of a point are (5, 9, 1), the bit values for the coordinates are (0101, 1001, 0001). Mixing the bit values according to the bit index in order of z, y, and x yields 010001000111. This value is expressed as a decimal number of 1095. That is, the Morton code value of the point having coordinates (5, 9, 1) is 1095. The attribute transformer 40007 may order the points based on the Morton code values and perform NNS through a depth-first traversal process. After the attribute transformation operation, the K-D tree or the Morton code is used when the NNS is needed in another transformation process for attribute coding.

As shown in the figure, the transformed attributes are input to the RAHT transformer 40008 and/or the LOD generator 40009.

The RAHT transformer 40008 according to the embodiments performs RAHT coding for predicting attribute information based on the reconstructed geometry information. For example, the RAHT transformer 40008 may predict attribute information of a node at a higher level in the octree based on the attribute information associated with a node at a lower level in the octree.

The LOD generator 40009 according to the embodiments generates a level of detail (LOD). The LOD according to the embodiments is a degree of detail of point cloud content. As the LOD value decrease, it indicates that the detail of the point cloud content is degraded. As the LOD value increases, it indicates that the detail of the point cloud content is enhanced. Points may be classified by the LOD.

The lifting transformer 40010 according to the embodiments performs lifting transform coding of transforming the attributes a point cloud based on weights. As described above, lifting transform coding may be optionally applied.

The coefficient quantizer 40011 according to the embodiments quantizes the attribute-coded attributes based on coefficients.

The arithmetic encoder 40012 according to the embodiments encodes the quantized attributes based on arithmetic coding.

Although not shown in the figure, the elements of the point cloud video encoder of FIG. 4 may be implemented by hardware including one or more processors or integrated circuits configured to communicate with one or more memories included in the point cloud content providing apparatus, software, firmware, or a combination thereof. The one or more processors may perform at least one of the operations and/or functions of the elements of the point cloud video encoder of FIG. 4 described above. Additionally, the one or more processors may operate or execute a set of software programs and/or instructions for performing the operations and/or functions of the elements of the point cloud video encoder of FIG. 4. The one or more memories according to the embodiments may include a high speed random access memory, or include a non-volatile memory (e.g., one or more magnetic disk storage devices, flash memory devices, or other non-volatile solid-state memory devices).

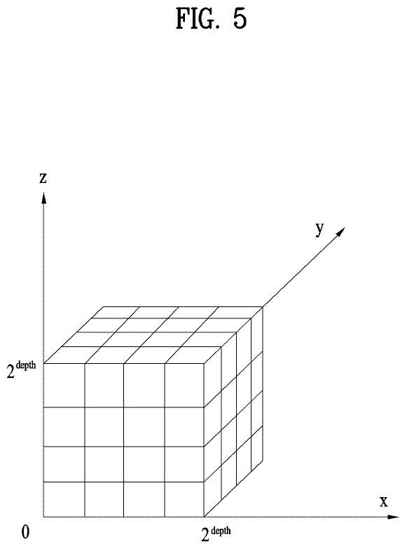

FIG. 5 shows an example of voxels according to embodiments.

FIG. 5 shows voxels positioned in a 3D space represented by a coordinate system composed of three axes, which are the X-axis, the Y-axis, and the Z-axis. As described with reference to FIG. 4, the point cloud video encoder (e.g., the quantizer 40001) may perform voxelization. Voxel refers to a 3D cubic space generated when a 3D space is divided into units (unit=1.0) based on the axes representing the 3D space (e.g., X-axis, Y-axis, and Z-axis). FIG. 5 shows an example of voxels generated through an octree structure in which a cubical axis-aligned bounding box defined by two poles (0, 0, 0) and (2^{d}, 2^{d}, 2^{d}) is recursively subdivided. One voxel includes at least one point. The spatial coordinates of a voxel may be estimated from the positional relationship with a voxel group. As described above, a voxel has an attribute (such as color or reflectance) like pixels of a 2D image/video. The details of the voxel are the same as those described with reference to FIG. 4, and therefore a description thereof is omitted.

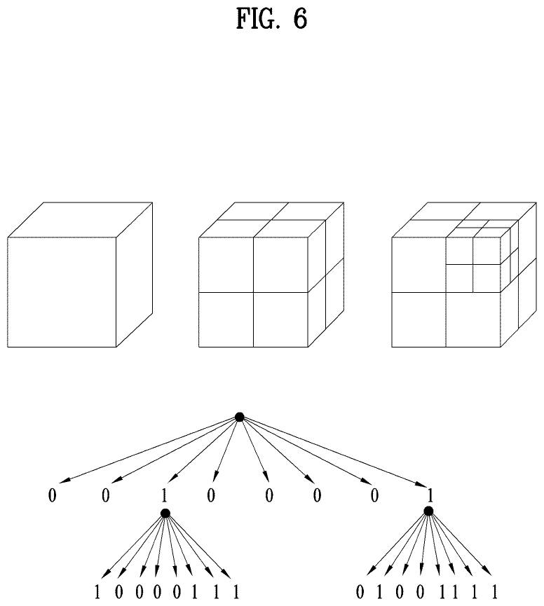

FIG. 6 shows an example of an octree and occupancy code according to embodiments.

As described with reference to FIGS. 1 to 4, the point cloud content providing system (point cloud video encoder 10002) or the octree analyzer 40002 of the point cloud video encoder performs octree geometry coding (or octree coding) based on an octree structure to efficiently manage the region and/or position of the voxel.

The upper part of FIG. 6 shows an octree structure. The 3D space of the point cloud content according to the embodiments is represented by axes (e.g., X-axis, Y-axis, and Z-axis) of the coordinate system. The octree structure is created by recursive subdividing of a cubical axis-aligned bounding box defined by two poles (0, 0, 0) and (2^{d}, 2^{d}, 2^{d}). Here, 2^{d} may be set to a value constituting the smallest bounding box surrounding all points of the point cloud content (or point cloud video). Here, d denotes the depth of the octree. The value of d is determined in Equation 1. In Equation 1, (x^{int}ₙ, y^{int}ₙ, z^{int}ₙ) denotes the positions (or position values) of quantized points.

$$d = Ceil ( Log 2 ( Max ( {x}_{n}^{int} , {y}_{n}^{int} , {z}_{n}^{int} , n = 1 , … , N ) + 1 ) ) \qquad Equation 1$$

As shown in the middle of the upper part of FIG. 6, the entire 3D space may be divided into eight spaces according to partition. Each divided space is represented by a cube with six faces. As shown in the upper right of FIG. 6, each of the eight spaces is divided again based on the axes of the coordinate system (e.g., X-axis, Y-axis, and Z-axis). Accordingly, each space is divided into eight smaller spaces. The divided smaller space is also represented by a cube with six faces. This partitioning scheme is applied until the leaf node of the octree becomes a voxel.

The lower part of FIG. 6 shows an octree occupancy code. The occupancy code of the octree is generated to indicate whether each of the eight divided spaces generated by dividing one space contains at least one point. Accordingly, a single occupancy code is represented by eight child nodes. Each child node represents the occupancy of a divided space, and the child node has a value in 1 bit. Accordingly, the occupancy code is represented as an 8-bit code. That is, when at least one point is contained in the space corresponding to a child node, the node is assigned a value of 1. When no point is contained in the space corresponding to the child node (the space is empty), the node is assigned a value of 0. Since the occupancy code shown in FIG. 6 is 00100001, it indicates that the spaces corresponding to the third child node and the eighth child node among the eight child nodes each contain at least one point. As shown in the figure, each of the third child node and the eighth child node has eight child nodes, and the child nodes are represented by an 8-bit occupancy code. The figure shows that the occupancy code of the third child node is 10000111, and the occupancy code of the eighth child node is 01001111. The point cloud video encoder (e.g., the arithmetic encoder 40004) according to the embodiments may perform entropy encoding on the occupancy codes. In order to increase the compression efficiency, the point cloud video encoder may perform intra/inter-coding on the occupancy codes. The reception device (e.g., the reception device 10004 or the point cloud video decoder 10006) according to the embodiments reconstructs the octree based on the occupancy codes.

The point cloud video encoder (e.g., the octree analyzer 40002) according to the embodiments may perform voxelization and octree coding to store the positions of points. However, points are not always evenly distributed in the 3D space, and accordingly there may be a specific region in which fewer points are present. Accordingly, it is inefficient to perform voxelization for the entire 3D space. For example, when a specific region contains few points, voxelization does not need to be performed in the specific region.

Accordingly, for the above-described specific region (or a node other than the leaf node of the octree), the point cloud video encoder according to the embodiments may skip voxelization and perform direct coding to directly code the positions of points included in the specific region. The coordinates of a direct coding point according to the embodiments are referred to as direct coding mode (DCM). The point cloud video encoder according to the embodiments may also perform trisoup geometry encoding, which is to reconstruct the positions of the points in the specific region (or node) based on voxels, based on a surface model. The trisoup geometry encoding is geometry encoding that represents an object as a series of triangular meshes. Accordingly, the point cloud video decoder may generate a point cloud from the mesh surface. The direct coding and trisoup geometry encoding according to the embodiments may be selectively performed. In addition, the direct coding and trisoup geometry encoding according to the embodiments may be performed in combination with octree geometry coding (or octree coding).

To perform direct coding, the option to use the direct mode for applying direct coding should be activated. A node to which direct coding is to be applied is not a leaf node, and points less than a threshold should be present within a specific node. In addition, the total number of points to which direct coding is to be applied should not exceed a preset threshold. When the conditions above are satisfied, the point cloud video encoder (or the arithmetic encoder 40004) according to the embodiments may perform entropy coding on the positions (or position values) of the points.

The point cloud video encoder (e.g., the surface approximation analyzer 40003) according to the embodiments may determine a specific level of the octree (a level less than the depth d of the octree), and the surface model may be used staring with that level to perform trisoup geometry encoding to reconstruct the positions of points in the region of the node based on voxels (Trisoup mode). The point cloud video encoder according to the embodiments may specify a level at which trisoup geometry encoding is to be applied. For example, when the specific level is equal to the depth of the octree, the point cloud video encoder does not operate in the trisoup mode. In other words, the point cloud video encoder according to the embodiments may operate in the trisoup mode only when the specified level is less than the value of depth of the octree. The 3D cube region of the nodes at the specified level according to the embodiments is called a block. One block may include one or more voxels. The block or voxel may correspond to a brick. Geometry is represented as a surface within each block. The surface according to embodiments may intersect with each edge of a block at most once.

One block has 12 edges, and accordingly there are at least 12 intersections in one block. Each intersection is called a vertex (or apex). A vertex present along an edge is detected when there is at least one occupied voxel adjacent to the edge among all blocks sharing the edge. The occupied voxel according to the embodiments refers to a voxel containing a point. The position of the vertex detected along the edge is the average position along the edge of all voxels adjacent to the edge among all blocks sharing the edge.

Once the vertex is detected, the point cloud video encoder according to the embodiments may perform entropy encoding on the starting point (x, y, z) of the edge, the direction vector (Δx, Δy, Δz) of the edge, and the vertex position value (relative position value within the edge). When the trisoup geometry encoding is applied, the point cloud video encoder according to the embodiments (e.g., the geometry reconstructor 40005) may generate restored geometry (reconstructed geometry) by performing the triangle reconstruction, up-sampling, and voxelization processes.

The vertices positioned at the edge of the block determine a surface that passes through the block. The surface according to the embodiments is a non-planar polygon. In the triangle reconstruction process, a surface represented by a triangle is reconstructed based on the starting point of the edge, the direction vector of the edge, and the position values of the vertices. The triangle reconstruction process is performed according to Equation 2 by: i) calculating the centroid value of each vertex, ii) subtracting the center value from each vertex value, and iii) estimating the sum of the squares of the values obtained by the subtraction.

$$[ \begin{matrix}{μ}_{x} \\ {μ}_{y} \\ {μ}_{z}\end{matrix} ] = \frac{1}{n} {\sum }_{i = 1}^{n} [ \begin{matrix}{x}_{i} \\ {y}_{i} \\ {z}_{i}\end{matrix} ] [ \begin{matrix}{\overline{x}}_{i} \\ {\overline{y}}_{i} \\ {\overline{z}}_{i}\end{matrix} ] = [ \begin{matrix}{x}_{i} \\ {y}_{i} \\ {z}_{i}\end{matrix} ] - [ \begin{matrix}{μ}_{x} \\ {μ}_{y} \\ {μ}_{z}\end{matrix} ] [ \begin{matrix}{σ}_{x}^{2} \\ {σ}_{y}^{2} \\ {σ}_{z}^{2}\end{matrix} ] = {\sum }_{i = 1}^{n} [ \begin{matrix}{\overline{x}}_{i}^{2} \\ {\overline{y}}_{i}^{2} \\ {\overline{z}}_{i}^{2}\end{matrix} ] \qquad Equation 2$$

Then, the minimum value of the sum is estimated, and the projection process is performed according to the axis with the minimum value. For example, when the element x is the minimum, each vertex is projected on the x-axis with respect to the center of the block, and projected on the (y, z) plane. When the values obtained through projection on the (y, z) plane are (ai, bi), the value of θ is estimated through atan2 (bi, ai), and the vertices are ordered based on the value of θ. The table 1 below shows a combination of vertices for creating a triangle According to the number of the vertices. The vertices are ordered from 1 to n. The table 1 below shows that for four vertices, two triangles may be constructed according to combinations of vertices. The first triangle may consist of vertices 1, 2, and 3 among the ordered vertices, and the second triangle may consist of vertices 3, 4, and 1 among the ordered vertices.

TABLE 1
Triangles formed from vertices ordered 1, . . . , n

| n | Triangles |
|---|---|
| 3 | (1, 2, 3) |
| 4 | (1, 2, 3), (3, 4, 1) |
| 5 | (1, 2, 3), (3, 4, 5), (5, 1, 3) |
| 6 | (1, 2, 3), (3, 4, 5), (5, 6, 1), (1, 3, 5) |
| 7 | (1, 2, 3), (3, 4, 5), (5, 6, 7), (7, 1, 3), (3, 5, 7) |
| 8 | (1, 2, 3), (3, 4, 5), (5, 6, 7), (7, 8, 1), (1, 3, 5), (5, 7, 1) |
| 9 | (1, 2, 3), (3, 4, 5), (5, 6, 7), (7, 8, 9), (9, 1, 3), (3, 5, 7), |
| | (7, 9, 3) |
| 10 | (1, 2, 3), (3, 4, 5), (5, 6, 7), (7, 8, 9), (9, 10, 1), (1, 3, 5), |
| | (5, 7, 9), (9, 1, 5) |
| 11 | (1, 2, 3), (3, 4, 5), (5, 6, 7), (7, 8, 9), (9, 10, 11), (11, 1, 3), |
| | (3, 5, 7), (7, 9, 11), (11, 3, 7) |
| 12 | (1, 2, 3), (3, 4, 5), (5, 6, 7), (7, 8, 9), (9, 10, 11), (11, 12, 1), |
| | (1, 3, 5), (5, 7, 9), (9, 11, 1), (1, 5, 9) |

The upsampling process is performed to add points in the middle along the edge of the triangle and perform voxelization. The added points are generated based on the upsampling factor and the width of the block. The added points are called refined vertices. The point cloud video encoder according to the embodiments may voxelize the refined vertices. In addition, the point cloud video encoder may perform attribute encoding based on the voxelized positions (or position values).

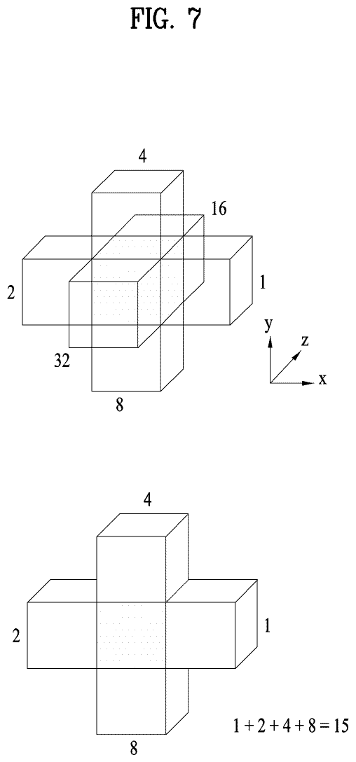

FIG. 7 shows an example of a neighbor node pattern according to embodiments.

In order to increase the compression efficiency of the point cloud video, the point cloud video encoder according to the embodiments may perform entropy coding based on context adaptive arithmetic coding.

As described with reference to FIGS. 1 to 6, the point cloud content providing system or the point cloud video encoder 10002 of FIG. 1, or the point cloud video encoder or arithmetic encoder 40004 of FIG. 4 may perform entropy coding on the occupancy code immediately. In addition, the point cloud content providing system or the point cloud video encoder may perform entropy encoding (intra encoding) based on the occupancy code of the current node and the occupancy of neighboring nodes, or perform entropy encoding (inter encoding) based on the occupancy code of the previous frame. A frame according to embodiments represents a set of point cloud videos generated at the same time. The compression efficiency of intra encoding/inter encoding according to the embodiments may depend on the number of neighboring nodes that are referenced. When the bits increase, the operation becomes complicated, but the encoding may be biased to one side, which may increase the compression efficiency. For example, when a 3-bit context is given, coding needs to be performed using 2³=8 methods. The part divided for coding affects the complexity of implementation. Accordingly, it is necessary to meet an appropriate level of compression efficiency and complexity.

FIG. 7 illustrates a process of obtaining an occupancy pattern based on the occupancy of neighbor nodes. The point cloud video encoder according to the embodiments determines occupancy of neighbor nodes of each node of the octree and obtains a value of a neighbor pattern. The neighbor node pattern is used to infer the occupancy pattern of the node. The upper part of FIG. 7 shows a cube corresponding to a node (a cube positioned in the middle) and six cubes (neighbor nodes) sharing at least one face with the cube. The nodes shown in the figure are nodes of the same depth. The numbers shown in the figure represent weights (1, 2, 4, 8, 16, and 32) associated with the six nodes, respectively. The weights are assigned sequentially according to the positions of neighboring nodes.

The lower part of FIG. 7 shows neighbor node pattern values. A neighbor node pattern value is the sum of values multiplied by the weight of an occupied neighbor node (a neighbor node having a point). Accordingly, the neighbor node pattern values are 0 to 63. When the neighbor node pattern value is 0, it indicates that there is no node having a point (no occupied node) among the neighbor nodes of the node. When the neighbor node pattern value is 63, it indicates that all neighbor nodes are occupied nodes. As shown in the figure, since neighbor nodes to which weights 1, 2, 4, and 8 are assigned are occupied nodes, the neighbor node pattern value is 15, the sum of 1, 2, 4, and 8. The point cloud video encoder may perform coding according to the neighbor node pattern value (for example, when the neighbor node pattern value is 63, 64 kinds of coding may be performed). According to embodiments, the point cloud video encoder may reduce coding complexity by changing a neighbor node pattern value (for example, based on a table by which 64 is changed to 10 or 6).

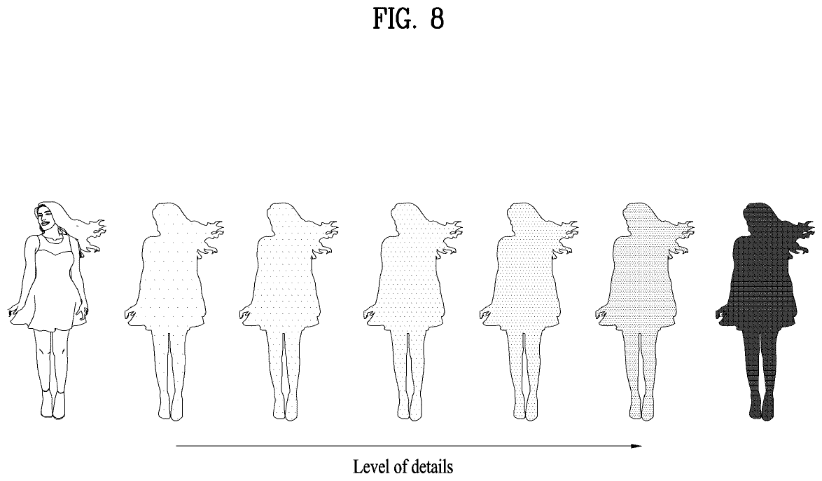

FIG. 8 illustrates an example of point configuration in each LOD according to embodiments.

As described with reference to FIGS. 1 to 7, encoded geometry is reconstructed (decompressed) before attribute encoding is performed. When direct coding is applied, the geometry reconstruction operation may include changing the placement of direct coded points (e.g., placing the direct coded points in front of the point cloud data). When trisoup geometry encoding is applied, the geometry reconstruction process is performed through triangle reconstruction, up-sampling, and voxelization. Since the attribute depends on the geometry, attribute encoding is performed based on the reconstructed geometry.

The point cloud video encoder (e.g., the LOD generator 40009) may classify (reorganize or group) points by LOD. FIG. 8 shows the point cloud content corresponding to LODs. The leftmost picture in FIG. 8 represents original point cloud content. The second picture from the left of FIG. 8 represents distribution of the points in the lowest LOD, and the rightmost picture in FIG. 8 represents distribution of the points in the highest LOD. That is, the points in the lowest LOD are sparsely distributed, and the points in the highest LOD are densely distributed. That is, as the LOD rises in the direction pointed by the arrow indicated at the bottom of FIG. 8, the space (or distance) between points is narrowed.

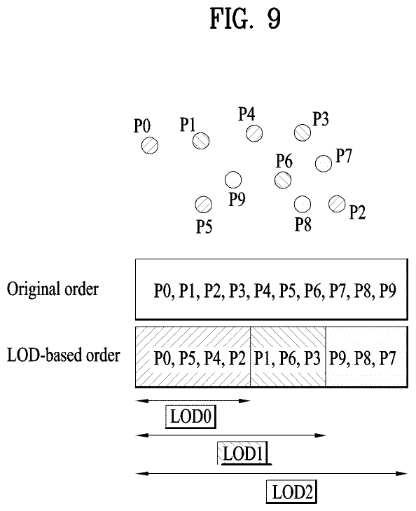

FIG. 9 illustrates an example of point configuration for each LOD according to embodiments.

As described with reference to FIGS. 1 to 8, the point cloud content providing system, or the point cloud video encoder (e.g., the point cloud video encoder 10002 of FIG. 1, the point cloud video encoder of FIG. 4, or the LOD generator 40009) may generates an LOD. The LOD is generated by reorganizing the points into a set of refinement levels according to a set LOD distance value (or a set of Euclidean distances). The LOD generation process is performed not only by the point cloud video encoder, but also by the point cloud video decoder.

The upper part of FIG. 9 shows examples (P0 to P9) of points of the point cloud content distributed in a 3D space. In FIG. 9, the original order represents the order of points P0 to P9 before LOD generation. In FIG. 9, the LOD based order represents the order of points according to the LOD generation. Points are reorganized by LOD. Also, a high LOD contains the points belonging to lower LODs. As shown in FIG. 9, LOD0 contains P0, P5, P4 and P2. LOD1 contains the points of LOD0, P1, P6 and P3. LOD2 contains the points of LOD0, the points of LOD1, P9, P8 and P7.

As described with reference to FIG. 4, the point cloud video encoder according to the embodiments may perform prediction transform coding based on LOD, lifting transform coding based on LOD, and RAHT transform coding selectively or in combination.

The point cloud video encoder according to the embodiments may generate a predictor for points to perform prediction transform coding based on LOD for setting a predicted attribute (or predicted attribute value) of each point. That is, N predictors may be generated for N points. The predictor according to the embodiments may calculate a weight (=1/distance) based on the LOD value of each point, indexing information about neighboring points present within a set distance for each LOD, and a distance to the neighboring points.

The predicted attribute (or attribute value) according to the embodiments is set to the average of values obtained by multiplying the attributes (or attribute values) (e.g., color, reflectance, etc.) of neighbor points set in the predictor of each point by a weight (or weight value) calculated based on the distance to each neighbor point. The point cloud video encoder according to the embodiments (e.g., the coefficient quantizer 40011) may quantize and inversely quantize the residual of each point (which may be called residual attribute, residual attribute value, attribute prediction residual value or prediction error attribute value and so on) obtained by subtracting a predicted attribute (or attribute value) each point from the attribute (i.e., original attribute value) of each point. The quantization process performed for a residual attribute value in a transmission device is configured as shown in table 2. The inverse quantization process performed for a residual attribute value in a reception device is configured as shown in table 3.

TABLE 2

int PCCQuantization(int value, int quantStep) {
if( value >=0) {
return floor(value / quantStep + 1.0 / 3.0);
} else {
return −floor(−value / quantStep + 1.0 / 3.0);
}
}

TABLE 3

int PCCInverseQuantization(int value, int quantStep) {
if( quantStep ==0) {
return value;
} else {
return value * quantStep;
}
}

When the predictor of each point has neighbor points, the point cloud video encoder (e.g., the arithmetic encoder 40012) according to the embodiments may perform entropy coding on the quantized and inversely quantized residual attribute values as described above. When the predictor of each point has no neighbor point, the point cloud video encoder according to the embodiments (e.g., the arithmetic encoder 40012) may perform entropy coding on the attributes of the corresponding point without performing the above-described operation. The point cloud video encoder according to the embodiments (e.g., the lifting transformer 40010) may generate a predictor of each point, set the calculated LOD and register neighbor points in the predictor, and set weights according to the distances to neighbor points to perform lifting transform coding. The lifting transform coding according to the embodiments is similar to the above-described prediction transform coding, but differs therefrom in that weights are cumulatively applied to attribute values. The process of cumulatively applying weights to the attribute values according to embodiments is configured as follows. 1) Create an array Quantization Weight (QW) for storing the weight value of each point. The initial value of all elements of QW is 1.0. Multiply the QW values of the predictor indexes of the neighbor nodes registered in the predictor by the weight of the predictor of the current point, and add the values obtained by the multiplication.

2) Lift prediction process: Subtract the value obtained by multiplying the attribute value of the point by the weight from the existing attribute value to calculate a predicted attribute value.

3) Create temporary arrays called updateweight and update and initialize the temporary arrays to zero.

4) Cumulatively add the weights calculated by multiplying the weights calculated for all predictors by a weight stored in the QW corresponding to a predictor index to the updateweight array as indexes of neighbor nodes. Cumulatively add, to the update array, a value obtained by multiplying the attribute value of the index of a neighbor node by the calculated weight.

5) Lift update process: Divide the attribute values of the update array for all predictors by the weight value of the updateweight array of the predictor index, and add the existing attribute value to the values obtained by the division.

6) Calculate predicted attributes by multiplying the attribute values updated through the lift update process by the weight updated through the lift prediction process (stored in the QW) for all predictors. The point cloud video encoder (e.g., coefficient quantizer 40011) according to the embodiments quantizes the predicted attribute values. In addition, the point cloud video encoder (e.g., the arithmetic encoder 40012) performs entropy coding on the quantized attribute values.

The point cloud video encoder (e.g., the RAHT transformer 40008) according to the embodiments may perform RAHT transform coding in which attributes of nodes of a higher level are predicted using the attributes associated with nodes of a lower level in the octree. RAHT transform coding is an example of attribute intra coding through an octree backward scan. The point cloud video encoder according to the embodiments scans the entire region from the voxel and repeats the merging process of merging the voxels into a larger block at each step until the root node is reached. The merging process according to the embodiments is performed only on the occupied nodes. The merging process is not performed on the empty node. The merging process is performed on an upper node immediately above the empty node.

Equation 3 below represents a RAHT transformation matrix. In Equation 3, gₗ_{_{x,y,z}} denotes the average attribute value of voxels at level l. gₗ_{_{x,y,z}} may be calculated based on gₗ₊₁_{_{2x,y,z}} and

$${g}_{l + {1}_{2 x + 1 , y , z}} .$$

The weights for gₗ_{_{2x,y,z}} and gₗ_{_{2x+1,y,z}} are w1=wₗ_{_{2x,y,z}} and

$$w 2 = {w}_{{l}_{2 x + 1 , y , z}} .$$

$$⌈ \begin{matrix}{g}_{l - {1}_{x , y , z}} \\ {h}_{l - {1}_{x , y , z}}\end{matrix} ⌉ = {T}_{w 1 w 2} ⌈ \begin{matrix}{g}_{{l}_{2 x , y , z}} \\ {h}_{{l}_{2 x + 1 , y , z}}\end{matrix} ⌉ {T}_{w 1 w 2} + \frac{1}{\sqrt{w 1 + w 2}} [ \begin{matrix}\sqrt{w 1} & \sqrt{w 2} \\ - \sqrt{w 2} & \sqrt{w 1}\end{matrix} ] \qquad Equation 3$$

Here, gₗ₋₁_{_{x,y,z}} is a low-pass value and is used in the merging process at the next higher level. hₗ₋₁_{_{x,y,z}} denotes high-pass coefficients. The high-pass coefficients at each step are quantized and subjected to entropy coding (e.g., encoding by the arithmetic encoder 40012). The weights are calculated as

$${w}_{{l}_{- 1 x , y , z}} = {w}_{{l}_{2 x , y , z}} + {w}_{{l}_{2 x + 1 , y , z}} .$$

The root node is created through the g₁_{_{0,0,0}} and g₁_{_{0,0,1}} as Equation 4.

$$⌈ \begin{matrix}gDC \\ {h}_{{0}_{0 , 0 , 0}}\end{matrix} ⌉ = {T}_{w 1000 w 1001} ⌈ \begin{matrix}{g}_{{1}_{0 , 0 , 0 z}} \\ {g}_{{1}_{0 , 0 , 1}}\end{matrix} ⌉ \qquad Equation 4$$

The value of gDC is also quantized and subjected to entropy coding like the high-pass coefficients.

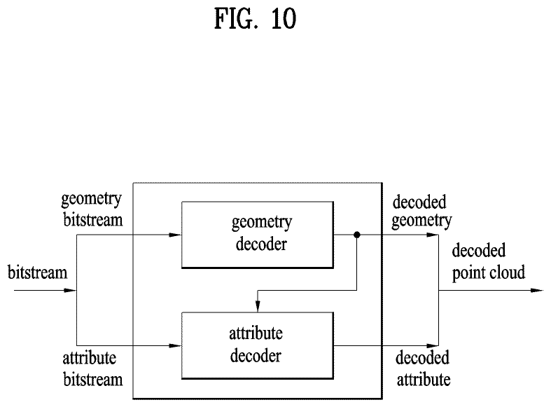

FIG. 10 illustrates a point cloud video decoder according to embodiments.

The point cloud video decoder illustrated in FIG. 10 is an example of the point cloud video decoder 10006 described in FIG. 1, and may perform the same or similar operations as the operations of the point cloud video decoder 10006 illustrated in FIG. 1. As shown in the figure, the point cloud video decoder may receive a geometry bitstream and an attribute bitstream contained in one or more bitstreams. The point cloud video decoder includes a geometry decoder and an attribute decoder. The geometry decoder performs geometry decoding on the geometry bitstream and outputs decoded geometry. The attribute decoder performs attribute decoding on the attribute bitstream based on the decoded geometry, and outputs decoded attributes. The decoded geometry and decoded attributes are used to reconstruct point cloud content (a decoded point cloud).

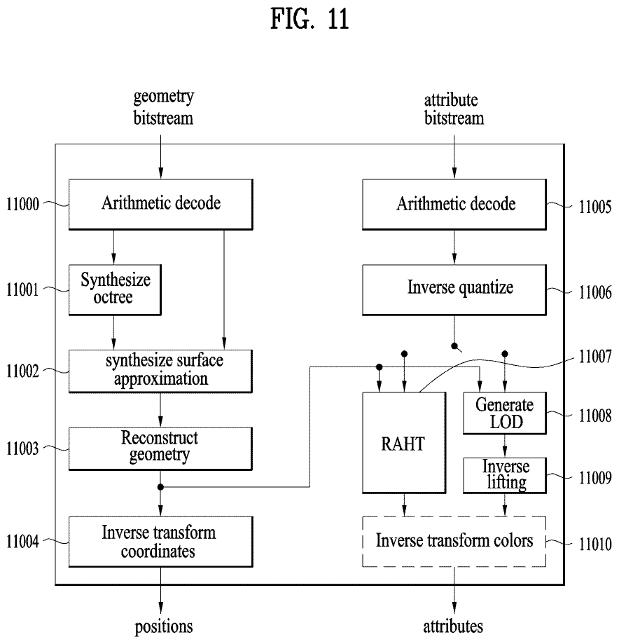

FIG. 11 illustrates a point cloud video decoder according to embodiments.

The point cloud video decoder illustrated in FIG. 11 is an example of the point cloud video decoder illustrated in FIG. 10, and may perform a decoding operation, which is a reverse process to the encoding operation of the point cloud video encoder illustrated in FIGS. 1 to 9.

As described with reference to FIGS. 1 and 10, the point cloud video decoder may perform geometry decoding and attribute decoding. The geometry decoding is performed before the attribute decoding.

The point cloud video decoder according to the embodiments includes an arithmetic decoder (Arithmetic decode) 11000, an octree synthesizer (Synthesize octree) 11001, a surface approximation synthesizer (Synthesize surface approximation) 11002, and a geometry reconstructor (Reconstruct geometry) 11003, a coordinate inverse transformer (Inverse transform coordinates) 11004, an arithmetic decoder (Arithmetic decode) 11005, an inverse quantizer (Inverse quantize) 11006, a RAHT transformer 11007, an LOD generator (Generate LOD) 11008, an inverse lifter (inverse lifting) 11009, and/or a color inverse transformer (Inverse transform colors) 11010.

The arithmetic decoder 11000, the octree synthesizer 11001, the surface approximation synthesizer 11002, and the geometry reconstructor 11003, and the coordinate inverse transformer 11004 may perform geometry decoding. The geometry decoding according to the embodiments may include direct decoding and trisoup geometry decoding. The direct decoding and trisoup geometry decoding are selectively applied. The geometry decoding is not limited to the above-described example, and is performed as a reverse process to the geometry encoding described with reference to FIGS. 1 to 9.

The arithmetic decoder 11000 according to the embodiments decodes the received geometry bitstream based on the arithmetic coding. The operation of the arithmetic decoder 11000 corresponds to the reverse process to the arithmetic encoder 40004.

The octree synthesizer 11001 according to the embodiments may generate an octree by acquiring an occupancy code from the decoded geometry bitstream (or information on the geometry secured as a result of decoding). The occupancy code is configured as described in detail with reference to FIGS. 1 to 9.

When the trisoup geometry encoding is applied, the surface approximation synthesizer 11002 according to the embodiments may synthesize a surface based on the decoded geometry and/or the generated octree.

The geometry reconstructor 11003 according to the embodiments may regenerate geometry based on the surface and/or the decoded geometry. As described with reference to FIGS. 1 to 9, direct coding and trisoup geometry encoding are selectively applied. Accordingly, the geometry reconstructor 11003 directly imports and adds position information about the points to which direct coding is applied. When the trisoup geometry encoding is applied, the geometry reconstructor 11003 may reconstruct the geometry by performing the reconstruction operations of the geometry reconstructor 40005, for example, triangle reconstruction, up-sampling, and voxelization. Details are the same as those described with reference to FIG. 6, and thus description thereof is omitted. The reconstructed geometry may include a point cloud picture or frame that does not contain attributes.

The coordinate inverse transformer 11004 according to the embodiments may acquire positions of the points by transforming the coordinates based on the reconstructed geometry.

The arithmetic decoder 11005, the inverse quantizer 11006, the RAHT transformer 11007, the LOD generator 11008, the inverse lifter 11009, and/or the color inverse transformer 11010 may perform the attribute decoding described with reference to FIG. 10. The attribute decoding according to the embodiments includes region adaptive hierarchical transform (RAHT) decoding, interpolation-based hierarchical nearest-neighbor prediction (prediction transform) decoding, and interpolation-based hierarchical nearest-neighbor prediction with an update/lifting step (lifting transform) decoding. The three decoding schemes described above may be used selectively, or a combination of one or more decoding schemes may be used. The attribute decoding according to the embodiments is not limited to the above-described example.

The arithmetic decoder 11005 according to the embodiments decodes the attribute bitstream by arithmetic coding.

The inverse quantizer 11006 according to the embodiments inversely quantizes the information about the decoded attribute bitstream or attributes secured as a result of the decoding, and outputs the inversely quantized attributes (or attribute values). The inverse quantization may be selectively applied based on the attribute encoding of the point cloud video encoder.

According to embodiments, the RAHT transformer 11007, the LOD generator 11008, and/or the inverse lifter 11009 may process the reconstructed geometry and the inversely quantized attributes. As described above, the RAHT transformer 11007, the LOD generator 11008, and/or the inverse lifter 11009 may selectively perform a decoding operation corresponding to the encoding of the point cloud video encoder.

The color inverse transformer 11010 according to the embodiments performs inverse transform coding to inversely transform a color value (or texture) included in the decoded attributes. The operation of the color inverse transformer 11010 may be selectively performed based on the operation of the color transformer 40006 of the point cloud video encoder.

Although not shown in the figure, the elements of the point cloud video decoder of FIG. 11 may be implemented by hardware including one or more processors or integrated circuits configured to communicate with one or more memories included in the point cloud content providing apparatus, software, firmware, or a combination thereof. The one or more processors may perform at least one or more of the operations and/or functions of the elements of the point cloud video decoder of FIG. 11 described above. Additionally, the one or more processors may operate or execute a set of software programs and/or instructions for performing the operations and/or functions of the elements of the point cloud video decoder of FIG. 11.

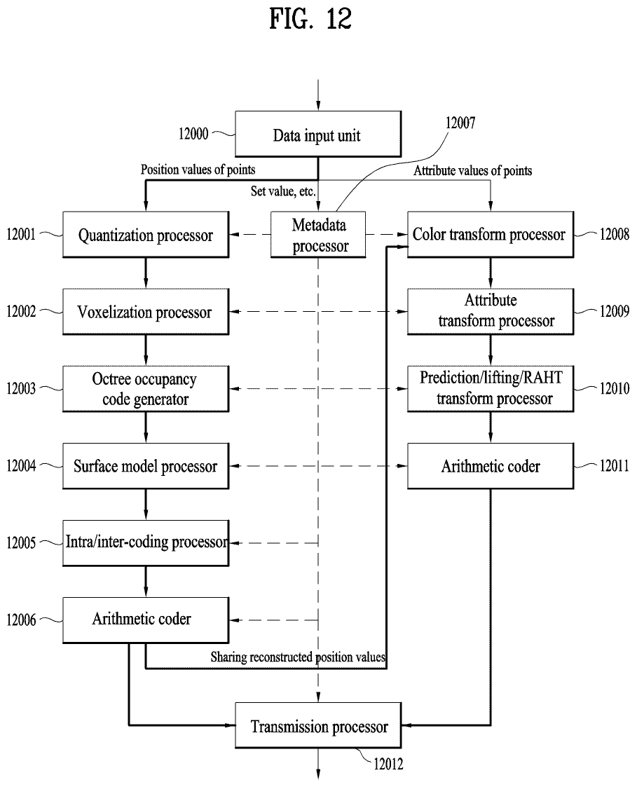

FIG. 12 illustrates a transmission device according to embodiments.

The transmission device shown in FIG. 12 is an example of the transmission device 10000 of FIG. 1 (or the point cloud video encoder of FIG. 4). The transmission device illustrated in FIG. 12 may perform one or more of the operations and methods the same as or similar to those of the point cloud video encoder described with reference to FIGS. 1 to 9. The transmission device according to the embodiments may include a data input unit 12000, a quantization processor 12001, a voxelization processor 12002, an octree occupancy code generator 12003, a surface model processor 12004, an intra/inter-coding processor 12005, an arithmetic coder 12006, a metadata processor 12007, a color transform processor 12008, an attribute transform processor 12009, a prediction/lifting/RAHT transform processor 12010, an arithmetic coder 12011 and/or a transmission processor 12012.

The data input unit 12000 according to the embodiments receives or acquires point cloud data. The data input unit 12000 may perform an operation and/or acquisition method the same as or similar to the operation and/or acquisition method of the point cloud video acquisition unit 10001 (or the acquisition process 20000 described with reference to FIG. 2).

The data input unit 12000, the quantization processor 12001, the voxelization processor 12002, the octree occupancy code generator 12003, the surface model processor 12004, the intra/inter-coding processor 12005, and the arithmetic coder 12006 perform geometry encoding. The geometry encoding according to the embodiments is the same as or similar to the geometry encoding described with reference to FIGS. 1 to 9, and thus a detailed description thereof is omitted.

The quantization processor 12001 according to the embodiments quantizes geometry (e.g., position values of points). The operation and/or quantization of the quantization processor 12001 is the same as or similar to the operation and/or quantization of the quantizer 40001 described with reference to FIG. 4. Details are the same as those described with reference to FIGS. 1 to 9.

The voxelization processor 12002 according to the embodiments voxelizes the quantized position values of the points. The voxelization processor 12002 may perform an operation and/or process the same or similar to the operation and/or the voxelization process of the quantizer 40001 described with reference to FIG. 4. Details are the same as those described with reference to FIGS. 1 to 9.

The octree occupancy code generator 12003 according to the embodiments performs octree coding on the voxelized positions of the points based on an octree structure. The octree occupancy code generator 12003 may generate an occupancy code. The octree occupancy code generator 12003 may perform an operation and/or method the same as or similar to the operation and/or method of the point cloud video encoder (or the octree analyzer 40002) described with reference to FIGS. 4 and 6. Details are the same as those described with reference to FIGS. 1 to 9.

The surface model processor 12004 according to the embodiments may perform trisoup geometry encoding based on a surface model to reconstruct the positions of points in a specific region (or node) on a voxel basis. The surface model processor 12004 may perform an operation and/or method the same as or similar to the operation and/or method of the point cloud video encoder (e.g., the surface approximation analyzer 40003) described with reference to FIG. 4. Details are the same as those described with reference to FIGS. 1 to 9.

The intra/inter-coding processor 12005 according to the embodiments may perform intra/inter-coding on point cloud data. The intra/inter-coding processor 12005 may perform coding the same as or similar to the intra/inter-coding described with reference to FIG. 7. Details are the same as those described with reference to FIG. 7. According to embodiments, the intra/inter-coding processor 12005 may be included in the arithmetic coder 12006.

The arithmetic coder 12006 according to the embodiments performs entropy encoding on an octree of the point cloud data and/or an approximated octree. For example, the encoding scheme includes arithmetic encoding. The arithmetic coder 12006 performs an operation and/or method the same as or similar to the operation and/or method of the arithmetic encoder 40004.

The metadata processor 12007 according to the embodiments processes metadata about the point cloud data, for example, a set value, and provides the same to a necessary processing process such as geometry encoding and/or attribute encoding. Also, the metadata processor 12007 according to the embodiments may generate and/or process signaling information related to the geometry encoding and/or the attribute encoding. The signaling information according to the embodiments may be encoded separately from the geometry encoding and/or the attribute encoding. The signaling information according to the embodiments may be interleaved.

The color transform processor 12008, the attribute transform processor 12009, the prediction/lifting/RAHT transform processor 12010, and the arithmetic coder 12011 perform the attribute encoding. The attribute encoding according to the embodiments is the same as or similar to the attribute encoding described with reference to FIGS. 1 to 9, and thus a detailed description thereof is omitted.

The color transform processor 12008 according to the embodiments performs color transform coding to transform color values included in attributes. The color transform processor 12008 may perform color transform coding based on the reconstructed geometry. The reconstructed geometry is the same as described with reference to FIGS. 1 to 9. Also, it performs an operation and/or method the same as or similar to the operation and/or method of the color transformer 40006 described with reference to FIG. 4 is performed. The detailed description thereof is omitted.

The attribute transform processor 12009 according to the embodiments performs attribute transformation to transform the attributes based on the reconstructed geometry and/or the positions on which geometry encoding is not performed. The attribute transform processor 12009 performs an operation and/or method the same as or similar to the operation and/or method of the attribute transformer 40007 described with reference to FIG. 4. A detailed description thereof is omitted. The prediction/lifting/RAHT transform processor 12010 according to the embodiments may code the transformed attributes by any one or a combination of RAHT coding, prediction transform coding, and lifting transform coding. The prediction/lifting/RAHT transform processor 12010 performs at least one of the operations the same as or similar to the operations of the RAHT transformer 40008, the LOD generator 40009, and the lifting transformer 40010 described with reference to FIG. 4. In addition, the prediction transform coding, the lifting transform coding, and the RAHT transform coding are the same as those described with reference to FIGS. 1 to 9, and thus a detailed description thereof is omitted.

The arithmetic coder 12011 according to the embodiments may encode the coded attributes based on the arithmetic coding. The arithmetic coder 12011 performs an operation and/or method the same as or similar to the operation and/or method of the arithmetic encoder 40012.

The transmission processor 12012 according to the embodiments may transmit each bitstream containing encoded geometry and/or encoded attributes and metadata, or transmit one bitstream configured with the encoded geometry and/or the encoded attributes and the metadata. When the encoded geometry and/or the encoded attributes and the metadata according to the embodiments are configured into one bitstream, the bitstream may include one or more sub-bitstreams. The bitstream according to the embodiments may contain signaling information including a sequence parameter set (SPS) for signaling of a sequence level, a geometry parameter set (GPS) for signaling of geometry information coding, an attribute parameter set (APS) for signaling of attribute information coding, and a tile parameter set (TPS or tile inventory) for signaling of a tile level, and slice data. The slice data may include information about one or more slices. One slice according to embodiments may include one geometry bitstream Geom0⁰ and one or more attribute bitstreams Attr0⁰ and Attr1⁰.

A slice refers to a series of syntax elements representing the entirety or part of a coded point cloud frame.

The TPS according to the embodiments may include information about each tile (e.g., coordinate information and height/size information about a bounding box) for one or more tiles. The geometry bitstream may contain a header and a payload. The header of the geometry bitstream according to the embodiments may contain a parameter set identifier (geom_parameter_set_id), a tile identifier (geom_tile_id) and a slice identifier (geom_slice_id) included in the GPS, and information about the data contained in the payload. As described above, the metadata processor 12007 according to the embodiments may generate and/or process the signaling information and transmit the same to the transmission processor 12012. According to embodiments, the elements to perform geometry encoding and the elements to perform attribute encoding may share data/information with each other as indicated by dotted lines. The transmission processor 12012 according to the embodiments may perform an operation and/or transmission method the same as or similar to the operation and/or transmission method of the transmitter 10003. Details are the same as those described with reference to FIGS. 1 and 2, and thus a description thereof is omitted.

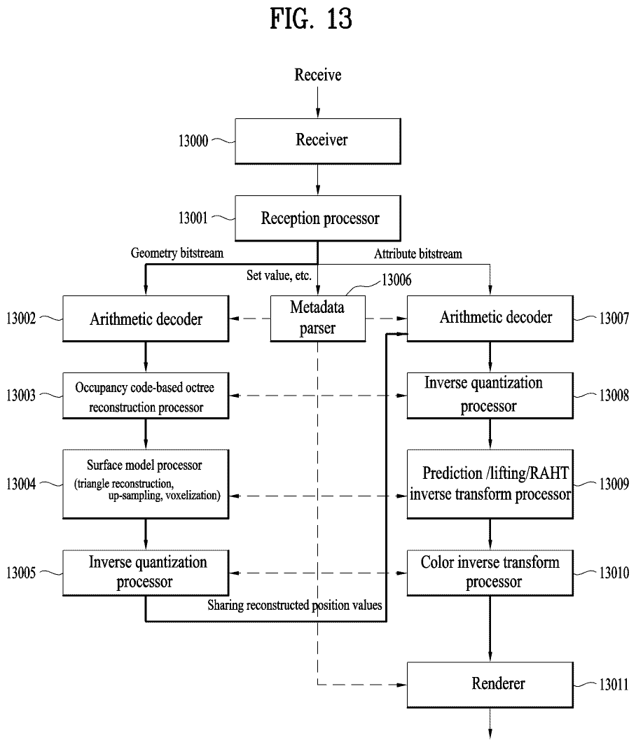

FIG. 13 illustrates a reception device according to embodiments.

The reception device illustrated in FIG. 13 is an example of the reception device 10004 of FIG. 1 (or the point cloud video decoder of FIGS. 10 and 11). The reception device illustrated in FIG. 13 may perform one or more of the operations and methods the same as or similar to those of the point cloud video decoder described with reference to FIGS. 1 to 11.

The reception device according to the embodiment includes a receiver 13000, a reception processor 13001, an arithmetic decoder 13002, an occupancy code-based octree reconstruction processor 13003, a surface model processor (triangle reconstruction, up-sampling, voxelization) 13004, an inverse quantization processor 13005, a metadata parser 13006, an arithmetic decoder 13007, an inverse quantization processor 13008, a prediction/lifting/RAHT inverse transform processor 13009, a color inverse transform processor 13010, and/or a renderer 13011. Each element for decoding according to the embodiments may perform a reverse process to the operation of a corresponding element for encoding according to the embodiments.

The receiver 13000 according to the embodiments receives point cloud data. The receiver 13000 may perform an operation and/or reception method the same as or similar to the operation and/or reception method of the receiver 10005 of FIG. 1. The detailed description thereof is omitted.

The reception processor 13001 according to the embodiments may acquire a geometry bitstream and/or an attribute bitstream from the received data. The reception processor 13001 may be included in the receiver 13000.

The arithmetic decoder 13002, the occupancy code-based octree reconstruction processor 13003, the surface model processor 13004, and the inverse quantization processor 13005 may perform geometry decoding. The geometry decoding according to embodiments is the same as or similar to the geometry decoding described with reference to FIGS. 1 to 10, and thus a detailed description thereof is omitted.

The arithmetic decoder 13002 according to the embodiments may decode the geometry bitstream based on arithmetic coding. The arithmetic decoder 13002 performs an operation and/or coding the same as or similar to the operation and/or coding of the arithmetic decoder 11000.

The occupancy code-based octree reconstruction processor 13003 according to the embodiments may reconstruct an octree by acquiring an occupancy code from the decoded geometry bitstream (or information about the geometry secured as a result of decoding). The occupancy code-based octree reconstruction processor 13003 performs an operation and/or method the same as or similar to the operation and/or octree generation method of the octree synthesizer 11001. When the trisoup geometry encoding is applied, the surface model processor 13004 according to the embodiments may perform trisoup geometry decoding and related geometry reconstruction (e.g., triangle reconstruction, up-sampling, voxelization) based on the surface model method. The surface model processor 13004 performs an operation the same as or similar to that of the surface approximation synthesizer 11002 and/or the geometry reconstructor 11003.

The inverse quantization processor 13005 according to the embodiments may inversely quantize the decoded geometry.

The metadata parser 13006 according to the embodiments may parse metadata contained in the received point cloud data, for example, a set value. The metadata parser 13006 may pass the metadata to geometry decoding and/or attribute decoding. The metadata is the same as that described with reference to FIG. 12, and thus a detailed description thereof is omitted.

The arithmetic decoder 13007, the inverse quantization processor 13008, the prediction/lifting/RAHT inverse transform processor 13009 and the color inverse transform processor 13010 perform attribute decoding. The attribute decoding is the same as or similar to the attribute decoding described with reference to FIGS. 1 to 10, and thus a detailed description thereof is omitted.

The arithmetic decoder 13007 according to the embodiments may decode the attribute bitstream by arithmetic coding. The arithmetic decoder 13007 may decode the attribute bitstream based on the reconstructed geometry. The arithmetic decoder 13007 performs an operation and/or coding the same as or similar to the operation and/or coding of the arithmetic decoder 11005.

The inverse quantization processor 13008 according to the embodiments may inversely quantize the decoded attribute bitstream. The inverse quantization processor 13008 performs an operation and/or method the same as or similar to the operation and/or inverse quantization method of the inverse quantizer 11006.

The prediction/lifting/RAHT inverse transform processor 13009 according to the embodiments may process the reconstructed geometry and the inversely quantized attributes. The prediction/lifting/RAHT inverse transform processor 13009 performs one or more of operations and/or decoding the same as or similar to the operations and/or decoding of the RAHT transformer 11007, the LOD generator 11008, and/or the inverse lifter 11009. The color inverse transform processor 13010 according to the embodiments performs inverse transform coding to inversely transform color values (or textures) included in the decoded attributes. The color inverse transform processor 13010 performs an operation and/or inverse transform coding the same as or similar to the operation and/or inverse transform coding of the color inverse transformer 11010. The renderer 13011 according to the embodiments may render the point cloud data.

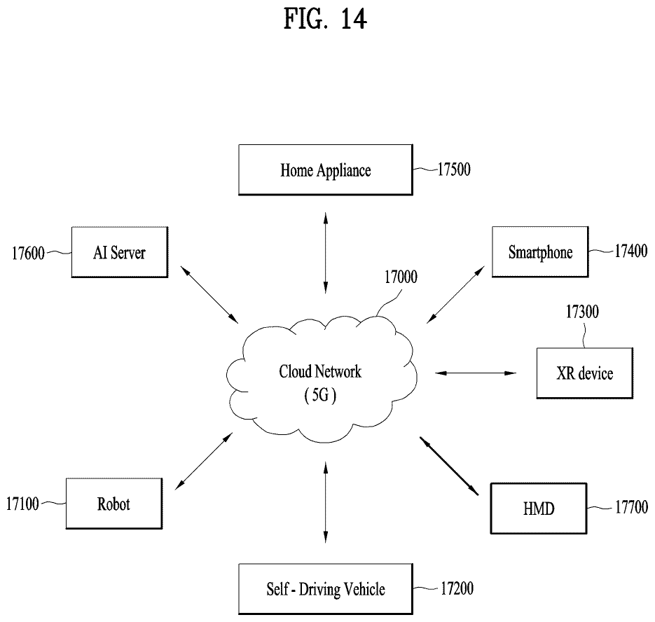

FIG. 14 shows an exemplary structure operatively connectable with a method/device for transmitting and receiving point cloud data according to embodiments.

The structure of FIG. 14 represents a configuration in which at least one of a server 17600, a robot 17100, a self-driving vehicle 17200, an XR device 17300, a smartphone 17400, a home appliance 17500, and/or a head-mount display (HMD) 17700 is connected to a cloud network 17000. The robot 17100, the self-driving vehicle 17200, the XR device 17300, the smartphone 17400, or the home appliance 17500 is referred to as a device. In addition, the XR device 17300 may correspond to a point cloud compressed data (PCC) device according to embodiments or may be operatively connected to the PCC device.

The cloud network 17000 may represent a network that constitutes part of the cloud computing infrastructure or is present in the cloud computing infrastructure. Here, the cloud network 17000 may be configured using a 3G network, 4G or Long Term Evolution (LTE) network, or a 5G network.

The server 17600 may be connected to at least one of the robot 17100, the self-driving vehicle 17200, the XR device 17300, the smartphone 17400, the home appliance 17500, and/or the HMD 17700 over the cloud network 17000 and may assist in at least a part of the processing of the connected devices 17100 to 17700.

The HMD 17700 represents one of the implementation types of the XR device and/or the PCC device according to the embodiments. The HMD type device according to the embodiments includes a communication unit, a control unit, a memory, an I/O unit, a sensor unit, and a power supply unit.

Hereinafter, various embodiments of the devices 17100 to 17500 to which the above-described technology is applied will be described. The devices 17100 to 17500 illustrated in FIG. 14 may be operatively connected/coupled to a point cloud data transmission device and reception device according to the above-described embodiments.

### <PCC+XR>

The XR/PCC device 17300 may employ PCC technology and/or XR (AR+VR) technology, and may be implemented as an HMD, a head-up display (HUD) provided in a vehicle, a television, a mobile phone, a smartphone, a computer, a wearable device, a home appliance, a digital signage, a vehicle, a stationary robot, or a mobile robot.

The XR/PCC device 17300 may analyze 3D point cloud data or image data acquired through various sensors or from an external device and generate position data and attribute data about 3D points. Thereby, the XR/PCC device 17300 may acquire information about the surrounding space or a real object, and render and output an XR object. For example, the XR/PCC device 17300 may match an XR object including auxiliary information about a recognized object with the recognized object and output the matched XR object.

### <PCC+Self-Driving+XR>

The self-driving vehicle 17200 may be implemented as a mobile robot, a vehicle, an unmanned aerial vehicle, or the like by applying the PCC technology and the XR technology.

The self-driving vehicle 17200 to which the XR/PCC technology is applied may represent a self-driving vehicle provided with means for providing an XR image, or a self-driving vehicle that is a target of control/interaction in the XR image. In particular, the self-driving vehicle 17200 which is a target of control/interaction in the XR image may be distinguished from the XR device 17300 and may be operatively connected thereto.

The self-driving vehicle 17200 having means for providing an XR/PCC image may acquire sensor information from sensors including a camera, and output the generated XR/PCC image based on the acquired sensor information. For example, the self-driving vehicle 17200 may have an HUD and output an XR/PCC image thereto, thereby providing an occupant with an XR/PCC object corresponding to a real object or an object present on the screen.

When the XR/PCC object is output to the HUD, at least a part of the XR/PCC object may be output to overlap the real object to which the occupant's eyes are directed. On the other hand, when the XR/PCC object is output on a display provided inside the self-driving vehicle, at least a part of the XR/PCC object may be output to overlap an object on the screen. For example, the self-driving vehicle 17200 may output XR/PCC objects corresponding to objects such as a road, another vehicle, a traffic light, a traffic sign, a two-wheeled vehicle, a pedestrian, and a building.

The virtual reality (VR) technology, the augmented reality (AR) technology, the mixed reality (MR) technology and/or the point cloud compression (PCC) technology according to the embodiments are applicable to various devices.

In other words, the VR technology is a display technology that provides only CG images of real-world objects, backgrounds, and the like. On the other hand, the AR technology refers to a technology that shows a virtually created CG image on the image of a real object. The MR technology is similar to the AR technology described above in that virtual objects to be shown are mixed and combined with the real world. However, the MR technology differs from the AR technology in that the AR technology makes a clear distinction between a real object and a virtual object created as a CG image and uses virtual objects as complementary objects for real objects, whereas the MR technology treats virtual objects as objects having equivalent characteristics as real objects. More specifically, an example of MR technology applications is a hologram service.

Recently, the VR, AR, and MR technologies are sometimes referred to as extended reality (XR) technology rather than being clearly distinguished from each other. Accordingly, embodiments of the present disclosure are applicable to any of the VR, AR, MR, and XR technologies. The encoding/decoding based on PCC, V-PCC, and G-PCC techniques is applicable to such technologies.

The PCC method/device according to the embodiments may be applied to a vehicle that provides a self-driving service.

A vehicle that provides the self-driving service is connected to a PCC device for wired/wireless communication.

When the point cloud compression data (PCC) transmission/reception device according to the embodiments is connected to a vehicle for wired/wireless communication, the device may receive/process content data related to an AR/VR/PCC service, which may be provided together with the self-driving service, and transmit the same to the vehicle. In the case where the PCC transmission/reception device is mounted on a vehicle, the PCC transmission/reception device may receive/process content data related to the AR/VR/PCC service according to a user input signal input through a user interface device and provide the same to the user. The vehicle or the user interface device according to the embodiments may receive a user input signal. The user input signal according to the embodiments may include a signal indicating the self-driving service.

As mentioned above, a point cloud (or point cloud data) is composed of a set of points, each of which may have geometry information and attribute information. The geometry information is 3D position (XYZ) information, and the attribute information includes a color (RGB, YUV, etc.) and a reflectance. In other words, the attribute information about each point may include at least one of a color, a reflectance, an opacity, a frame index, a frame number, a material identifier, or a normal vector, and the type of the attribute information is signaled using an attr_label_known field in signaling information (e.g., an attribute parameter set).

In the present disclosure, geometry information is used interchangeably with geometry data and geometry. Also, attribute information is used interchangeably with attribute data and attributes.

The G-PCC encoding performed in a transmission device and method according to embodiments may include partitioning point clouds into tiles based on regions, and partitioning each of the tiles into slices for parallel processing. It may further include compressing geometry on a per slice basis, and compressing attribute information based on reconstructed geometry (i.e., decoded geometry) obtained based on the geometry (i.e., position) information having positions changed by the compression.

The G-PCC decoding performed in a reception device and method according to embodiments may include receiving, from a transmitting side, an encoded slice-level geometry bitstream and attribute bitstream, decoding geometry, and decoding attribute information based on the geometry reconstructed through the decoding.

According to embodiments, an octree-based geometry compression method, a predictive tree-based geometry compression method, or a trisoup-based geometry compression method may be used to compress the geometry information.

According to embodiments, compression of point cloud data includes lossy compression and lossless compression. In lossy compression, geometry (i.e., position) information and attribute information may be compressed differently from the original or omitted. In contrast, in lossless compression, the precision of the original data is preserved as much as possible, and the number of points is kept the same as in the original. For input floating-point values, near-lossless compression, which sets a threshold value in a specific range and allows only errors within the threshold value, is also considered to be in the lossless range.

Also, the point cloud content providing system may use one or more cameras (e.g., an infrared camera capable of securing depth information, an RGB camera capable of extracting color information corresponding to the depth information, etc.), a projector (e.g., an infrared pattern projector configured to secure depth information, etc.), LiDAR, and the like to generate (acquire) point cloud content (or point cloud data). LiDAR (Light Detection And Ranging) is also called Laser Detection And Ranging (LADAR), Time of Flight (ToF), laser scanner, laser radar, etc.

LiDAR refers to equipment configured to measure the distance by measuring the time it takes for emitted light to reflect on a subject and return. It provides precise 3D information about the real world as point cloud data over a wide area and long distance. Such large-volume point cloud data may be widely used in various fields where computer vision technology is employed, such as autonomous vehicles, robots, and 3D map production. That is, the LiDAR equipment uses a LiDAR system configured to measure the coordinates of a location of a reflector by emitting a laser pulse and measuring the time it takes for the laser pulse to reflect on a subject (i.e., a reflector) in order to generate point cloud content. According to embodiments, the depth information may be extracted through the LiDAR equipment. The point cloud content generated through the LiDAR equipment may be composed of multiple frames, which may be integrated into one piece of content.

In this case, multiple frames may constitute a group of frames (GoF). In other words, a GoF is a set of frames that are the unit of inter-based (also called inter-frame or inter-screen) encoding/decoding.

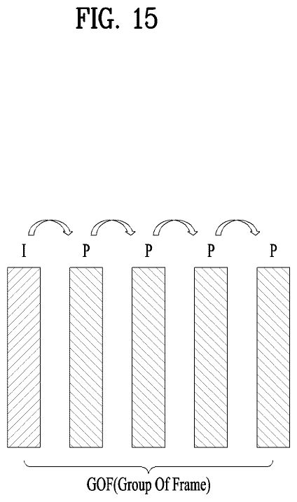

FIG. 15 illustrates an example in which a GOF is composed of a plurality of frames according to embodiments. In FIG. 15, the GoF is configured in an IPPP structure. This is merely an example, and the GoF may have another structure such as IPPBPP, IBBPBB, or the like.

Here, an I frame is an intra-prediction frame for predicting similarities within a single frame, and is also referred to as a key frame. Among multiple frames, every k-th frame may be designated as an I frame. Alternatively, scores related to a correlation between frames may be set and a frame having a high score may be designated as an I frame. The P frame is a frame for inter-prediction, which is prediction based on the relationship between previous frames (i.e., unidirectional). The B frame is a frame for inter-prediction, which is prediction based on the relationship between a previous frame and a subsequent frame (i.e., bidirectional). According to embodiments, when inter-prediction is performed with P frames among the frames in a GoF, the prediction may be performed with reference to previous frames or the B frames. In other words, for the P frame, one or more previous frames may be configured as reference frames. For a B frame, one or more previous frames and one or more subsequent frames may be configured as reference frames. Here, a reference frame may be frames that are involved in encoding/decoding the current frame. That is, the immediately preceding I frame or P frame referenced in encoding/decoding the current P frame may be referred to as a reference frame. Also, the immediately preceding I frame or P frame and the immediately following I frame or P frame referenced in both directions to encode/decode the current B frame may be referred to as reference frames.

According to embodiments, LiDAR intensity is measured as the degree of reflection of a laser (i.e., laser pulse). For example, laser reflectance measured BY a geometry-based LiDAR (MMS LiDAR) system is expressed as an integer from 0 to 255, which is a bi-product constant. The reflectance is measured differently depending on the surface object, with lower numbers indicating lower reflectance and higher numbers indicating higher reflectance.

In addition, the intensity returned from the laser may be affected by the angle at which the laser reaches (scan angle), range, surface composition, roughness, and moisture content. In addition, a laser at the bottom of a LiDAR sensor may generally have a higher intensity than the same slope along the edge as the returned energy decreases. In addition, the intensity may be acquired under a variety of conditions including highly reflective objects, nearby obstacles, strong ambient light (direct sunlight), and interference from other LiDAR sensors. Therefore, even points on the same object do not always have the same reflectance, and the reflectance may change depending on the environment at the time of acquisition. In other words, when compressing geometry information, the reflectance may be affected or changed depending on the environment where the point cloud data is acquired.

The present disclosure proposes a structure for compressing attribute information based on geometry information between frames when point cloud data is composed of multiple frames. For example, a dynamic point cloud classified into category 3 is composed of multiple point cloud frames, which may be applied to autonomous driving, etc. The set of frames is called a sequence. A sequence includes frames with the same attribute values. Therefore, the attribute values between frames have data features such as motion or attribute value changes between previous or subsequent frames.

The present disclosure proposes a method of compressing attributes between frames, and a method and device for searching and applying a global/local scaling factor (also referred to as a scale factor) based on frame characteristics. As used herein, a global scaling factor refers to a global attribute scaling factor, and a local scaling factor refers to a local attribute scaling factor. In the present disclosure, the scaling factors may be applied on a frame-by-frame basis.

In the present disclosure, the scaling factors may be applied on a tile-by-tile or slice-by-slice basis.

In the present disclosure, when the point cloud data is partitioned into large prediction units (LPUs) and/or prediction units (PUs), the scaling factors may be applied on a per LPU and/or per PU basis.

In the present disclosure, when the points in the point cloud data are separated into roads and objects, the scaling factors may be applied differently for roads and objects.

In the present disclosure, the scaling factors may be applied to objects.

In the present disclosure, the scaling factors may be applied on a point-by-point basis.

In the present disclosure, the scaling factor applied on a frame-by-frame basis is referred to as a global scaling factor, and the scaling factor applied on the basis of at least one of tiles/slices/LPUs/PUs/roads/objects/points is referred to as a local scaling factor.

In the present disclosure, the scaling factors may be acquired based on the reflectance in the attribute information. In particular, in the present disclosure, the scaling factors may be acquired based on an intensity calculated based on the reflectance.

In the present disclosure, the scaling factors may or may not be applied based on a threshold.

In the disclosure, the scaling factors may be applied before geometry compression or after geometry compression but before attribute compression.

In the present disclosure, the scaling factors may be applied when performing a neighbor search for compression of attribute information.

In other words, the present disclosure provides a method for performing inter-frame attribute compression in point cloud data. The characteristic (e.g., reflectance) of the data used for inter-frame attribute compression is affected by the acquisition environment, but there has been no method for compressing the changed characteristic. The present disclosure is not limited to the reflectance, and may be applied to any attribute value labeled by the attr_label_known field signaled in the signaling information (e.g., APS). According to embodiments, the transmission device may apply a scaling factor before geometry compression, or after geometry compression but before attribute compression, or after searching the nearest neighbor (NN) for attribute compression, and the unit forming the basis of application of the scaling factor and the applied scaling factor value are transmitted to the reception device. In this case, the scaling factor may be a global attribute scaling factor and/or a local attribute scaling factor. The scaling factor may be applied on a per frame, per tile, per slice, per LPU/PU, or per attribute NN basis. Further, the scaling factor application condition may be determined by searching for the amount of difference in attributes between frames, or by using a histogram/min max/RDO (Rate-Distortion Optimization), and may be applied differently to road/object data or differently for each octree/predictive geometry tree (predgeom) unit.

In the present disclosure, when a rotation value used to estimate global motion for compression of geometry information is greater than a rotation threshold (th_rotation), and/or a translation value used to estimate the global motion is greater than a translation threshold (th_translation), the inter-frame attribute compression is skipped. Here, the translation refers to a spatial position relative to the origin, and the rotation refers to a rotation with respect to the XYZ direction. That is, the translation means movement or substitution by a certain position in space.

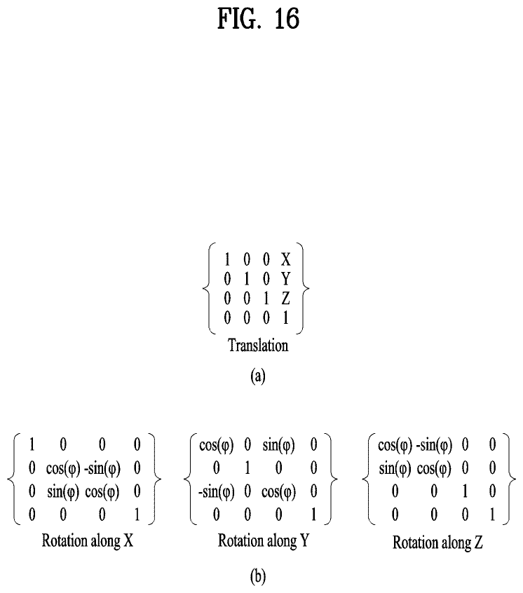

FIGS. 16-(a) and 16-(b) illustrate example global motion matrices according to embodiments. In particular, FIG. 16-(a) shows an example of a 4D matrix for acquiring translations among global motion matrices according to embodiments, and FIG. 16-(b) shows an example of 4D matrices for acquiring rotations among the global motion matrices according to embodiments. That is, FIG. 16-(b) shows an example of a matrix for rotation by an angle of θ about the X-axis, a matrix for rotation by an angle of θ about the Y-axis, and a matrix for rotation by an angle of θ about the Z-axis.

As described above, in the present disclosure, an intensity may be obtained based on the reflectance in the attribute information, and a scaling factor may be determined based on the intensity.

In other words, in the present disclosure, in order to improve the inter-frame attribute compression rate, a common feature of the frames acquired by a characteristic of a moving laser may be found. For example, a sequence of frames of category 3 (i.e., Cat3-frames) has only reflection information as an attribute value. Reflection is a distance between a sensor (e.g., a laser sensor) and a target (e.g., an object) calculated based on the difference between the transmit time and receive time and the speed of light. According to embodiments, reflection R may be calculated as shown in Equation 5.

$$R = 1 / 2 \times c \times {t}_{L} \qquad [ Equation 5 ]$$

In Equation 5, R denotes the reflection, which is the range between the sensor and the target surface, t_{L} denotes the round-trip time of the laser pulse, and c denotes the speed of light. Since t_{L} is affected by environmental factors such as sunlight and background light, the intensity I_{R} of the laser pulse ultimately received by the laser receiver in the LiDAR equipment is calculated as shown in Equation 6.

$${I}_{R} = {I}_{r} \times ( cos θ / {R}^{2} ) \times ρ \times {μ}_{atm} \times C \qquad [ Equation 6 ]$$

In Equation 6, I_{R} denotes the received intensity, Iᵣ denotes the transmitted intensity, R denotes the reflection, which is the range from the scanner to the target, θ is the effective incident angle (i.e., the angle between the direction of the laser pulse and the normal to the surface of the target), ρ denotes the reflectance of the target, μₐₜₘ denotes the atmospheric attenuation constant, and C denotes the sensor system constant factor. According to embodiments, when the conditions of the measurement environment (e.g., geometric conditions, weather, instrumentation, etc.) are assumed to be the same, the reflection has the same value.

In one embodiment of the present disclosure, a scaling factor is obtained based on the intensity of a reference frame and the intensity of the current frame. In particular, in one embodiment of the present disclosure describes, the scaling factor may be obtained based on an average distribution of the intensity of the reference frame and an average distribution of the intensity of the current frame.

According to embodiments, the inter-frame attribute compression is performed after the geometry compression of the current frame. At this time, the generation of a Morton code is performed for the reference frame and the current frame based on the geometry (e.g., reconstructed geometry) values. In the present disclosure, the reference frame may be a frame in the previously compressed GoF. The same frame in which the geometry compression has been performed may be used as a reference frame for the attribute compression, or a different frame based on a frame index may be used as a reference frame for the attribute compression. When the attribute information is compressed using the same reference frame as for the geometry, the overall distribution of the attribute values in the reference frame and the attribute values in the current frame may be obtained. In this case, there may be a difference in intensity between the frames due to the equation by which I_{R} (i.e., received intensity) is calculated.

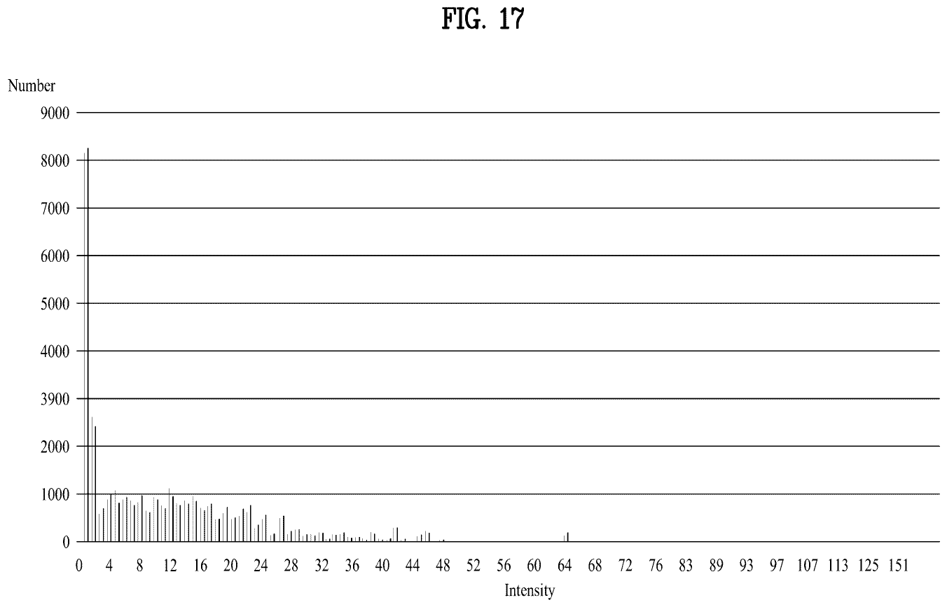

According to embodiments, the number according to the intensity of the entire frame is shown in the graph of FIG. 17.

FIG. 17 is a graph depicting an example of the number according to the intensity of an entire frame. In FIG. 17, the horizontal axis represents the intensity and the vertical axis represents the number of points. FIG. 17 shows the distribution of points by intensity.

Based on the graph shown in FIG. 17, the average distribution of the reference frame (ref_frame=ΣIR) and the average distribution of the current frame (cur_frame=ΣIR) may be obtained. Here, IR denotes the received intensity.

A global scaling value (i.e., scaling factor) (global_scale) to be applied to the current frame may be calculated as shown in Equation 7 below.

$$global\_scale = Cur\_frame / Ref\_frame \qquad [ Equation 7 ]$$

By applying (e.g., multiplying by) the obtained global scaling factor to the current frame, the reflectance (e.g., reflectance ratio) of the current frame may be adjusted.

In other words, the global scaling factor (i.e., global scale) that is applied to the entire frame is used as a whole-frame factor that reflects the characteristic by which the frame is acquired.

For example, when the reference frame has a reflectance from 0 to 10 and the current frame has a reflectance from 10 to 20, the scaling factor may be determined to be 10, and the reflectance of the current frame may be adjusted to be similar to the reference frame by subtracting 10 (i.e., the scaling factor) from each reflectance of the current frame. In this case, the residual of the transmitted reflectance becomes smaller, which improves the compression performance of the reflectance.

In addition to global scaling, the present disclosure may use a method of applying an equation such as the average sum of the target scaling and the average sum of the current range, or any other equation, to a range defined in the scale range of the inter-frame attribute compression.

According to embodiments, the same global scaling may be defined for colors defined in the attr_label_known field signaled in the signaling information. In other words, in point cloud data, color information is likely to have similar colors in the same space. In addition, when a matching geometry point is pinpointed in a previous frame, it is likely to have a similar RGB value to the color value of that point. However, depending on the location of the light source and the location of the object at the time of the acquisition by the laser equipment, there may be a difference in color from the previous frame. In this case, the color may be corrected using the global/local scaling factor of the attribute, and then neighbor node search and predictor selection may be performed.

According to embodiments, the local scaling factor applied to the LPU in the present disclosure may be acquired based on an average distribution of an LPU in the current frame and an average distribution of a corresponding LPU in a reference frame. Here, for the average distribution, refer to the description above. In this case, the corresponding LPU in the reference frame may be the LPU at the closest position based on the Euclidean distance. In the present disclosure, a local scaling factor applied to units such as PUs/roads/objects, etc. may be acquired similarly to the case of the LPU.

According to embodiments, applying a scaling factor means multiplying, subtracting, or adding the scaling factor from the corresponding attribute value in the unit of a current frame/LPU/PU/road/object/point, depending on the attribute (e.g., reflectance, color, etc.). For example, for reflectance, the scaling factor may be multiplied. For color, the scaling factor may be subtracted.

According to embodiments, the scaling factor may or may not be applied when compressing the attribute. For example, if the difference in attribute (e.g., reflectance, color, etc.) between the reference frame and the current frame is large, the scaling factor may be applied. Otherwise, the scaling factor may not be applied. In other words, the scaling factor may be applied to attribute compression when there is a large difference in attribute (e.g., reflectance, color, etc.) between frames or when there is a sudden increase in motion. The scaling factor may not be applied to attribute compression when there is little motion, the frames are a still image, or there are no environmental changes.

In other words, in the present disclosure, a condition for applying scaling may be determined when compressing attribute information between frames. Here, the application condition may be set as a scaling threshold (scaling_threshold). For example, if the difference in reflectance between the reference frame and the current frame is greater than the scaling threshold, the scaling factor may be applied. Otherwise, the scaling factor may not be applied. In the present disclosure, the attribute encoder may include a determination part configured to determine the condition for applying the scaling.

According to embodiments, the determination part may determine and set a scaling threshold per frame, or may receive a scaling threshold as input.

According to embodiments, the condition for applying the scaling may be determined by searching the amount of difference in attribute between frames or using a histogram/min max/RDO, and a scaling threshold may be set. Further, the scaling factor may be applied differently to data partitioned into a road and data partitioned into objects, or may be applied differently per prediction unit in an octree/geometry predictive tree (predgeom) structure. For example, the data partitioned into a road are nearly similar. Thus, the scaling factor may not be applied to the data partitioned into the road and applied only to the data partitioned into objects.

According to embodiments, the amount of difference between the attributes of color and intensity may be set as a condition for compression (i.e., a condition for applying scaling). For example, the difference in the amount of attribute change between the reference frame and the current frame may be used to determine whether to apply scaling. Here, the amount of change may be set by comparing the averages of the sum of the attribute values in the current frame and the reference frame, by comparing the averages of the point-to-point/point-to-plane differences in the reference frame, or by comparing the averages of the differences between the Morton indexes, or the like.

The disclosure also proposes an embodiment in which a reference frame is selected based on the amount of difference by number of attribute values, as shown in FIG. 17. In other words, by listing the number of attribute values in a histogram, the overall brightness of the attribute values may be searched for.

Next, the range of scaling applied to inter-frame attribute compression will be described.

According to embodiments, in inter-frame attribute compression, the scaling factor may be applied per specific unit in the current frame. For example, the specific unit in which the scaling factor is applied may be a frame, a tile, a slice, a road/object partition unit, an object, an LPU/PU, or an LPU/PU/object in a spherical coordinate system. In this case, the application range of the scaling factor and/or the whether to apply the scaling factor may be determined by the determination part. Other scaling ranges may be defined as a set of points clustered using an iterative closest point (ICP), simultaneous localization and mapping (SLAM) algorithm, or the like.

As described above, the present disclosure determines whether to apply a scaling factor by comparing the amount of change in an attribute value (e.g., color, reflectance, or intensity) between the reference frame and the current frame with a scaling threshold. When the amount of change is greater than the scaling threshold, the scaling factor is applied per specific unit.

Next, a method to apply scaling in neighbor node search for a reference frame will be described.

As described above, the scaling factor may be applied at a step prior to compression of the geometry information, and/or at a step after coding of the geometry information but before coding of the attribute information (i.e., after reconstruction of the geometry information), and/or at a step after searching the NN during the coding of the attribute information.

According to embodiments, the NN search is performed by the attribute encoder after the generation of the LOD.

The LOD is a level of detail in the point cloud content. Smaller LOD values indicate less detail in the point cloud content, while larger LOD values indicate more detail in the point cloud content. The points of the reconstructed geometry, namely, the reconstructed positions, may be categorized according to the LOD.

In one embodiment, the predictive transform coding technique and the lifting transform coding technique, among other methods for compressing attribute information, may divide and group points into LODs.

This operation is referred to as LOD generation, and a group having different LODs may be referred to as an LOD₁ set, where 1 denotes the LOD and is an integer starting from 0. LOD₀ is a set composed of points having the longest distances therebetween. As 1 increases, the distance between points in LOD₁ decreases.

Once the LOD₁ set is generated, the attribute encoder according to embodiments may search X (>0) nearest neighbor (NN) points in a group having the same or lower LOD (i.e., a group in which the distance between nodes is large) based on the LOD₁ set and register the same as a neighbor point set in the predictor of the point. X is the maximum number of points that may be configured as neighbors. It may be input as a user parameter or may be signaled in signaling information through the signaling processor 51005 (e.g., the lifting_num_pred_nearest_neighbours field signaled in the APS).

According to embodiments, the points in the LOD₁ set are sorted based on the Morton code order. The points in each of the LOD₀ to LOD₁₋₁ sets are also sorted based on the Morton code order. In other words, a Morton code for each point in the point cloud may be generated based on the x, y, and z position values of each point in the point cloud. Then, once the Morton codes of the points in the point cloud are generated in this way, the points may be sorted in the current frame and reference frame by the order of the Morton codes.

In the present disclosure, the operation of searching for the NN points as described above may be performed in each of the reference frame and the current frame. X (e.g., 3) NN points may be found in the reference frame and X (e.g., 3) NN points may be found in the current frame.

Next, an example of searching for NN points in the current frame will be described.

According to embodiments, to generate a neighbor point set for a point Px (i.e., the point to be encoded or the current point) belonging to the LOD₁ set, the attribute encoder may search for a point having a Morton code closest to the Morton code of the point Px among the points that are positioned before the point Px in Morton code order (i.e., the points having Morton codes that are less than or equal to the Morton code of Px) among the points belonging to the LOD₀ to LOD₁₋₁ sets and/or points belonging to the LOD₁ set. The point found through the search will be referred to herein as Pi or a center point.

According to embodiments, in searching for the center point Pi, the search may include searching for a point Pi that has the closest Morton code to the Morton code of point Px among all points positioned before point Px, or may include searching for a point Pi that has the closest Morton code to the Morton code of point Px among the points within a search range.

According to embodiments, the attribute encoder compares the distances between the point Px and the points in the neighbor point search range centered at the searched (or selected) center point Pi and spanning to the front (i.e., to the left of the center point) and to the rear (i.e., to the right of the center point). Then, the X (e.g., 3) points at the closest distance may be selected as the NN points and registered as a neighbor point set. In one embodiment, the neighbor point search range may be the number of points.

As described above, for attribute compression, the attribute encoder generates LODs based on the points of the reconstructed geometry and searches for the nearest neighbor points for a point to be encoded based on the generated LODs. According to embodiments, the attribute decoder of the reception device also generates LODs and searches for the nearest neighbor points for a point to be decoded based on the generated LODs.

In another embodiment, X (e.g., 3) NN points may be searched for based on the current frame and a reference frame.

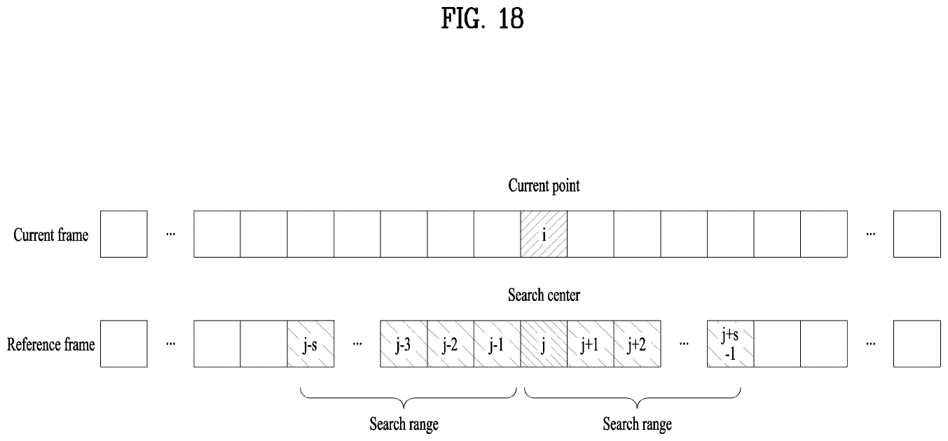

FIG. 18 illustrates an example of searching for nearest neighbor points according to embodiments.

That is, the figure illustrates an example of searching for neighbor nodes in a structure of two codes: a Morton code generated in the current frame and a Morton code generated in a reference frame (e.g., a previous frame). In other words, FIG. 18 illustrates a method of searching for neighbor nodes based on Morton codes for inter-frame attribute compression.

In FIG. 18, it is assumed that the points in the current frame and the points in the reference frame are sorted in ascending order based on the size of the Morton codes. In this case, the point at the foremost position among the points sorted in Morton order has the smallest Morton code.

According to embodiments, to search for a neighbor node corresponding to the i-th Morton code of the current frame, the index j of the Morton code closest to the i-th Morton code of the current frame is selected from the Morton code of the reference frame. For example, the point (i.e., the point with index j) that has the greatest value among the Morton codes that are smaller than the Morton code of the current point (i.e., i) in the current frame is selected as the center point (upper bound). Then, based on the selected index j, a search range is configured in the forward and backward directions. In the search range, the attribute encoder according to embodiments performs attribute compression based on the three neighbor nodes (i.e., NN points) selected as prediction nodes in the reference frame and the three neighbor nodes (i.e., NN points) selected in the current frame. That is, lifting/predicting transform is performed based on a total of six points, which are the NN points of the current point i to be encoded in the current frame, to compress the attribute information. In this regard, according to the present disclosure, the attribute compression of a previous frame may be limited when it is determined that the reference frame is unpredictable in the current frame in attribute information prediction.

According to embodiments, the attribute encoder may apply a scaling application method that is applied to neighbor node search in the reference frame after the neighbor node search. In FIG. 18, the indexes within the search range of point j in the reference frame closest to the geometry of point i in the current frame are designated as a neighbor node search range. The NN points are then re-searched for with the closest Morton distance or Euclidian distance, which may be used as predictors, in the designated range. According to embodiments, the attribute encoder may apply attribute scaling in the neighbor node search range and apply attribute scaling in the predictor list. According to embodiments, a scaling factor may be applied to neighbor nodes in the current frame in common. For example, when there are three NN points found for the current point in the current frame, the same scaling factor may be applied to the three NN points. For example, when the attribute values of the three NN points found in the reference frame are 2, 4, and 6 and the attribute values of the three NN points found in the current frame are 1, 2, and 3, the scaling factor may be 2. When this scaling factor is applied to the three NN points found in the current frame, the attribute values of the three NN points found in the current frame become 2, 4, and 6.

According to embodiments, in lossy attribute coding, the LoD is used to select a representative value in the current frame to move to a higher layer. If the representative value fails to accurately reflect the representative values of the colors in the region, the compression efficiency is reduced. In addition, since the value of reflectance representing the region depends on the material or is affected by the light source, a scaling factor may be applied to points that are close in distance, and then a prediction mode and a residual value may be transmitted. Here, the prediction mode may be set in different ways. For example, prediction mode 0 may be a mode in which the average attribute value of the NN points is set as a predicted value. In the present disclosure, the scaling factor may be applied to the NN points in prediction mode 0. Also, the residual value, i.e., the residual attribute information, may be the difference in attribute value of the predicted point predicted in prediction mode 0 at the current point.

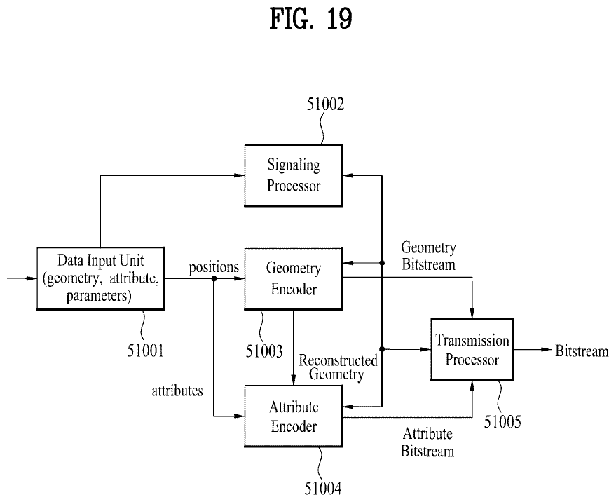

FIG. 19 illustrates another example of a point cloud transmission device according to embodiments. The elements of the point cloud transmission device illustrated in FIG. 19 may be implemented by hardware, software, a processor, and/or a combination thereof.

According to embodiments, the point cloud transmission device may include a data input unit 51001, a signaling processor 51002, a geometry encoder 51003, an attribute encoder 51004, and a transmission processor 51005.

The geometry encoder 51003 and the attribute encoder 51004 may perform some or all of the operations described in the point cloud video encoder 10002 of FIG. 1, the encoding 20001 of FIG. 2, the point cloud video encoder of FIG. 4, and the point cloud video encoder of FIG. 12.

The data input unit 51001 according to embodiments receives or acquires point cloud data. The data input unit 51001 may perform some or all of operations of the point cloud video acquisition unit 10001 in FIG. 1 or some or all of the operations of the data input unit 12000 in FIG. 12.

The data input section 51001 outputs the positions of the points in the point cloud data to the geometry encoder 51003 and outputs the attributes of the points in the point cloud data to the attribute encoder 51004. Here, the input point cloud data may be on a frame-by-frame, tile-by-tile, or slice-by-slice basis. In one embodiment, the point cloud data may be separated into a road and objects and input into the data input unit 51001. In another embodiment, the point cloud data may be partitioned into LPUs/PUs and input into the data input unit 51001. In addition, the parameters are output to the signaling processor 51002. According to embodiments, the parameters may be provided to the geometry encoder 51003 and the attribute encoder 51004.

The geometry encoder 51003 performs entropy encoding on the compressed geometry information and outputs the encoded information to the transmission processor 51005 in the form of a geometry bitstream.

The geometry encoder 51003 reconfigures the geometry information based on positions changed through compression, and outputs the reconfigured (or decoded) geometry information to the attribute encoder 51004.

The attribute encoder 51004 compresses attribute information input based on positions at which geometry encoding is not performed and/or reconfigured geometry information. According to an embodiment, the attribute information may be coded using any one or a combination of one or more of RAHT coding, LOD-based predictive transform coding, and lifting transform coding. The attribute encoder 51004 performs entropy encoding on the compressed attribute information and outputs the information to the transmission processor 51005 in the form of an attribute bitstream.

According to embodiments, the attribute encoder 51004 compresses the attribute information by performing inter-prediction or intra-prediction-based encoding on the reconstructed geometry information and the attribute information (e.g., reflectance, color, etc.) about the points input per at least one of frame/tile/slice/LPU/PU/road/object/objects.

In this regard, the characteristic (e.g., reflectance) of the data used for inter-frame attribute compression frames are affected by the acquisition environment, and thus the attribute encoder 51004 may apply a scaling factor to the attribute information to compress the changed characteristic. Here, the scaling factor may be applied before geometry compression, before attribute compression after geometry compression, or after searching nearest neighbors (NNs) for attribute compression, and information related to attribute scaling is transmitted to the reception device. In this case, the scaling factor may be a global attribute scaling factor and/or a local attribute scaling factor. For example, the scaling factor may be calculated based on an average distribution obtained based on the intensity of the reference frame and an average distribution obtained based on the intensity of the current frame. The scaling factor may then be applied on a per frame, per tile, per slice, per LPU/PU, or per attribute NN basis. Further, the scaling factor application condition may be determined by searching for the amount of difference in attributes between frames, or by using a histogram/min max/RDO, and may be applied differently to road/object data or differently for each octree/predictive geometry tree (predgeom) unit.

The signaling processor 51002 may generate and/or process signaling information (e.g., parameters) required for encoding/decoding/rendering of the geometry information and attribute information, and provide the same to the geometry encoder 51003, the attribute encoder 51004, and/or the transmission processor 51005. Alternatively, the signaling processor 51002 may be provided with the signaling information generated by the geometry encoder 51003, the attribute encoder 51004, and/or the transmission processor 51005. The signaling processor 51002 may provide information (e.g., head orientation information and/or viewport information) fed back from the reception device to the geometry encoder 51003, the attribute encoder 51004, and/or the transmission processor 51005.

As used herein, the signaling information may be signaled and transmitted at the level of a parameter set (sequence parameter set (SPS), geometry parameter set (GPS), attribute parameter set (APS), tile parameter set (TPS) (or tile inventory), etc). It may also be signaled and transmitted per coding unit (or compression unit or prediction unit) of each image, such as slice or tile. Here, the SPS includes sequence-level signaling information, the GPS includes information for encoding/decoding of geometry information, the APS includes information for encoding/decoding of attribute information, and the TPS includes information related to tiles.

The method/device according to embodiments may signal relevant information to add/perform operations according to embodiments. The signaling information according to embodiments may be used by a transmission device and/or a reception device.

The transmission processor 51005 may perform the same or similar operation and/or transmission method as or to the operation and/or transmission method of the transmission processor 12012 of FIG. 12 and perform the same or similar operation and/or transmission method as or to the transmitter 10003 of FIG. 1. For a detailed description, refer to the description of FIG. 1 or FIG. 12 and the detailed description will be omitted herein.

The transmission processor 51005 may multiplex the geometry bitstream output from the geometry encoder 51003, the attribute bitstream output from the attribute encoder 51004, and the signaling bitstream output from the signaling processor 51002 into one bitstream. The multiplexed bitstream may be transmitted without change or may be encapsulated in a file or a segment to be transmitted. In an embodiment of the present disclosure, the file is in an ISOBMFF file format.

According to embodiments, the file or the segment may be transmitted to the reception device or stored in a digital storage medium (e.g., a USB drive, SD, CD, DVD, Blu-ray disc, HDD, SSD, etc.). The transmission processor 51005 according to the embodiments may communicate with the reception device through wired/wireless communication through a network such as 4G, 5G, or 6G. In addition, the transmission processor 51005 may perform a necessary data processing operation depending on a network system (e.g., a 4G, 5G, or 6G communication network system). The transmission processor 51005 may transmit encapsulated data according to an on-demand scheme.

According to embodiments, the attribute scaling related information for scaling of the attribute information described above may be transmitted in at least one of the SPS, GPS, APS, and/or TPS, and/or geometry data unit (also referred to as a geometry slice bitstream), and/or attribute data unit (also referred to as an attribute slice bitstream) by at least one of the signaling processor 51002, the geometry encoder 51003, the attribute encoder 51004, or the transmission processor 51005.

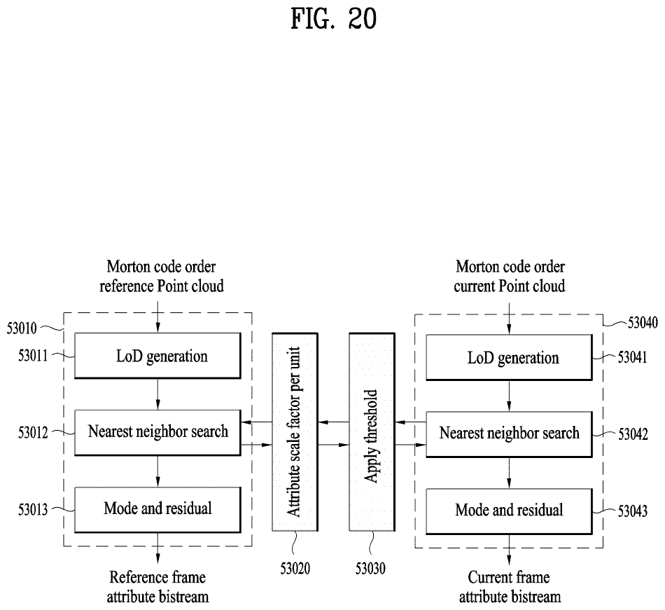

FIG. 20 illustrates an example of applying scaling in neighbor node search of an attribute encoder according to embodiments. The elements of the attribute encoder illustrated in FIG. 20 may be implemented in hardware, software, processors, and/or combinations thereof.

For ease of description, only parts of the attribute encoder related to neighbor node search are illustrated in FIG. 20, and may include a first node searcher 53010, a scaling factor application part 53020, a determination part 53030, and a second node searcher 53040.

The LoD generation part 53011 of the first node searcher 53010 generates LODs based on points of the geometry in the reference frame, and the NN search part 53012 searches for neighbor nodes (i.e., NN points) based on the generated LODs. In one example, the NN search part 53012 may select up to three neighbor nodes from points in the reference frame that are sorted based on the Morton code as described above.

The LoD generation part 53041 of the second node searcher 53040 may generate LODs based on points of the geometry in the current frame, and the NN search part 53042 may search for neighbor nodes (i.e., NN points) based on the generated LODs. In one example, the NN search part 53042 may select up to three neighbor nodes from points in the current frame that are sorted based on the Morton code as described above.

The determination part 53030 determines whether to apply a scaling factor to the neighbor nodes (i.e., NN points) found by the first node searcher 53010 and the second node searcher 53040 by applying a scaling threshold. The condition for applying the scaling factor (e.g., the scaling threshold) may be determined by searching for the amount of difference in attributes between frames, or by using a histogram/min max/RDO (Rate-Distortion Optimization).

Once the determination part 53030 determines that scaling is applied, the scaling factor application part 53020 applies the scaling factor to the NN points found by the first node searcher 53010 and the second node searcher 53040. The scaling factor may be applied differently to the road/object data or differently per octree/predgeom unit.

In other words, the attribute encoder 51004 of FIG. 20 may calculate an attribute scaling value (i.e., a scaling factor) based on the three neighbor nodes found in the LoD of the current frame and the three neighbor nodes with the closest geometry values found in the LoD of the reference frame. At this time, when the amount of change of the two attribute values per unit to which scaling is to be applied is greater than or equal to the scaling threshold, scaling may not be applied. When the amount of change is less the scaling threshold, scaling may be applied.

The compressor 53013 of the first node searcher 53010 and the compressor 53043 of the second node searcher 53040 perform inter-prediction based on the neighbor nodes with or without the scaling factor applied, and output a reference frame attribute bitstream and/or a current frame attribute bitstream including prediction mode information and residual attribute information.

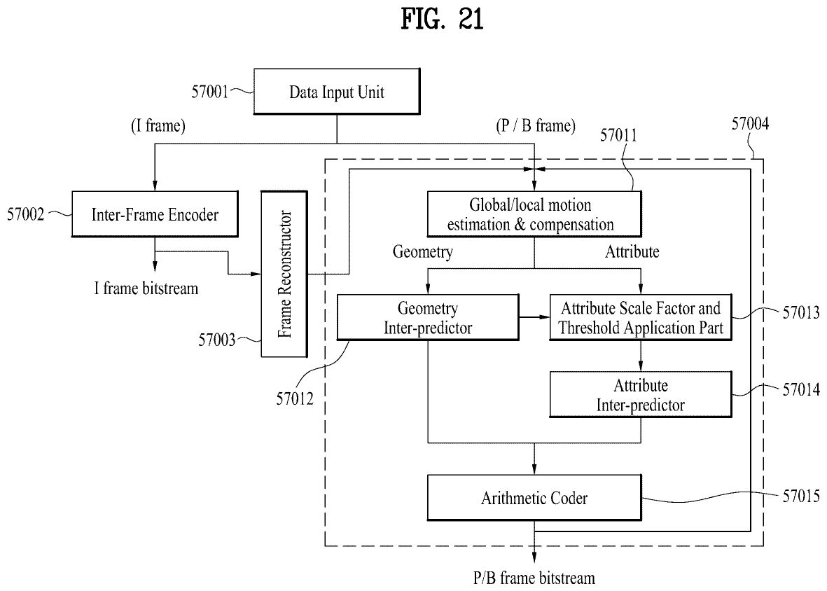

FIG. 21 is an example detailed block diagram illustrating a point cloud video encoder including a geometry encoder and an attribute encoder according to embodiments. The elements of the point cloud video encoder illustrated in FIG. 21 may be implemented in hardware, software, processors, and/or combinations thereof.

In FIG. 21, the point cloud video encoder may include a data input unit 57001, a first compressor 57002 configured to compress an I frame based on intra-prediction, a frame reconstructor 57003, and a second compressor 57004 configured to compress P/B frames based on inter-prediction.

FIG. 21 illustrates only parts of the point cloud video encoder related to scaling. For parts not described or illustrated in FIG. 21, refer to the descriptions of FIGS. 1 to 20.

The data input unit 57001 according to embodiments receives or acquires point cloud data. The data input unit 57001 may perform the same or similar operations and/or acquisition method as the operations and/or acquisition method of the point cloud video acquisition unit 10001 (or the acquisition process 20000 described in FIG. 2, or the data input unit 51001 described in FIG. 20).

According to embodiments, when the frame output from the data input unit 57001 is an I frame, the first compressor 57002 performs intra-prediction on the geometry information and attribute information contained in the input I frame, respectively, performs compression and entropy coding thereon, and then outputs an I frame bitstream.

According to embodiments, the frame reconstructor 57003 reconstructs the geometry information based on geometry information (in particular, occupancy code) encoded based on intra-prediction. The reconstructed geometry information is output to the second compressor 57004.

According to embodiments, when the frame output from the data input unit 57001 is a P frame or a B frame, the second compressor 57004 performs inter-prediction on the geometry information and attribute information contained in the input P frame or B frame based on one or more reference frames, respectively, performs compression and entropy coding thereon, and then outputs a P/B frame bitstream.

According to embodiments, the motion compensation part 57011 of the second compressor 57004 may perform global/local motion estimation for inter-prediction to obtain a global/local motion vector and apply the same to one or more reference frames to perform motion compensation.

According to embodiments, the geometry inter-predictor 57012 of the second compressor 57004 performs inter-prediction on the global/local motion compensated one or more reference frames and the geometry information about the input P frame or B frame per at least one of frame/tile/slice/LPU/PU/road/object, and outputs geometry prediction mode information and residual geometry information. In one embodiment, the geometry inter-predictor 57012 of the second compressor 57004 may generate an octree code based on the octree structure configured from the input geometry information, and perform inter-prediction on the occupancy code.

According to embodiments, the arithmetic coder 57015 of the second compressor 57004 entropy codes the compressed geometry information including the prediction mode information and the residual geometry information.

According to embodiments, the scaling application part 57013 of the second compressor 57004 may apply a scaling factor to the attribute information in the input P-frame or B-frame per at least one of frame/tile/slice/LPU/PU/road/object. According to embodiments, the scaling application part 57013 may determine whether to apply scaling based on a scaling threshold, and may apply scaling only when the amount of change of the attribute between the reference frame and the current frame is greater than the scaling threshold. Here, the condition for applying scaling, the application range, and the like have been described in detail with the reference to FIGS. 15 to 20, and thus will not be described below. In other embodiments, the application of attribute scaling may be performed prior to compression of the geometry information, or may be performed when the attribute inter-predictor 57014 searches for neighbor nodes after LoD generation for compression of the attribute information.

According to embodiments, the scaling application part 57013 may receive scaling-related information as input to apply scaling to the attribute information, and/or may signal scaling-related information after applying scaling to the attribute information and transmit the scaling-related information to the reception device.

For example, the scaling application part 57013 may signal information (e.g., attr_global_scaling_flag) indicating whether to use attribute scaling using a reference frame. Further, it may signal a scaling factor (e.g., scaling_factor) per unit of application using the attribute scaling method. It may also signal attribute scaling application unit information (e.g., attr_scaling_unit). According to embodiments, the attribute scaling application unit information (e.g., attr_scaling_unit) is defined in the transmission device and depends on the amount of change described above. Further, attr_global_scaling_flag (i.e., information indicating whether scaling is enabled) and scaling_factor (i.e., a scaling factor value) may be signaled per unit indicated by the attribute scaling application unit information (e.g., attr_scaling_unit). In the case where attribute scaling is applied to neighbor node search, the scaling factor (attr_nearest_neighbour_scaling_factor) is signaled per prediction unit. Additionally, a scaling threshold (e.g., scaling_threshold) may be signaled to determine whether to apply scaling.

According to embodiments, the scaling-related information may include information indicating whether attribute scaling is enabled (e.g., attr_global_scaling_flag), a scaling factor (e.g., scaling_factor), unit information for application of attribute scaling (e.g., attr_scaling_unit), a scaling factor used when attribute scaling is applied to neighbor node search (attr_nearest_neighbour_scaling_factor), or a scaling threshold (e.g., scaling_threshold). The scaling-related information may be included in the signaling information and transmitted to the reception device. The signaling information may be at least one of the SPS, GPS, TPS, APS, geometry slice header, or attribute slice header.

According to embodiments, the attribute inter-predictor 57014 of the second compressor 57004 performs inter-prediction on the attribute information in the one or more global/local motion-compensated reference frames and the P-frames or B-frames to which scaling is or is not applied, per at least one of frame/tile/slice/LPU/PU/road/object, and outputs corresponding attribute prediction mode information and residual attribute information. In one embodiment, the attribute inter-predictor 57014 may generate a LoD based on the reconstructed geometry information, search neighbor nodes based on the generated LoD, and compress the attribute information using any one or a combination of two or more of RAHT coding, prediction transform coding, and lifting transform coding.

According to embodiments, the arithmetic coder 57015 of the second compressor 57004 entropy-codes the compressed attribute information including the attribute prediction mode information and the residual attribute information.

The P/B bitstream output from the second compressor 57004 may contain the entropy-coded residual geometry information, geometry prediction mode information, residual attribute information, and attribute prediction mode information.

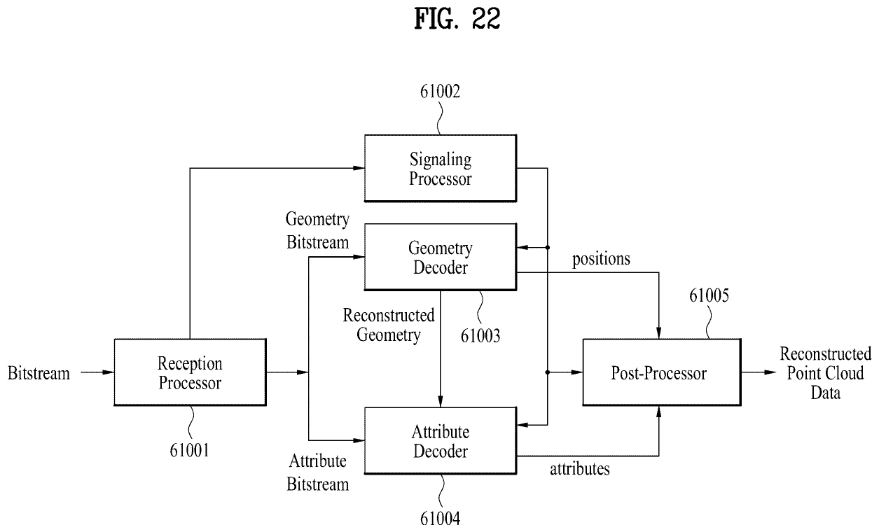

FIG. 22 illustrates another example of a point cloud reception device according to embodiments.

The point cloud reception device according to the embodiments may include a reception processor 61001, a signaling processor 61002, a geometry decoder 61003, an attribute decoder 61004, and a post-processor 61005. According to embodiments, the geometry decoder 61003 and the attribute decoder 61004 may be referred to as a point cloud video decoder. According to embodiments, the point cloud video decoder may be referred to as a PCC decoder, a PCC decoding unit, a point cloud decoder, a point cloud decoding unit, or the like.

The reception processor 61001 may receive one bitstream or may receive each of a geometry bitstream, an attribute bitstream, and a signaling bitstream. Upon receiving a file and/or a segment, the reception processor 61001 may decapsulate the received file and/or segment and output a bitstream therefor.

When receiving (or decapsulating) one bitstream, the reception processor 61001 may demultiplex a geometry bitstream, an attribute bitstream, and/or a signaling bitstream from one bitstream, output the demultiplexed signaling bitstream to the signaling processor 61002, output the geometry bitstream to the geometry decoder 61003, and output the attribute bitstream to the attribute decoder 61004.

When receiving (or decapsulating) a geometry bitstream, an attribute bitstream, and/or a signaling bitstream, the reception processor 61001 may deliver the signaling bitstream to the signaling processor 61002, deliver the geometry bitstream to the geometry decoder 61003, and deliver the attribute bitstream to the attribute decoder 61004.

The signaling processor 61002 may parse and process information included in signaling information, e.g., SPS, GPS, APS, TPS, and metadata in the input signaling bitstream and provide the parsed and processed information to the geometry decoder 61003, the attribute decoder 61004, and the post-processor 61005. According to another embodiment, signaling information included in the geometry slice (or data unit) header and/or the attribute slice (or data unit) header may be pre-parsed by the signaling processor 61002 prior to decoding of corresponding slice data. The signaling information may include information related to scaling.

For example, when the point cloud data is partitioned into tiles and/or slices at the transmitting side, the TPS includes the number of slices included in each tile, and accordingly the point cloud video decoder according to the embodiments may check the number of slices and quickly parse the information for parallel decoding. Further, the point cloud video decoder according to the present disclosure may quickly parse a bitstream containing point cloud data as it receives an SPS having a reduced amount of data. The reception device may decode tiles upon receiving the tiles, and may decode each slice based on the GPS and APS included in each tile. Thereby, decoding efficiency may be maximized.

In other words, the geometry decoder 61003 may reconstruct the geometry by performing the reverse process to the operation of the geometry encoder 51003 of FIG. 19 on the compressed geometry bitstream based on signaling information (e.g., geometry related parameters). The geometry restored (or reconstructed) by the geometry decoder 61003 is provided to the attribute decoder 61004.

The attribute decoder 61004 may restore the attribute by performing the reverse process of the operation of the attribute encoder 51004 of FIG. 19 on the compressed attribute bitstream based on signaling information (e.g., attribute related parameters) and the reconstructed geometry. According to embodiments, when the point cloud data is partitioned into tiles and/or slices at the transmitting side, the geometry decoder 61003 and the attribute decoder 61004 perform geometry decoding and attribute decoding on a tile-by-tile basis and/or slice-by-slice basis.

The attribute decoder 61004 applies a scaling factor to the attribute information based on the scaling-related information included in the signaling information to restore the original attribute information. The scaling factor may be applied before or after decoding the attribute information.

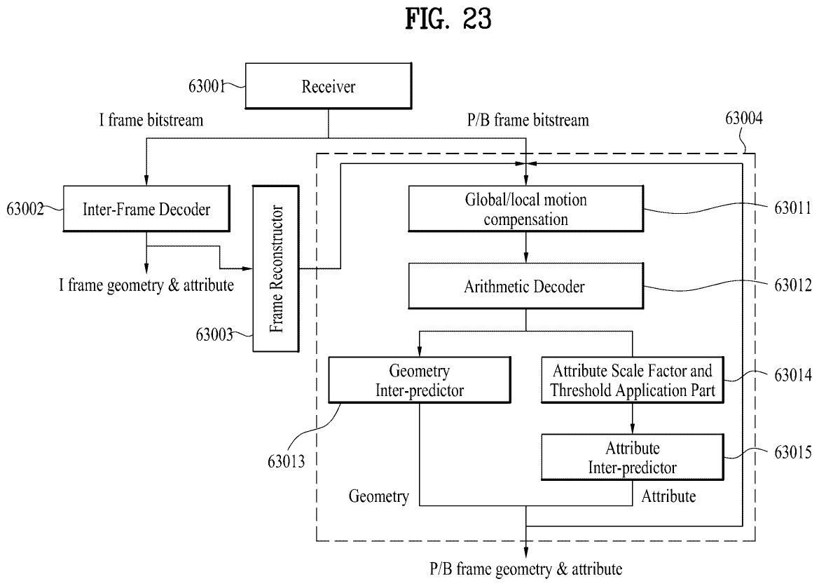

FIG. 23 is a detailed block diagram illustrating another example of a point cloud video decoder including a geometry decoder and an attribute decoder according to embodiments. The elements of the point cloud video decoder illustrated in FIG. 23 may be implemented in hardware, software, processors, and/or combinations thereof.

In FIG. 23, the point cloud video decoder may include a receiver 63001, a first decoder 63002 configured to reconstruct an I frame based on intra-prediction, a frame reconstructor 63003, and a second decoder 63004 configured to reconstruct P/B frames based on inter-prediction.

FIG. 23 illustrates only parts of the point cloud video decoder related to scaling. For parts not described or illustrated in FIG. 23, refer to the descriptions of FIGS. 1 to 18.

The receiver 63001 according to embodiments receives compressed point cloud data and signaling information. The receiver 63001 may perform the same or similar operations and/or reception method as the operations and/or reception method of the receiver 10005 of FIG. 1 or the reception processor 61001 of FIG. 22, and thus a detailed description thereof will be skipped.

According to embodiments, when a bitstream output from the receiver 63001 is an I frame bitstream, the first decoder 63002 entropy-decodes the input I frame bitstream and performs intra-prediction on the compressed geometry information and compressed attribute information contained in the entropy-decoded I frame based on the signaling information to reconstruct the geometry information and attribute information of the I frame, respectively.

According to embodiments, the frame reconstructor 67003 outputs the geometry information (in particular, the occupancy code) reconstructed based on the intra-prediction to the second decoder 67004.

According to embodiments, when the bitstream output from the receiver 63001 is a P-frame or B-frame bitstream, the motion compensation part 63011 may perform motion compensation by applying a global/local motion vector to one or more reference frames, as described at the transmission side, based on the signaling information including motion-related information (e.g., global/local motion vector).

According to embodiments, the arithmetic decoder 63012 entropy-decodes the input P-frame or B-frame bitstream.

According to embodiments, the geometry inter-predictor 63013 performs inter-prediction on the compressed geometry information (e.g., geometry prediction mode information and geometry residual information) contained in the entropy-decoded P frame or

B frame based on the signaling information, per at least one of frame/tile/slice/LPU/PU/road/object, to reconstruct the geometry information of the P frame or B frame. In one embodiment, the geometry inter-predictor 63013 may reconstruct the octree structure by acquiring an occupancy code from the reconstructed geometry information.

According to embodiments, the scaling application part 63014 may apply a scaling factor to the compressed attribute information (e.g., attribute prediction mode information and attribute residual information) contained in the entropy-decoded P-frame or B-frame per at least one of frame/tile/slice/LPU/PU/road/object based on the signaling information including scaling-related information.

According to embodiments, the scaling application part 63014 may or may not apply scaling based on the scaling-related information included in the signaling information. In other embodiments, applying attribute scaling may be performed prior to reconstruction of the geometry information, or may be performed when the attribute inter-predictor 63015 searches for neighbor nodes after LoD generation to restore the attribute information.

According to embodiments, the scaling-related information may include at least one of information indicating whether attribute scaling is enabled (e.g., attr_global_scaling_flag), a scaling factor (e.g., scaling_factor), and unit information for applying attribute scaling (e.g., attr_scaling_unit), a scaling factor used when attribute scaling is applied to neighbor node search (attr_nearest_neighbour_scaling_factor), or a scaling threshold (e.g., scaling_threshold). The signaling information including the scaling-related information may be at least one of the SPS, GPS, TPS, APS, geometry slice header, or attribute slice header.

According to embodiments, the attribute inter-predictor 63015 restores the attribute information in the P frame or B frame by performing inter-prediction per at least one of frame/tile/slice/LPU/PU/road/object based on the compressed attribute information contained in the P frame or B frame to which scaling is or is not applied and one or more motion-compensated reference frames.

In one embodiment, the attribute inter-predictor 63015 may generate a LoD based on the reconstructed geometry information, search neighbor nodes based on the generated LoD, and restore the attribute information using any one or a combination of two or more of RAHT decoding, prediction transform decoding, and lifting transform decoding.

According to embodiments, the scaling application part 63014 may determine whether to apply scaling based on the information in attr_global_scaling_flag. When the information indicates that scaling is to be applied, scaling_factor may be applied to the frame (or tile or slice). Further, based on attr_scaling_flag, it may be determined whether scaling is applied in a unit of application indicated by the information in attr_scaling_unit. When this information indicates that scaling is to be applied, scaling_factor may be applied to the unit of application (e.g., LPU/PU/road/object/objects/objects/octree/geometry predictive tree), and then the attribute information may be restored using at least one of prediction/lifting/RAHT decoding. In the case where attribute scaling is applied to neighbor node search, the information in attr_nearest_neighbour_scaling_factor may be signaled per point, which is a prediction unit, and the attribute values may be restored using the same computation method performed by the transmission device. Further, whether to apply scaling may be determined based on the information in scaling_threshold.

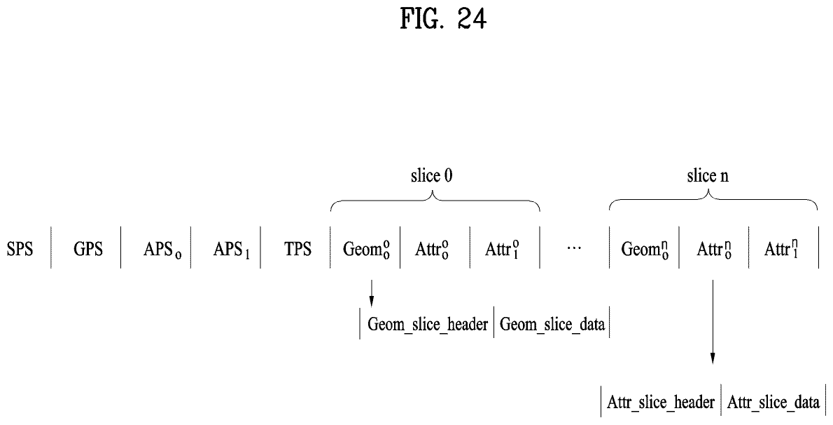

FIG. 24 illustrates an exemplary bitstream structure of point cloud data for transmission/reception according to embodiments.

In the present disclosure, related information may be signaled in order to add/carry out the embodiments described so far. The signaling information according to embodiments may be used by a point cloud video encoder on the transmitting side or a point cloud video decoder on the receiving side.

The point cloud video encoder according to the embodiments may generate a bitstream as shown in FIG. 24 by encoding geometry information and attribute information as described above. In addition, signaling information related to the point cloud data may be generated and processed by at least one of the geometry encoder, the attribute encoder, or the signaling processor of the point cloud video encoder, and may be included in the bitstream.

The signaling information may be received/acquired by at least one of the geometry decoder, the attribute decoder, or the signaling processor of the point cloud video decoder.

The bitstreams according to embodiments may be divided into a geometry bitstream, an attribute bitstream, and a signaling bitstream and transmitted/received, or may be combined into one bitstream to be transmitted/received.

When a geometry bitstream, an attribute bitstream, and a signaling bitstream according to embodiments are configured in one bitstream, the bitstream may include one or more sub-bitstreams. The bitstream according to the embodiments may include a sequence parameter set (SPS) for sequence level signaling, a geometry parameter set (GPS) for signaling of geometry information coding, one or more attribute parameter sets (APSs) (APS₀, APS₁) for signaling of attribute information coding, a tile parameter set (TPS) for signaling at the tile level, and one or more slices (slice 0 to slice n). That is, a bitstream of point cloud data according to embodiments may include one or more tiles, and each of the tiles may be a slice group including one or more slices (slice 0 to slice n). The TPS according to the embodiments may contain information about each of the one or more tiles (e.g., coordinate value information and height/size information about the bounding box). Each slice may include one geometry bitstream (Geom0) and one or more attribute bitstreams (Attr0 and Attr1). For example, a first slice (slice 0) may include one geometry bitstream (Geom0⁰) and one or more attribute bitstreams (Attr0⁰ and Attr1⁰).

The geometry bitstream (also referred to as a geometry slice) in each slice may include a geometry slice header (geom_slice_header) and geometry slice data (geom_slice_data). According to embodiments, the geometry bitstream in each slice may be referred to as a geometry data unit, the geometry slice header may be referred to as a geometry data unit header, and the geometry slice data may be referred to as geometry data unit data.

Each attribute bitstream (also referred to as an attribute slice) in each slice may include an attribute slice header (attr_slice_header) and attribute slice data (attr_slice_data). According to embodiments, the attribute bitstream in each slice may be referred to as an attribute data unit, the attribute slice header may be referred to as an attribute data unit header, and the attribute slice data may be referred to as attribute data unit data.

By transmitting the point cloud data according to the bitstream structure as shown in FIG. 24, the transmission device according to the embodiments may allow the encoding operation to be applied differently according to the importance level, and allow a good-quality encoding method to be used in an important region. In addition, it may support efficient encoding and transmission according to the characteristics of the point cloud data and provide attribute values according to user requirements.

As the reception device according to the embodiments receives the point cloud data according to the bitstream structure as shown in FIG. 24, it may apply different filtering (decoding methods) to the respective regions (regions divided into tiles or slices) according to the processing capacity of the reception device, rather than using a complex decoding (filtering) method for the entire point cloud data. Thereby, a better image quality may be provided for regions important to the user and appropriate latency may be ensured in the system.

As described above, tiles or slices are provided to process the point cloud data by dividing the point cloud data into regions. In dividing the point cloud data into regions, an option to generate a different set of neighbor points for each region may be configured. Thereby, a selection method having low complexity and slightly lower reliability, or a selection method having high complexity and high reliability may be provided.

According to embodiments, at least one of the SPS, GPS, TPS, APS, geometry slice header, or attribute slice header may include scaling-related information.

The signal (e.g., scaling-related information) may have a different meaning depending on the position where the signal is carried. When the signal is defined in the SPS, this may indicate that the signal is uniformly applied to the entire sequence. When the signal is defined in the GPS, this may indicate that the signal is used for position reconstruction. When the signal is defined in the APS, this may indicate that the signal is applied to attribute reconstruction. When the signal is defined in the TPS, this may indicate that the signaling is applied only to the points in a tile. When the signal is delivered in a slice, this may indicate that the signaling is applied only to the slice. In addition, when the fields (or syntax elements) defined below are applicable to multiple point cloud data streams as well as the current point cloud data stream, they may be carried in a superordinate parameter set or the like.

The term field, as used in the syntaxes of the present disclosure described hereinafter, may have the same meaning as a parameter or element.

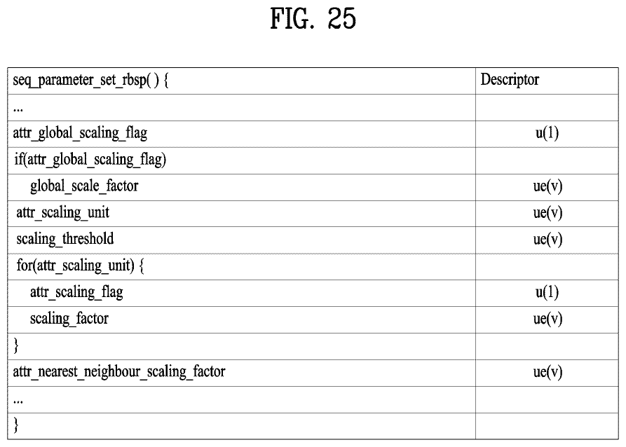

FIG. 25 illustrates a syntax structure of a sequence parameter set (seq_parameter_set_rbsp( ) (SPS) according to one embodiment of the present disclosure. The SPS may include sequence information about a point cloud data bitstream, and in particular, is shown to include scaling-related information as an example.

In FIG. 25, the SPS may include an attr_global_scaling_flag field, an attr_scaling_unit field, and a scaling_threshold field.

attr_global_scaling_flag indicates whether global attribute scaling is enabled. For example, attr_global_scaling_flag set to TRUE indicates that global attribute scaling is enabled, and attr_global_scaling_flag set to FALSE indicates that global attribute scaling is disabled.

When the value of the attr_global_scaling_flag field is TRUE, the SPS may further include a global_scale_factor field.

global_scale_factor indicates a global scaling value (also known a scaling factor value) that is applied to the frame.

attr_scaling_unit indicates the unit of application in which the attribute scaling is applied. For example, among the values of attr_scaling_unit, 0 indicates object/road, 1 indicates objects, 2 indicates LPU/PU, and 3 indicates octree/geometry predictive tree (predtree).

scaling_threshold indicates a scaling threshold for determining whether to apply scaling.

According to embodiments, the SPS may further include an attr_scaling_flag field and a scaling_factor field per unit of application indicated by the attr_scaling_unit field.

attr_scaling_flag indicates whether attribute scaling is applied to the unit of application indicated by attr_scaling_unit. For example, attr_scaling_flag may indicate that attribute scaling (e.g., local scaling) is used for the unit of application when the value thereof is TRUE, and may indicate that attribute scaling is not used when the value is FALSE.

scaling_factor indicates a scaling value applied to the application unit.

According to embodiments, the SPS may further include an attr_nearest_neighbor_scaling_factor field.

attr_nearest_neighbour_scaling_factor indicates a scaling value of a neighbor node that is applied per point, when attribute scaling is applied to the neighbor node search.

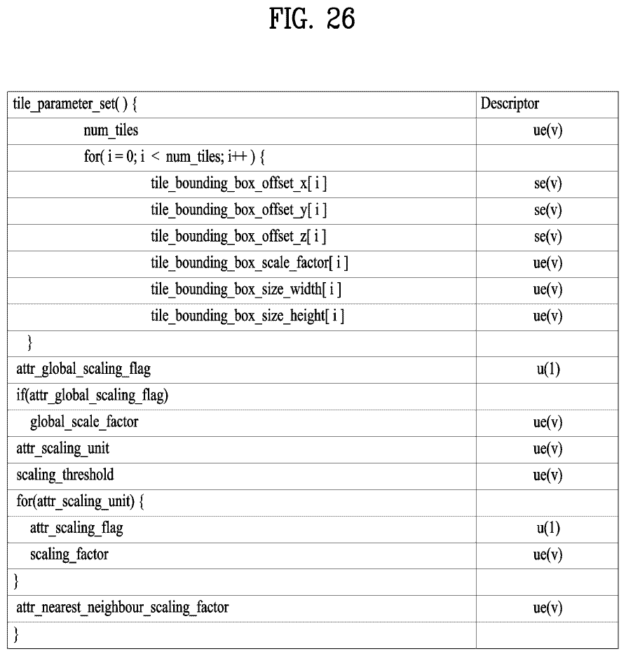

FIG. 26 illustrates a syntax structure of a tile parameter set (tile_parameter_set( )) (TPS) according to one embodiment of the present disclosure. According to embodiments, the tile parameter set (TPS) may also be referred to as a tile inventory. In the illustrated example, the TPS includes tile related information for each tile, and in particular, scaling-related information.

The TPS according to the embodiments includes a num_tiles field.

num_tiles indicates the number of tiles signaled for the bitstream. When not present, num_tiles is inferred to be 0.

The TPS according to the embodiments includes an iteration statement repeated as many times as the value of the num_tiles field. In an embodiment, i is initialized to 0, and is incremented by 1 each time the iteration statement is executed. The iteration statement is repeated until the value of i becomes equal to the value of num_tiles. The iteration statement may include a tile_bounding_box_offset_x[i] field, a tile_bounding_box_offset_y[i] field, a tile_bounding_box_offset_z[i] field, a tile_bounding_box_size_width[i] field, a tile_bounding_box_size_height[i] field, and a tile_bounding_box_size_depth[i] field.

tile_bounding_box_offset_x[i] indicates the x offset of the i-th tile in the Cartesian coordinates.

tile_bounding_box_offset_y[i] indicates the y offset of the i-th tile in the Cartesian coordinates.

tile_bounding_box_offset_z[i] indicates the z offset of the i-th tile in the Cartesian coordinates.

tile_bounding_box_size_width[i] indicates the width of the i-th tile in the Cartesian coordinates.

tile_bounding_box_size_height[i] indicates the height of the i-th tile in the Cartesian coordinates.

tile_bounding_box_size_depth[i] indicates the depth of the i-th tile in the Cartesian coordinates.

According to embodiments, the TPS may include an attr_global_scaling_flag field, an attr_scaling_unit field, and a scaling_threshold field.

attr_global_scaling_flag indicates whether global attribute scaling is enabled. For example, attr_global_scaling_flag set to TRUE indicates that global attribute scaling is enabled, and attr_global_scaling_flag set to FALSE indicates that global attribute scaling is disabled.

When the value of the attr_global_scaling_flag field is TRUE, the TPS may further include a global_scale_factor field.

global_scale_factor indicates a global scaling value (also known a scaling factor value) that is applied to the frame.

attr_scaling_unit indicates the unit of application in which the attribute scaling is applied. For example, among the values of attr_scaling_unit, 0 indicates object/road, 1 indicates objects, 2 indicates LPU/PU, and 3 indicates octree/geometry predictive tree (predtree).

scaling_threshold indicates a scaling threshold for determining whether to apply scaling.

According to embodiments, the TPS may further include an attr_scaling_flag field and a scaling_factor field per unit of application indicated by the attr_scaling_unit field.

attr_scaling_flag indicates whether attribute scaling is applied to the unit of application indicated by attr_scaling_unit. For example, attr_scaling_flag may indicate that attribute scaling (e.g., local scaling) is used for the unit of application when the value thereof is TRUE, and may indicate that attribute scaling is not used when the value is FALSE.

scaling_factor indicates a scaling value applied to the application unit.

According to embodiments, the TPS may further include an attr_nearest_neighbor_scaling_factor field.

attr_nearest_neighbour_scaling_factor indicates a scaling value of a neighbor node that is applied per point, when attribute scaling is applied to the neighbor node search.

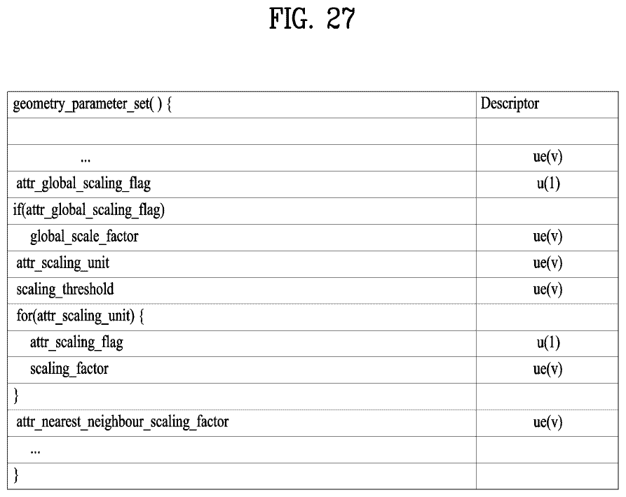

FIG. 27 illustrates a syntax structure of a geometry parameter set (geometry_parameter_set( )) (GPS) according to one embodiment of the present disclosure. In particular, FIG. 27 illustrates an example where the GPS further includes scaling-related information.

In FIG. 27, the GPS may include an attr_global_scaling_flag field, an attr_scaling_unit field, and a scaling_threshold field.

attr_global_scaling_flag indicates whether global attribute scaling is enabled. For example, attr_global_scaling_flag set to TRUE indicates that global attribute scaling is enabled, and attr_global_scaling_flag set to FALSE indicates that global attribute scaling is disabled.

When the value of the attr_global_scaling_flag field is TRUE, the GPS may further include a global_scale_factor field.

global_scale_factor indicates a global scaling value (also known a scaling factor value) that is applied to the frame.

attr_scaling_unit indicates the unit of application in which the attribute scaling is applied. For example, among the values of attr_scaling_unit, 0 indicates object/road, 1 indicates objects, 2 indicates LPU/PU, and 3 indicates octree/geometry predictive tree (predtree).

scaling_threshold indicates a scaling threshold for determining whether to apply scaling.

According to embodiments, the GPS may further include an attr_scaling_flag field and a scaling_factor field per unit of application indicated by the attr_scaling_unit field.

attr_scaling_flag indicates whether attribute scaling is applied to the unit of application indicated by attr_scaling_unit. For example, attr_scaling_flag may indicate that attribute scaling (e.g., local scaling) is used for the unit of application when the value thereof is TRUE, and may indicate that attribute scaling is not used when the value is FALSE.

scaling_factor indicates a scaling value applied to the application unit.

According to embodiments, the GPS may further include an attr_nearest_neighbor_scaling_factor field.

attr_nearest_neighbour_scaling_factor indicates a scaling value of a neighbor node that is applied per point, when attribute scaling is applied to the neighbor node search.

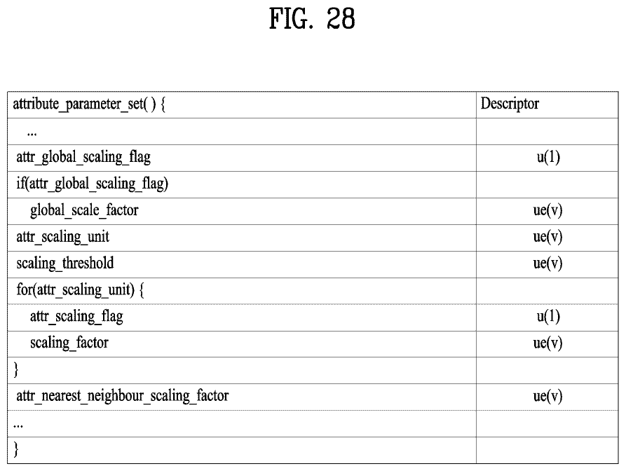

FIG. 28 illustrates a syntax structure of an attribute parameter set (attribute_parameter_set( )) (APS) according to one embodiment of the present disclosure. The APS according to the embodiments may include information about a method of encoding attribute information related to point cloud data contained in one or more slices, and may further include scaling-related information.

In FIG. 28, the APS may include an attr_global_scaling_flag field, an attr_scaling_unit field, and a scaling_threshold field.

attr_global_scaling_flag indicates whether global attribute scaling is enabled. For example, attr_global_scaling_flag set to TRUE indicates that global attribute scaling is enabled, and attr_global_scaling_flag set to FALSE indicates that global attribute scaling is disabled.

When the value of the attr_global_scaling_flag field is TRUE, the APS may further include a global_scale_factor field.

global_scale_factor indicates a global scaling value (also known a scaling factor value) that is applied to the frame.

attr_scaling_unit indicates the unit of application in which the attribute scaling is applied. For example, among the values of attr_scaling_unit, 0 indicates object/road, 1 indicates objects, 2 indicates LPU/PU, and 3 indicates octree/geometry predictive tree (predtree).

scaling_threshold indicates a scaling threshold for determining whether to apply scaling.

According to embodiments, the APS may further include an attr_scaling_flag field and a scaling_factor field per unit of application indicated by the attr_scaling_unit field.

attr_scaling_flag indicates whether attribute scaling is applied to the unit of application indicated by attr_scaling_unit. For example, attr_scaling_flag may indicate that attribute scaling (e.g., local scaling) is used for the unit of application when the value thereof is TRUE, and may indicate that attribute scaling is not used when the value is FALSE.

scaling_factor indicates a scaling value applied to the application unit.

According to embodiments, the APS may further include an attr_nearest_neighbor_scaling_factor field.

attr_nearest_neighbour_scaling_factor indicates a scaling value of a neighbor node that is applied per point, when attribute scaling is applied to the neighbor node search.

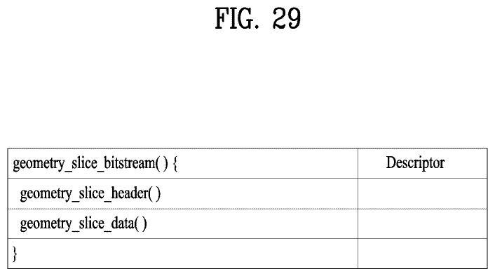

FIG. 29 illustrates a syntax structure of a geometry slice bitstream( ) according to one embodiment of the present disclosure.

The geometry slice bitstream (geometry_slice_bitstream( ) according to the embodiments may include a geometry slice header (geometry_slice_header( )) and geometry slice data (geometry_slice_data( )).

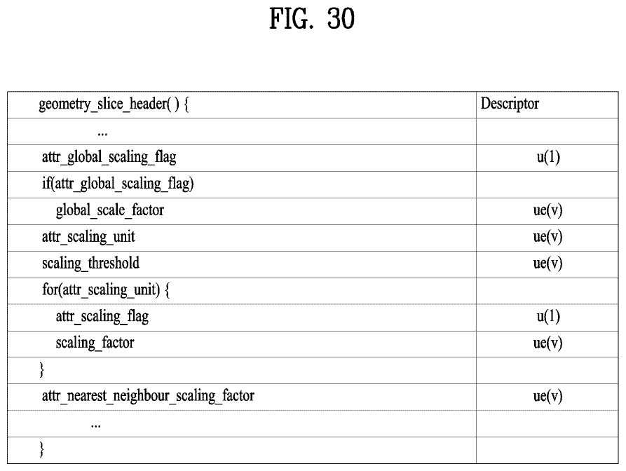

FIG. 30 illustrates a syntax structure of a geometry slice header (geometry_slice_header( )) according to one embodiment of the present disclosure.

A bitstream transmitted by the transmission device (or a bitstream received by the reception device) according to the embodiments may contain one or more slices. Each slice may include a geometry slice and an attribute slice. The geometry slice includes a geometry slice header (GSH). The attribute slice includes an attribute slice header (ASH).

The geometry slice header (geometry_slice_header( )) according to the embodiments may include an attr_global_scaling_flag field, an attr_scaling_unit field, and a scaling_threshold field.

attr_global_scaling_flag indicates whether global attribute scaling is enabled. For example, attr_global_scaling_flag set to TRUE indicates that global attribute scaling is enabled, and attr_global_scaling_flag set to FALSE indicates that global attribute scaling is disabled.

When the value of the attr_global_scaling_flag field is TRUE, the geometry slice header may further include a global_scale_factor field.

global_scale_factor indicates a global scaling value (also known a scaling factor value) that is applied to the frame.

attr_scaling_unit indicates the unit of application in which the attribute scaling is applied. For example, among the values of attr_scaling_unit, 0 indicates object/road, 1 indicates objects, 2 indicates LPU/PU, and 3 indicates octree/geometry predictive tree (predtree).

scaling_threshold indicates a scaling threshold for determining whether to apply scaling.

According to embodiments, the geometry slice header may further include an attr_scaling_flag field and a scaling_factor field per unit of application indicated by the attr_scaling_unit field.

attr_scaling_flag indicates whether attribute scaling is applied to the unit of application indicated by attr_scaling_unit. For example, attr_scaling_flag may indicate that attribute scaling (e.g., local scaling) is used for the unit of application when the value thereof is TRUE, and may indicate that attribute scaling is not used when the value is FALSE.

scaling_factor indicates a scaling value applied to the application unit.

According to embodiments, the geometry slice header may further include an attr_nearest_neighbor_scaling_factor field.

attr_nearest_neighbour_scaling_factor indicates a scaling value of a neighbor node that is applied per point, when attribute scaling is applied to the neighbor node search.

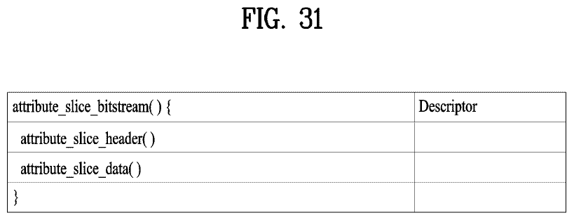

FIG. 31 illustrates a syntax structure of an attribute slice bitstream( ) according to one embodiment of the present disclosure.

The attribute slice bitstream (attribute_slice_bitstream( )) according to the embodiments may include an attribute slice header (attribute_slice_header( )) and attribute slice data (attribute_slice_data( )).

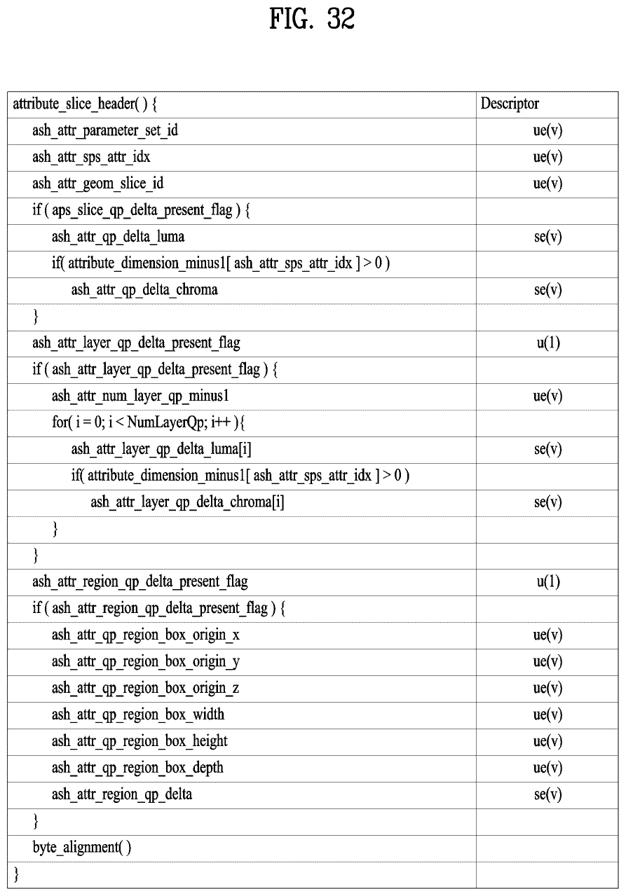

FIG. 32 illustrates a syntax structure of an attribute slice header (attribute_slice_header( )) according to one embodiment of the present disclosure.

The attribute slice header (attribute_slice_header( )) according to the embodiments may include an ash_attr_parameter_set_id field, an ash_attr_sps_attr_idx field, an ash_attr_geom_slice_id field, an ash_attr_layer_qp_delta_present_flag field, and an ash_attr_region_qp_delta_present_flag field.

When the value of the aps_slice_qp_delta_present_flag field in the APS is TRUE (e.g., 1), the attribute slice header (attribute_slice_header( ) according to the embodiments may further include an ash_attr_qp_delta_luma field. When the value of attribute_dimension_minus1 [Oash_dimension_minus1] is greater than 0, the attribute slice header may further include an ash_attr_qp_delta_chroma field.

The ash_attr_parameter_set_id field indicates the value of the aps_attr_parameter_set_id field in the current active APS.

The ash_attr_sps_attr_idx field indicates an attribute set in the current active SPS.

The ash_attr_geom_slice_id field indicates the value of the gsh_slice_id field in the current geometry slice header.

The ash_attr_qp_delta_luma field indicates a luma delta quantization parameter qp derived from the initial slice qp in the active attribute parameter set.

The ash_attr_qp_delta_chroma field indicates a chroma delta quantization parameter qp derived from the initial slice qp in the active attribute parameter set.

In this regard, the variables InitialSliceQpY and InitialSliceQpC are derived as follows.

$$InitialSliceQpY = aps\_attrattr \_initial \_qp + ash\_attr \_qp \_delta \_luma$$

$$InitialSliceQpC = aps\_attrattr \_initial \_qp + aps\_attr \_chroma \_qp \_offset + ash\_attr \_qp \_delta \_chroma$$

The ash_attr_layer_qp_delta_present_flag field indicates whether the ash_attr_layer_qp_delta_luma field and the ash_attr_layer_qp_delta_chroma field are present in the attribute slice header (ASH) for each layer. For example, when the value of the ash_attr_layer_qp_delta_present_flag field 1, is it indicates that the ash_attr_layer_qp_delta_luma field and the ash_attr_layer_qp_delta_chroma field are present in the ASH. When the value is 0, it indicates that the fields are not present.

When the value of the ash_attr_layer_qp_delta_present_flag field is TRUE, the ASH may further include an ash_attr_num_layer_qp_minus1 field.

The ash_attr_num_layer_qp_minus1 field plus 1 indicates the number of layers through which the ash_attr_qp_delta_luma field and the ash_attr_qp_delta_chroma field are signaled. When the ash_attr_num_layer_qp field is not signaled, the value of the ash_attr_num_layer_qp field will be 0. According to embodiments, NumLayerQp specifying the number of layers may be obtained by adding 0 to the value of the ash_attr_num_layer_qp_minus1 field (NumLayerQp=ash_attr_num_layer_qp_minus1+1).

According to embodiments, when the value of the ash_attr_layer_qp_delta_present_flag field is TRUE, the geometry slice header may include a loop iterated as many times as the value of NumLayerQp. In this case, in an embodiment, i may be initialized to 0 and incremented by 1 every time the loop is executed, and the loop incremented until the value of i reaches the value of NumLayerQp. This loop contains an ash_attr_layer_qp_delta_luma[i] field. Also, when the value of the attribute_dimension_minus1[ash_attr_sps_attr_idx] field is greater than 0, the loop may further include an ash_attr_layer_qp_delta_chroma[i] field.

The ash_attr_layer_qp_delta_luma field indicates a luma delta quantization parameter (qp) from InitialSliceQpY in each layer.

The ash_attr_layer_qp_delta_chroma field indicates a chroma delta quantization parameter (qp) from InitialSliceQpC in each layer.

The variables SliceQpY[i] and SliceQpC[i] with i=0 . . . NumLayerQPNumQPLayer−1 are derived as follows.

for ( i = 0; i < NumLayerQPNumQPLayer; i++) {
SliceQpY[i] = InitialSliceQpY + ash_attr_layer_qp_delta_luma[i]
SliceQpC[i] = InitialSliceQpC + ash_attr_layer_qp_delta_chroma[i]
}

When the value of the ash_attr_region_qp_delta_present_flag field is 1, the attribute slice header (attribute_slice_header( ) according to the embodiments indicates that ash_attr_region_qp_delta, region bounding box origin, and size are present in the current attribute slice header. When the value of the ash_attr_region_qp_delta_present_flag field is 0, it indicates that the ash_attr_region_qp_delta, region bounding box origin, and size are not present in the current attribute slice header.

That is, when the value of the ash_attr_layer_qp_delta_present_flag field is 1, the attribute slice header may further include an ash_attr_qp_region_box_origin_x field, an ash_attr_qp_region_box_origin_y field, an ash_attr_qp_region_box_origin_z field, an ash_attr_qp_region_box_width field, an ash_attr_qp_region_box_height field, an ash_attr_qp_region_box_depth field, and an ash_attr_region_qp_delta field.

The ash_attr_qp_region_box_origin_x field indicates the x offset of the region bounding box relative to slice_origin_x.

The ash_attr_qp_region_box_origin_y field indicates the y offset of the region bounding box relative to slice_origin_y.

The ash_attr_qp_region_box_origin_z field indicates the z offset of the region bounding box relative to slice_origin_z.

The ash_attr_qp_region_box_size_width field indicates the width of the region bounding box.

The ash_attr_qp_region_box_size_height field indicates the height of the region bounding box.

The ash_attr_qp_region_box_size_depth field indicates the depth of the region bounding box.

The ash_attr_region_qp_delta field indicates delta qp from SliceQpY[i] and SliceQpC[i] of a region specified by the ash_attr_qp_region_box field.

According to embodiments, the variable RegionboxDeltaQp specifying a region box delta quantization parameter is set equal to the value of the ash_attr_region_qp_delta field (RegionboxDeltaQp=ash_attr_region_qp_delta).

According to embodiments, the attribute slice header may further include an attr_global_scaling_flag field, an attr_scaling_unit field, and a scaling_threshold field.

attr_global_scaling_flag indicates whether global attribute scaling is enabled. For example, attr_global_scaling_flag set to TRUE indicates that global attribute scaling is enabled, and attr_global_scaling_flag set to FALSE indicates that global attribute scaling is disabled.

When the value of the attr_global_scaling_flag field is TRUE, the attribute slice header may further include a global_scale_factor field.

global_scale_factor indicates a global scaling value (also known a scaling factor value) that is applied to the frame.

attr_scaling_unit indicates the unit of application in which the attribute scaling is applied. For example, among the values of attr_scaling_unit, 0 indicates object/road, 1 indicates objects, 2 indicates LPU/PU, and 3 indicates octree/geometry predictive tree (predtree).

scaling_threshold indicates a scaling threshold for determining whether to apply scaling.

According to embodiments, the attribute slice header may further include an attr_scaling_flag field and a scaling_factor field per unit of application indicated by the attr_scaling_unit field.

attr_scaling_flag indicates whether attribute scaling is applied to the unit of application indicated by attr_scaling_unit. For example, attr_scaling_flag may indicate that attribute scaling (e.g., local scaling) is used for the unit of application when the value thereof is TRUE, and may indicate that attribute scaling is not used when the value is FALSE.

scaling_factor indicates a scaling value applied to the application unit.

According to embodiments, the attribute slice header may further include an attr_nearest_neighbor_scaling_factor field.

attr_nearest_neighbour_scaling_factor indicates a scaling value of a neighbor node that is applied per point, when attribute scaling is applied to the neighbor node search.

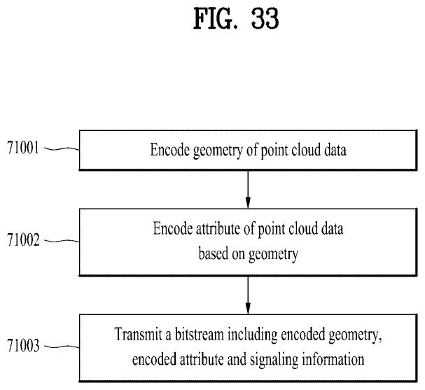

FIG. 33 is a flowchart of a method of transmitting point cloud data according to embodiments.

The method of transmitting point cloud data according to the embodiments may include operation 71001 of encoding geometry included in point cloud data, operation 71002 of encoding attributes included in the point cloud data based on input and/or reconstructed geometry, and operation 71003 of transmitting a bitstream containing the encoded geometry, the encoded attributes, and signaling information.

In operations 71001 and 71002 of encoding the geometry and attributes included in the point cloud data, some or all of the operations of the point cloud video encoder 10002 of FIG. 1, the encoding 20001 of FIG. 2, the point cloud video encoder of FIG. 4, the point cloud video encoder of FIG. 12, the geometry encoder and attribute encoder of FIG. 19, the point cloud video encoder of FIG. 20, and the point cloud video encoder of FIG. 21 may be performed.

According to embodiments, in operation 71001 of encoding the geometry includes, points in the input point cloud data are quantized according to a quantization scale and/or sampled according to a sampling scale. Then, an octree structure is generated based on the quantized points or sampled points, and the occupancy code is entropy-encoded and output in the form of a geometry bitstream.

Operations 71001 and 71002 of encoding the geometry and attributes according to the embodiments may include performing the encoding per slice or per tile, the tile including one or more slices.

In operations 71001 and 71002 of encoding the geometry and attributes according to the embodiments, when the input frame is an I frame, intra-prediction is performed on geometry information and attribute information contained in the input I frame, respectively, the information is compressed and entropy-coded, and then an I frame bitstream is output.

In operations 71001 and 71002 of encoding the geometry and attributes according to the embodiments, when the input frame is a P-frame or a B-frame, inter-prediction is performed on geometry information and attribute information contained in the input P-frame or B-frame based on one or more reference frames, respectively, the information is compressed and entropy-coded, and then a P/B frame bitstream is output.

In operations 71001 and 71002 of encoding the geometry and attributes according to the embodiments, when the input frame is a P-frame or a B-frame, a scaling factor may be applied to the attribute information in the P/B frame per at least one of frame/tile/slice/LPU/PU/road/object. According to embodiments, in the operations 71001 and 71002 of encoding the geometry and attributes, it may be determined whether to apply scaling based on a scaling threshold, and scaling may be applied only when the amount of change in attributes between the reference frame and the current frame is greater than the scaling threshold. Here, the condition for applying scaling, the range of application, and the like have been described in detail with reference to FIGS. 15 to 20, and thus will not be described below. According to embodiments, attribute scaling may be applied prior to compression of the geometry information, or may be applied after geometry reconstruction but prior to attribute compression, or may be applied when searching for neighbor nodes after LoD generation.

Operation 71003 of transmitting the bitstream containing the encoded geometry, encoded attributes, and signaling information may be performed by the transmitter 10003 of FIG. 1, the transmission 20002 of FIG. 2, the transmission processor 12012 of FIG. 12, or the transmission processor 51008 of FIG. 19.

According to embodiments, the scaling-related information included in the signaling information may include at least one of information indicating whether attribute scaling is enabled (e.g., attr_global_scaling_flag), a scaling factor (e.g., scaling_factor), and unit information for applying attribute scaling (e.g., attr_scaling_unit), a scaling factor used when attribute scaling is applied to neighbor node search (attr_nearest_neighbour_scaling_factor), or a scaling threshold (e.g., scaling_threshold). The signaling information may be included in at least one of the SPS, GPS, TPS, APS, geometry slice header, or attribute slice header and transmitted to the reception device.

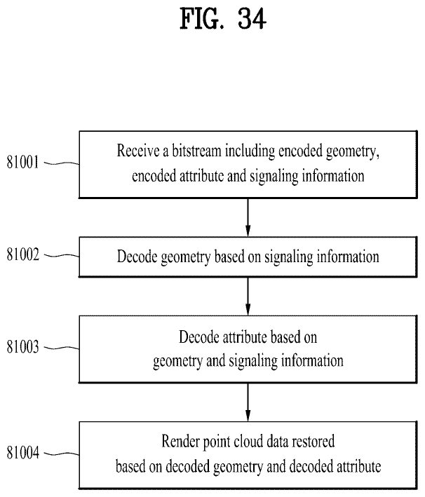

FIG. 34 is a flowchart of a method of receiving point cloud data according to embodiments.

The method of receiving point cloud data according to the embodiments includes operation 81001 of receiving a bitstream containing encoded geometry, encoded attributes, and signaling information, operation 81002 of decoding the geometry based on the signaling information, operation 81003 of decoding the attributes based on the decoded/reconstructed geometry and signaling information, and operation 81004 of rendering the reconstructed point cloud data based on the decoded geometry and decoded attributes.

Operation 81001 of receiving the bitstream containing the encoded geometry, encoded attributes, and signaling information according to the embodiments may be performed by the receiver 10005 of FIG. 1, the transmission 20002 or decoding 20003 of FIG. 2, the receiver 13000 or reception processor 13001 of FIG. 13, or the reception processor 61001 of FIG. 22.

Operations 81002 and 81003 of decoding the geometry and attributes according to the embodiments may include performing the decoding per slice or per tile, the tile including one or more slices.

In operation 81002 of decoding the geometry according to the embodiments, some or all of the operations of the point cloud video decoder 10006 of FIG. 1, the decoding 20003 of FIG. 2, the point cloud video decoder of FIG. 11, the point cloud video decoder of FIG. 13, the geometry decoder of FIG. 22, and the point cloud video decoder of FIG. 23 may be performed.

In operation 81003 of decoding the attributes according to the embodiments, some or all of the operations of the point cloud video decoder 10006 of FIG. 1, the decoding 20003 of FIG. 2, the point cloud video decoder of FIG. 11, the point cloud video decoder of FIG. 13, the attribute decoder of FIG. 22, and the point cloud video decoder of FIG. 23 may be performed.

According to embodiments, the signaling information, for example, at least one of a sequence parameter set, a geometry parameter set, an attribute parameter set, a tile parameter set, a geometry slice header, and an attribute slice header, may include scaling-related information. The details included in the scaling-related information have been described above, and thus a description thereof will be skipped to avoid redundancy.

According to embodiments, in operation 81002 of decoding the geometry, the geometry decoding may be performed by reconstructing metadata based on the signaling information and re-generating an octree based on the reconstructed metadata. Then, the geometry may be reconstructed based on the re-generated octree.

According to embodiments, in operation 81003 of decoding the attributes, attribute decoding may be performed based on the reconstructed geometry information.

According to embodiments, in operations 81002 and 81003 of decoding the geometry and attributes, when the input bitstream is an I frame bitstream, intra-prediction is performed on the compressed geometry information and compressed attribute information contained in the I frame based on the signaling information, respectively, to reconstruct the geometry information and attribute information in the I frame.

According to embodiments, in operations 81002 and 81003 of decoding the geometry and attributes, when the input bitstream is a P frame or B frame bitstream, the geometry information in the P frame or B frame is reconstructed by performing inter-prediction on the compressed geometry information (e.g., geometry prediction mode information and geometry residual information) contained in the entropy decoded P frame or B frame based on the signaling information per at least one of frame/tile/slice/LPU/PU/road/object.

According to embodiments, in operations 81002 and 81003 of decoding the geometry and attributes, a scaling factor may be applied to the compressed attribute information (e.g., attribute prediction mode information and attribute residual information) contained in the P frame or B frame per at least one of a frame/tile/slice/LPU/PU/road/object based on the signaling information including scaling-related information.

According to embodiments, in operations 81002 and 81003 of decoding the geometry and attributes, scaling may or may not be applied based on the scaling-related information included in the signaling information. In other embodiments, applying the attribute scaling may be performed prior to reconstructing the geometry information or may be performed when neighbor nodes are searched for after LoD generation to restore the attribute information.

In operation 81004 of rendering the reconstructed point cloud data based on the decoded geometry and decoded attributes according to the embodiments, the reconstructed point cloud data may be rendered according to various rendering methods. For example, the points in the point cloud content may be rendered to a vertex having a certain thickness, a cube having a specific minimum size centered on the corresponding vertex position, or a circle centered on the corresponding vertex position. All or part of the rendered point cloud content is provided to the user through a display (e.g., a VR/AR display, a general display, etc.).

Operation 81004 of rendering the point cloud data may be performed by the renderer 10007 of FIG. 1, the rendering 20004 of FIG. 2, or the renderer 13011 of FIG. 13.

As such, according to the present disclosure, the compression efficiency of attribute information between frames of a point cloud may be improved by applying scaling to attribute information contained in point cloud data composed of multiple frames and then performing inter-prediction-based attribute compression.

Further, according to the present disclosure, by applying scaling even when searching for neighbor nodes for attribute compression, the compression efficiency may be improved even in searching for neighbor nodes between frames.

Each part, module, or unit described above may be a software, processor, or hardware part that executes successive procedures stored in a memory (or storage unit). Each of the steps described in the above embodiments may be performed by a processor, software, or hardware parts. Each module/block/unit described in the above embodiments may operate as a processor, software, or hardware. In addition, the methods presented by the embodiments may be executed as code. This code may be written on a processor readable storage medium and thus read by a processor provided by an apparatus.

In the specification, when a part “comprises” or “includes” an element, it means that the part further comprises or includes another element unless otherwise mentioned. Also, the term “ . . . module (or unit)” disclosed in the specification means a unit for processing at least one function or operation, and may be implemented by hardware, software or combination of hardware and software.

Although embodiments have been explained with reference to each of the accompanying drawings for simplicity, it is possible to design new embodiments by merging the embodiments illustrated in the accompanying drawings. If a recording medium readable by a computer, in which programs for executing the embodiments mentioned in the foregoing description are recorded, is designed by those skilled in the art, it may fall within the scope of the appended claims and their equivalents.

The apparatuses and methods may not be limited by the configurations and methods of the embodiments described above. The embodiments described above may be configured by being selectively combined with one another entirely or in part to enable various modifications.

Although preferred embodiments have been described with reference to the drawings, those skilled in the art will appreciate that various modifications and variations may be made in the embodiments without departing from the spirit or scope of the disclosure described in the appended claims. Such modifications are not to be understood individually from the technical idea or perspective of the embodiments.

Various elements of the apparatuses of the embodiments may be implemented by hardware, software, firmware, or a combination thereof. Various elements in the embodiments may be implemented by a single chip, for example, a single hardware circuit. According to embodiments, the components according to the embodiments may be implemented as separate chips, respectively. According to embodiments, at least one or more of the components of the apparatus according to the embodiments may include one or more processors capable of executing one or more programs. The one or more programs may perform any one or more of the operations/methods according to the embodiments or include instructions for performing the same. Executable instructions for performing the method/operations of the apparatus according to the embodiments may be stored in a non-transitory CRM or other computer program products configured to be executed by one or more processors, or may be stored in a transitory CRM or other computer program products configured to be executed by one or more processors. In addition, the memory according to the embodiments may be used as a concept covering not only volatile memories (e.g., RAM) but also nonvolatile memories, flash memories, and PROMs. In addition, it may also be implemented in the form of a carrier wave, such as transmission over the Internet. In addition, the processor-readable recording medium may be distributed to computer systems connected over a network such that the processor-readable code may be stored and executed in a distributed fashion.

In this document, the term “/” and “,” should be interpreted as indicating “and/or.” For instance, the expression “A/B” may mean “A and/or B.” Further, “A, B” may mean “A and/or B.” Further, “A/B/C” may mean “at least one of A, B, and/or C.” “A, B, C” may also mean “at least one of A, B, and/or C.” Further, in the document, the term “or” should be interpreted as “and/or.” For instance, the expression “A or B” may mean 1) only A, 2) only B, and/or 3) both A and B. In other words, the term “or” in this document should be interpreted as “additionally or alternatively.”

Various elements of the embodiments may be implemented by hardware, software, firmware, or a combination thereof. Various elements in the embodiments may be executed by a single chip such as a single hardware circuit. According to embodiments, the element may be selectively executed by separate chips, respectively. According to embodiments, at least one of the elements of the embodiments may be executed in one or more processors including instructions for performing operations according to the embodiments.

Operations according to the embodiments described in this specification may be performed by a transmission/reception device including one or more memories and/or one or more processors according to embodiments. The one or more memories may store programs for processing/controlling the operations according to the embodiments, and the one or more processors may control various operations described in this specification. The one or more processors may be referred to as a controller or the like. In embodiments, operations may be performed by firmware, software, and/or combinations thereof. The firmware, software, and/or combinations thereof may be stored in the processor or the memory.

Terms such as first and second may be used to describe various elements of the embodiments. However, various components according to the embodiments should not be limited by the above terms. These terms are only used to distinguish one element from another. For example, a first user input signal may be referred to as a second user input signal. Similarly, the second user input signal may be referred to as a first user input signal. Use of these terms should be construed as not departing from the scope of the various embodiments. The first user input signal and the second user input signal are both user input signals, but do not mean the same user input signal unless context clearly dictates otherwise. The terminology used to describe the embodiments is used for the purpose of describing particular embodiments only and is not intended to be limiting of the embodiments. As used in the description of the embodiments and in the claims, the singular forms “a”, “an”, and “the” include plural referents unless the context clearly dictates otherwise. The expression “and/or” is used to include all possible combinations of terms. The terms such as “includes” or “has” are intended to indicate existence of figures, numbers, steps, elements, and/or components and should be understood as not precluding possibility of existence of additional existence of figures, numbers, steps, elements, and/or components.

As used herein, conditional expressions such as “if” and “when” are not limited to an optional case and are intended to be interpreted, when a specific condition is satisfied, to perform the related operation or interpret the related definition according to the specific condition. Embodiments may include variations/modifications within the scope of the claims and their equivalents. It will be apparent to those skilled in the art that various modifications and variations can be made in the present disclosure without departing from the spirit and scope of the disclosure. Thus, it is intended that the present disclosure cover the modifications and variations of this disclosure provided they come within the scope of the appended claims and their equivalents.

### Mode for Disclosure

The details have been specifically described in the best mode for the disclosure.

### INDUSTRIAL APPLICABILITY

It will be apparent to those skilled in the art that various modifications and variations are possible without departing from the spirit or scope of the embodiments. Thus, it is intended that the embodiments cover the modifications and variations of the embodiments provided they come within the appended claims and their equivalents.

1. A method of transmitting point cloud data, the method comprising:
encoding geometry information in the point cloud data;
encoding attribute information in the point cloud data based on the geometry information; and
transmitting the encoded geometry information, the encoded attribute information, and signaling information,
wherein the encoding of the attribute information comprises:
selectively applying a scaling factor to the attribute information; and
compressing the attribute information by performing inter-prediction based on a reference frame and a current frame containing the attribute information with and without the scaling factor applied,
wherein the signaling information comprises scaling-related information.

2. The method of claim 1, wherein the scaling factor is acquired based on an average distribution of the attribute information contained in the current frame and an average distribution of the attribute information contained in the reference frame.

3. The method of claim 2, wherein the average distribution is an average distribution of intensities acquired based on reflectance included in the attribute information.

4. The method of claim 3, wherein the applying of the scaling factor comprises:
applying the scaling factor to the attribute information based on an amount of change between the attribute information contained in the current frame and the attribute information contained in the reference frame being greater than a threshold.

5. The method of claim 1, wherein the scaling-related information is included in at least one of a sequence parameter set, a geometry parameter set, an attribute parameter set, a tile parameter set, a geometry slice header, or an attribute slice header.

6. The method of claim 1, wherein the scaling-related information comprises at least one of:
information indicating whether scaling is applied to the attribute information;
threshold information provided to determine whether the scaling is applied;
a value of the scaling factor; or
information indicating a unit of application of the scaling factor.

7. An apparatus for transmitting point cloud data, the method comprising:
a geometry encoder configured to encode geometry information in the point cloud data;
an attribute encoder configured to encode attribute information in the point cloud data based on the geometry information; and
a transmitter configured to transmit the encoded geometry information, the encoded attribute information, and signaling information,
wherein the attribute encoder is configured to:
selectively apply a scaling factor to the attribute information; and
compress the attribute information by performing inter-prediction based on a reference frame and a current frame containing the attribute information with and without the scaling factor applied,
wherein the signaling information comprises scaling-related information.

8. The apparatus of claim 7, wherein the scaling factor is acquired based on an average distribution of the attribute information contained in the current frame and an average distribution of the attribute information contained in the reference frame.

9. The apparatus of claim 8, wherein the average distribution is an average distribution of intensities acquired based on reflectance included in the attribute information.

10. The apparatus of claim 9, wherein the attribute encoder applies the scaling factor to the attribute information based on an amount of change between the attribute information contained in the current frame and the attribute information contained in the reference frame being greater than a threshold.

11. The apparatus of claim 7, wherein the scaling-related information is included in at least one of a sequence parameter set, a geometry parameter set, an attribute parameter set, a tile parameter set, a geometry slice header, or an attribute slice header.

12. The apparatus of claim 7, wherein the scaling-related information comprises at least one of:
information indicating whether scaling is applied to the attribute information;
threshold information provided to determine whether the scaling is applied;
a value of the scaling factor; or
information indicating a unit of application of the scaling factor.

13. A method of receiving point cloud data, the method comprising:
receiving encoded geometry information, encoded attribute information, and signaling information;
decoding the encoded geometry information based on the signaling information;
decoding the encoded attribute information based on the signaling information and the decoded geometry information; and
rendering reconstructed point cloud data based on the decoded geometry information and the decoded attribute information,
wherein the signaling information comprises scaling-related information,
wherein the decoding of the attribute information comprises:
selectively applying scaling to the encoded attribute information based on the scaling-related information; and
restoring the encoded attribute information by performing inter-prediction based on a reference frame and a current frame containing the encoded attribute information with or without the scaling applied.

14. The method of claim 13, wherein the scaling-related information is included in at least one of a sequence parameter set, a geometry parameter set, an attribute parameter set, a tile parameter set, a geometry slice header, or an attribute slice header.

15. The method of claim 13, wherein the scaling-related information comprises at least one of:
information indicating whether scaling is applied to the attribute information;
threshold information provided to determine whether the scaling is applied;
a value of the scaling factor; or
information indicating a unit of application of the scaling factor.
